(19) United States
(12) Patent Application Publication
(10) Pub. No.: US 2025/0016085 A1
(43) Pub. Date: Jan. 9, 2025

(54) REDUCED HEADER SIGNAL INFORMATION TESTING SYSTEMS AND METHODS

(71) Applicant: Advantest Corporation, Tokyo (JP)

(72) Inventor: Max SEMINARIO, Colorado Springs, CO (US)

(21) Appl. No.: 18/759,721

(22) Filed: Jun. 28, 2024

Related U.S. Application Data
(60) Provisional application No. 63/512,605, filed on Jul. 7, 2023.

(51) Int. Cl. H04L 43/50; H04L 27/26; H04L 27/34

(52) U.S. Cl. CPC H04L 43/50; H04L 27/2659; H04L 27/3483

(57) ABSTRACT

Presented embodiments facilitate efficient and effective flexible implementation of different types of testing procedures in a test system. In some embodiments a signal processing test method comprises: selecting a signal processing mode between a header included mode, a reduced header training mode, and a reduced header mode; performing a signal processing information determination process in accordance with a result of the selecting a signal process mode; and performing modulation/demodulation related processes in accordance with results of the signal processing information determination process. In a reduced header mode, a process is performed on a communication signal where header information is not initially readily available in the communication signal itself, and demodulation parameter information is advantageously derived/developed/extrapolated from other information in the communication signal.

### RELATED APPLICATIONS

This application claims the benefit of and priority to provisional application No. 63/512,605 entitled “TECHNIQUES FOR HEADERLESS DEMODULATION OF A SIGNAL,” (Attorney Docket Number ATSY-0138-00.00US), filed Jul. 7, 2023, which is incorporated herein by reference in its entirety.

### FIELD OF THE DISCLOSURE

Embodiments of the present disclosure relate to the field of signal processing and electronic testing.

### BACKGROUND OF THE DISCLOSURE

Electronic systems and devices have made significant contributions towards the advancement of modern society and have facilitated increased productivity and reduced costs in analyzing and communicating information in a variety of business, science, education, and entertainment applications. To address the ever-increasing desire to communicate more information, new communication devices and communication protocols are implemented. Proper transmission and processing (e.g., modulation, demodulation, etc.) of signals conveying the information is crucial for accurate information communication between electronic devices. As larger amounts of information are communicated and new communication protocols develop, testing a component's ability to properly participate in information communication historically takes more time and resources, making testing systems and test operations overall less productive and often costly.

Moreover, testing to ensure accurate signal transmission and processing tends to become complicated and problematic as communication components and protocols advance and change. Addressing the changing communication protocol requirements traditionally leads to more complicated test patterns (e.g., individually larger patterns, needing collectively more of them, etc.), which in turn often results in undesirable longer test times. More electronic resources associated with testing (e.g., testing scan chain components, wave generation components, additional information storage capacity, etc.) are also traditionally required to address the increased amounts of information and new communication protocol requirements. However, the memory space and other resources on integrated circuits are typically limited which in turn drives a focus on allocating resources towards normal operations (e.g., mission mode operations, non-testing operations, end-use operations, etc.) and functionality. However, assigning and dedicating the limited space to testing resources for relatively infrequent testing operations tends to become a costly and inefficient and/or undesirable allocation of resources. Providing adequate time and resources for appropriately testing implementations of new communication protocols in devices under test (DUTs), e.g., by automated test systems (ATEs), etc., is traditionally impractical and/or impossible.

### SUMMARY

Presented embodiments of the present disclosure facilitate flexible implementation of different types of testing procedures in a test system. Embodiments described herein enable efficient and effective testing of communication systems and methods on a component basis, where resources that support the components are limited. In effect, embodiments of the present disclosure allow communication devices to be sufficiently tested without adding additional electronic resources not needed by the communication device for its normal operations thereby providing cost savings for the device manufacturing entities.

In some embodiments, a reduced header communication signal processing test method comprises performing an autocorrelation of cyclic prefixes in a signal, wherein the signal is configured in accordance with a communication protocol; identifying start timing of symbols in the signal based on results of the autocorrelation and wherein the symbols are defined by the communication protocol and comprise orthogonal frequency division modulation (OFDM) symbols. The method further includes determining an initial coarse frequency error correction based on results of the autocorrelation; establishing a set of bins for the signal, wherein the set of bins comprises pilot bins and data bins, wherein further the set of bins correspond to a set of subcarriers associated with the signal and the pilot bins have corresponding pilot subcarriers in the set of subcarriers and the data bins correspond to data subcarriers in the set of subcarriers. The method further includes extracting identifications of the pilot bins in accordance with definitions of the pilot subcarriers as defined by the communication protocol; establishing ideal constellation values and ideal symbol values for the pilot bins and for the data bins; and determining other demodulation parameters values based upon results of the ideal constellation values and ideal symbol values for the pilot bins and the data bins.

In other embodiments, a signal processing test system comprises a load board configured to couple with a plurality of devices under test (DUTs); a controller configured to direct testing of the plurality of DUTs, wherein the controller comprises a test mode selection module operable to select between a plurality of test modes, wherein one of the plurality of the test modes is associated with a reduced header communication signal test process applied to a signal; and testing electronics configured to test the plurality of DUTs under control of the controller. The testing electronics are coupled to the load board and wherein the testing electronics comprise: a demodulation information determination module operable to gather information associated with demodulation operations, wherein the demodulation operations comprise determining signal processing information based upon information in a payload portion of the signal; and a demodulation module operable to perform demodulation operations based upon information received from the demodulation information determination module.

In other embodiments a signal processing test method comprises: selecting a signal processing mode between a header included mode, a reduced header training mode, and a reduced header mode; performing a signal processing information determination process in accordance with a result of the selecting a signal process mode; and performing modulation/demodulation related processes in accordance with results of the signal processing information determination process.

### DESCRIPTION OF THE DRAWINGS

The accompanying drawings, which are incorporated in and form a part of this specification, are included for exemplary illustration of the principles of the present disclosure and not intended to limit the present disclosure to the particular implementations illustrated therein. The drawings are not to scale unless otherwise specifically indicated.

FIG. 1A is a block diagram of an exemplary test environment or system in accordance with embodiments of the present disclosure.

FIG. 1B is a block diagram of exemplary radio frequency (RF) integrated circuit devices or DUTs in accordance with embodiments of the present disclosure.

FIG. 1C is a bock diagram of an exemplary test environment or system in accordance with embodiments of the present disclosure.

FIG. 2A is a block diagram of an exemplary DUT in accordance with embodiments of the present disclosure.

FIG. 2B is a block diagram of an exemplary Automatic Test System (ATE) in accordance with embodiments of the present disclosure.

FIG. 3A is a flow chart of an exemplary multimode modulation/demodulation parameter determination method including a novel reduced header process in accordance with embodiments of the present disclosure.

FIG. 3B is a block diagram of an exemplary multimode modulation/demodulation parameter determination system in accordance with embodiments of the present disclosure.

FIG. 4A is a block diagram of an exemplary PDU communication frame or packet in accordance with embodiments of the present disclosure.

FIG. 4B is a block diagram of an exemplary PDU communication frame or packet at different communication protocol/model layers in accordance with embodiments of the present disclosure.

FIG. 4C includes various exemplary data packets including organizations and configurations of information in PPDUs in accordance with embodiments of the present disclosure.

FIG. 4D is a data packet diagram including various exemplary organizations and configurations of information (“packets”) in accordance with embodiments of the present disclosure.

FIG. 4E is a block diagram of different exemplary signal physical layer protocol data unit (PPDU) organizations/configurations per the IEEE 802.11 family of wireless network protocols/standards in accordance with embodiments of the present disclosure.

FIG. 5A is a block diagram of an exemplary signal configuration in accordance with embodiments of the present disclosure.

FIG. 5B is a block diagram of an exemplary frequency spectrum of subcarriers and corresponding bins in accordance with embodiments of the present disclosure.

FIG. 5C is a graphical block diagram of an exemplary transmission scheme of OFDM symbol tones/signals in accordance with embodiments of the present disclosure.

FIG. 5D is a block diagram of an exemplary OFDM symbol payload portion transmission with reduced header information in accordance with embodiments of the present disclosure.

FIG. 5E is a block diagram of various exemplary subcarrier configuration assignments in accordance with embodiments of the present disclosure.

FIG. 6A is a block diagram of several exemplary constellation maps associated with signal communications in accordance with embodiments of the present disclosure.

FIG. 6B is a block diagram of several exemplary constellation map errors associated with signal communications in accordance with embodiments of the present disclosure.

FIG. 7 is a logical flow chart of an exemplary testing mode selection process in accordance with embodiments of the present disclosure.

FIG. 8 is a block diagram of an exemplary reduced header mode testing process in accordance with embodiments of the present disclosure.

FIG. 9A is a block diagram of exemplary autocorrelation graph results in accordance with embodiments of the present disclosure.

FIG. 9B is a block diagram of an exemplary autocorrelation process in accordance with embodiments of the present disclosure.

FIG. 10 is a flow chart of an exemplary equalizer value determination process in accordance with embodiments of the present disclosure.

FIG. 11A is a flow chart of an exemplary ideal pilot tone determination process in accordance with embodiments of the present disclosure.

FIG. 11B is a graph of an exemplary simulated channel response when there is a signal with a full header or a signal with a non-blind known stimulus in accordance with embodiments of the present disclosure.

FIG. 11C is a graph illustrating the locations of several exemplary pilot bin frequency responses in accordance with embodiments of the present disclosure.

FIG. 12A is a flow chart of an exemplary interpolation process with iterative update/re-determination of equalization values within a bin, in accordance with embodiments of the present disclosure.

FIG. 12B is an exemplary graph of results of an interpolation process with iterative update/re-determination of equalization values within a bin, in accordance with embodiments of the present disclosure.

FIGS. 12C and 12D are flow charts of an exemplary interpolation process with iterative update/re-determination of equalization values within a bin, in accordance with embodiments of the present disclosure.

FIG. 12E is a block diagram of an exemplary subcarrier bin configuration 1291 in accordance with embodiments of the present disclosure.

FIG. 12F is a block diagram of exemplary signal information processing operations in accordance with embodiments of the present disclosure.

FIG. 12G is a block diagram of exemplary signal information processing operations in accordance with embodiments of the present disclosure.

FIG. 12H is a block diagram of exemplary signal information processing operations in accordance with embodiments of the present disclosure.

FIG. 12I is a block diagram of equalizer value listing 1293 associated with bins of OFDM values in a burst or frame.

FIG. 12J is a flow chart of an average equalizer process 1500 in accordance with some embodiments of the disclosure.

FIG. 13A is an exemplary graph of a frequency response for a bandwidth comprising multiple bins/subcarriers in accordance with embodiments of the present disclosure.

FIG. 13B is an exemplary graph of a frequency response for a bandwidth comprising multiple bins/subcarriers in accordance with embodiments of the present disclosure.

FIG. 14A is a flow chart of an exemplary enhanced equalizer process in accordance with embodiments of the present disclosure.

FIG. 14B is a block diagram of several exemplary signal information processing operations in accordance with embodiments of the present disclosure.

FIG. 15 is a flow chart of an exemplary current data bin label reassignment process in accordance with embodiments of the present disclosure.

FIG. 16 is a flow chart of an exemplary reduced header with reference signal training mode testing process in accordance with embodiments of the present disclosure.

FIG. 17 is a block diagram of an example 802.11ax 20 MHz ideal waveform in accordance with embodiments of the present disclosure.

FIG. 18 is a graph of an exemplary payload-only ideal IQ waveform when the input parameter HeaderlessDemod is set to training mode (e.g., HeaderlessDemodTraining and Execute, etc.) in accordance with embodiments of the present disclosure.

FIG. 19 is a graph of exemplary extracted payload-only ideal signal in accordance with embodiments of the present disclosure.

FIG. 20 is graph of a demodulated payload-only signal in accordance with embodiments of the present disclosure.

FIG. 21 is a flow chart of an exemplary header mode testing process in accordance with embodiments of the present disclosure.

FIG. 22 is a block diagram of an exemplary electronic system which may be used as a platform to implement and control methods in accordance with embodiments of the present disclosure.

FIG. 23 is a block diagram of exemplary algorithm Reduced Header Processing Module 230 in accordance with embodiments of the present disclosure.

FIG. 24 is a block diagram of an exemplary algorithm interpolation module in accordance with embodiments of the present disclosure.

FIG. 25 is an expanded versions of an exemplary algorithm Enhanced Equalizer Module and Reassignment Module.

FIG. 26 is a block diagram of an exemplary algorithm Training Module Process Module in accordance with embodiments of the present disclosure.

FIG. 27 is a block diagram of an exemplary algorithm Pilot Bin Ideal Value Module in accordance with embodiments of the present disclosure.

FIG. 28 is a block diagram of an exemplary algorithm Iterative Interpolation Module in accordance with embodiments of the present disclosure.

FIG. 29 is a block diagram of an exemplary testing method in accordance with embodiments of the present disclosure.

FIG. 30 is a block diagram of an exemplary reduced header mode testing process in accordance with embodiments of the present disclosure.

### DETAILED DESCRIPTION

Reference will now be made in detail to the preferred embodiments of the disclosure, examples of which are illustrated in the accompanying drawings. While the disclosure will be described in conjunction with the preferred embodiments, it will be understood that they are not intended to limit the disclosure to these embodiments. On the contrary, the disclosure is intended to cover alternatives, modifications, and equivalents, which may be included within the spirit and scope of the disclosure as defined by the appended claims. Furthermore, in the following detailed description of the present disclosure, numerous specific details are set forth in order to provide a thorough understanding of the present disclosure. However, it will be obvious to one ordinarily skilled in the art that the present disclosure may be practiced without these specific details. In other instances, well known methods, procedures, components, and circuits have not been described in detail as not to unnecessarily obscure aspects of the current disclosure.

Presented systems and methods include efficient and effective approaches for handling modulation/demodulation in various scenarios, including situations where properly handling signal modulation/demodulation would otherwise be difficult (e.g., due to limited capabilities/resources in a device, economically unviable, etc.). In some embodiments, communication signals are demodulated without reliance on some demodulation parameters being included in the signals that would otherwise be utilized in traditional approaches. In some exemplary implementations, a “reduced header information demodulation determination” process is performed on a communication signal where header information (e.g., preamble information, channel estimation related information, reference information, etc.) is not initially readily available in the communication signal itself, and demodulation parameter information is advantageously derived/developed/extrapolated from other information in the communication signal. By reducing the header size, devices under test (DUTs) with limited resources are efficiently tested thereby reducing testing cost and complexity.

In view of the above, embodiments of the present disclosure enable efficient and effective signal processing component testing. In some embodiments, a “reduced header information demodulation” process is performed by an automated test equipment (ATE) system in response to a signal being transmitted to or by a device under test (DUT). The process is performed in a test environment on a payload portion of information in which demodulation parameter information that would normally be included in other portions of a communication protocol. The demodulation parameter information is not otherwise readily available to the DUT. Results of up converting and down converting a signal in a DUT are captured and conveyed to the ATE for post processing in accordance with the “reduced header information demodulation” process. In some exemplary implementations, the reduced header information demodulation process is implemented by a computer algorithm running on a work station associated with the ATE. The payload portion is communicated in compliance with payload specifications of a communication protocol and information and data related to demodulation parameters specified by other portions of the protocol are not included in the signal. In some exemplary implementations, the signal specifically includes less header/preamble information associated with the communication protocol than would otherwise be normally be included in a signal.

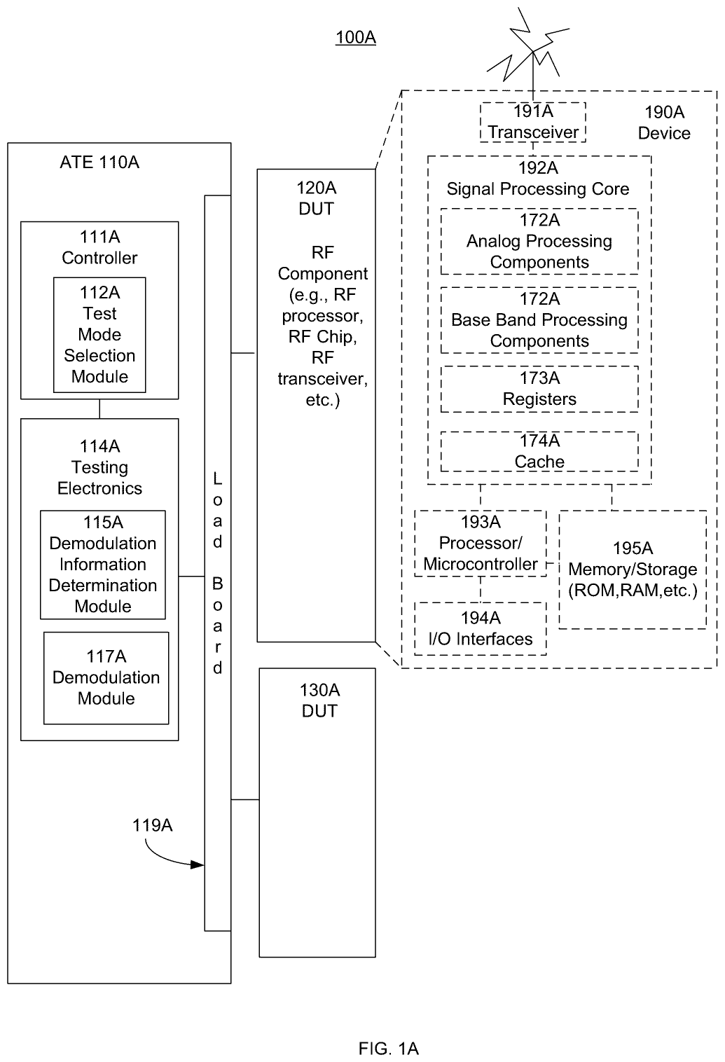

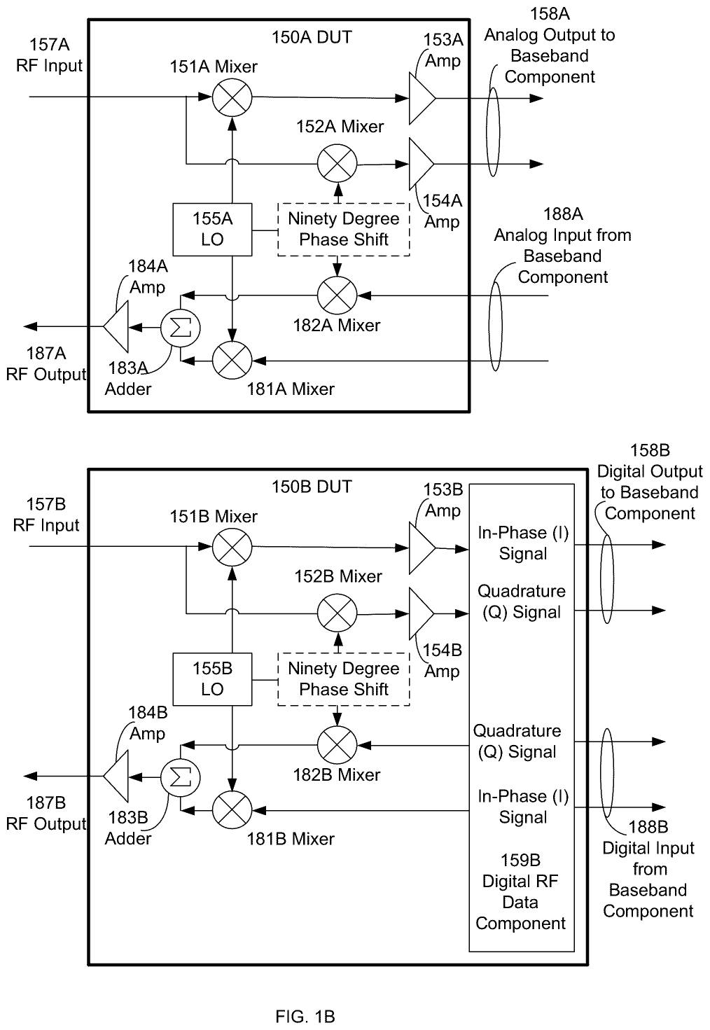

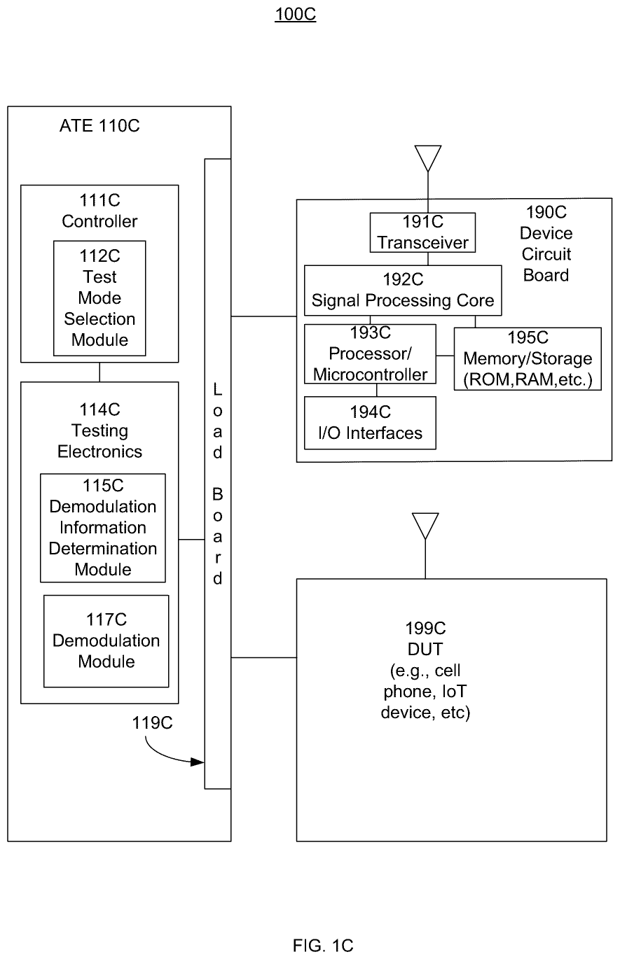

FIG. 1A is a block diagram of an exemplary test environment or test system 100A in accordance with embodiments of the present disclosure. Test system 100A is included in some embodiments of a signal processing test system. The test environment or test system 100A includes automated test equipment (ATE) 110A and devices under test (DUT) (e.g., 120A, 130A, etc.). ATE 110A includes controller 111A, testing electronics 114A, test or load board 119A, and a user interface (not shown). In some embodiments, controller 111A is configured for direct testing of the plurality of DUTs (e.g., DUTs 120A, 130A, etc.). Testing electronics 114A are configured to test the plurality of DUTs. Controller 111A is coupled to testing electronics 114A and to test board or load board 119A. Load board 119A is configured to communicatively couple with the testing electronics 114A and a plurality of devices under test (e.g., DUT 120A, DUT 130A, etc.).

In some exemplary implementations, controller 111A comprises a test mode selection module 112A. The test mode selection module selects between 1) a reduced header signal processing test mode process, 2) reduced header with reference signal training mode testing process, and 3) a header test mode process. Additional characteristics/features and operations of these modes are presented in other portions of this description. Testing electronics 114A are communicatively coupled to the controller 111A. It is appreciated that various factors can be utilized in making a mode selection. For instance, a portion of testing for a DUT is conducted in one mode and another portion of testing for the DUT is conducted in another mode. In some embodiments, a header test mode is selected for one burst (e.g., a burst with few OFDM symbols in the payload, etc.) and the reduced header signal processing test mode process is selected for another burst (e.g., a burst with many OFDM symbols in the payload, etc.).

The testing electronics 114A comprises demodulation information determination module 115A and demodulation information determination module 117A, which are communicatively coupled to one another. Demodulation information determination module 115A gathers information associated with demodulation operations, including determining signal processing information that is otherwise not included in the reduced header information. Demodulation module 117A performs demodulation operations based upon information received from demodulation information determination module 115A. In some embodiments, testing electronics 114A directs testing of the DUTs and includes resources that are assigned to the respective DUTs. Testing electronics 114A can include a Field Programmable Gate Array (FPGA) in some implementations. Additional characteristics/features and operation of the test mode selection module 112A and demodulation information determination module 115A are presented in other portions of this description.

In some embodiments, the test mode selection module 112A selects a reduced header signal processing test process and the demodulation information determination module 115A determines signal processing information associated with demodulation operations, where the signal processing information is otherwise not included in a header portion of a signal associated with the demodulation operations.

Various information associated with testing the DUT (e.g., selection of a test mode, test results, preliminary analysis results, reconfigured test information, testing directions, etc.) is communicated between test equipment 110A and the user test interface. In some exemplary implementations, a user test interface includes a processing unit, a memory, and user input/output components (e.g., display, keyboard, etc.). The memory can store testing related information, the processing unit can process the information, and the user input/output components can convey information to and from a user.

In some embodiments, a DUT (e.g., 120A, 130A, etc.) is considered a signal processing component. DUT 120A can be configured for eventual implementation in the end-use device 190A. In some embodiments, DUT 120A is configured for eventual end-use implementation in a communication device or system, e.g., a cell phone, an internet of things (IoT) device, or a device compliant with an Institute of Electrical and Electronics Engineers (IEEE) 802.11 wireless network protocol/standard, etc. Device 190A includes transceiver 191A, signal processing core 192A, processor/microcontroller 193A, memory storage 195A (e.g., ROM/RAM, etc.) and I/O interfaces 194A (e.g., digital interface pins, etc.). Signal processing core 192A includes analog signal processing components 172A, base band components 172A, registers 173A, and cache 174A. While DUT 120A may have access to other resources and capabilities (e.g., memory/storage 195, processor/microcontroller 193A, etc.) when integrated in device 190A, these resources are not typically available to DUT 120A during testing before DUT 120A is integrated in device 190A.

DUT 120A is primarily directed to performing analog operations. In some exemplary implementations, DUT 120 is a radio frequency (RF) integrated circuit chip. In some embodiments, DUT 120A is directed to performing communication operations. DUT 120A may be configured to perform transceiver operations, analog signal processing, and so on.

In some embodiments, a DUT is an RF component that performs various aspects of communication signal transmission and reception operations, including performing up-conversion and down-conversion operations on the signal. In transmission activities, modulation information (e.g., in the form of a modulation signal, I and Q signals, etc.) are combined and upconverted to an RF signal by multiplying a local oscillator generated carrier frequency by a baseband modulation signal. In transmission activities, modulation information (e.g., in the form of a modulation signal, I and Q signals, etc.) are combined and upconverted to an RF signal by multiplying a local oscillator generated carrier frequency by a baseband modulation signal. It is appreciated the DUTs can have various interface configurations (e.g., analog, digital, etc.) for coupling with baseband components. RF components accommodate filtering (e.g., may do a portion of interpolation in the analog domain and digital domain, etc.) in order to meet spectrum mask requirements. In some embodiments, novel testing systems and methods presented herein receive information based upon captured samples of up-converted transmitted communication signals and down-converted received communication signals. The novel ability to accurately process payload symbols with reduced header information enables testing of DUTs with limited memory resources to store captured samples that would otherwise be overload with samples from a large header portion.

FIG. 1B is a block diagram of two exemplary radio frequency (RF) integrated circuit DUTs in accordance with embodiments of the present disclosure. DUT 150A includes mixer 151A, mixer 152A, amplifier 153A, amplifier 154A, mixer 181A, mixer 182A, adder component 183A, amplifier 184A, and local oscillator 155A. Mixer 151A is coupled to amplifier 153A and mixer 152A is coupled to amplifier 154A. Mixer 181A and mixer 182A are coupled adder component 183A which is coupled to amplifier 184A. Local oscillator 155A is coupled to mixer 151A, mixer 152A, mixer 181A, and mixer 182A. Local oscillator provides an in-phase signal to mixer 151A and 181A while also providing a 90 degree phase shifted quadrature signal to mixer 152A and mixer 182A. Radio frequency (RF) input signal 157A is fed to mixers 151A and 152A. Amplifier 153A and amplifier 154A provide analog output signal 158A to a baseband component. Analog input signal 188A from a baseband component is fed to mixers 181A and 182A which in turn provide input to adder component 183A. Adder component 183A combines the in-phase portion of a signal and the quadrature phase portion of the signal and forwards the results to amplifier 184A. Amplifier 184A provides RF output signal 187A.

DUT 150B includes mixer 151B, mixer 152B, amplifier 153B, amplifier 154B, mixer 181B, mixer 182B, adder component 183B, amplifier 184B, local oscillator 155B and digital RF data component 159B. Mixer 151B is coupled to amplifier 153B and mixer 152B is coupled to amplifier 154B. Local oscillator 155B is coupled to mixer 151B, mixer 152B, mixer 181B, and mixer 182B. Local oscillator provides an in-phase signal to mixer 151B and 181B while also providing a 90 degree phase shifted quadrature signal to mixer 152B and 182B. Radio frequency (RF) input signal 157B is fed to mixers 151B and 152B. The outputs of amplifier 153B and amplifier 154B are coupled to digital RF data component 159B. Digital RF data component 159B provides a digital output signal 158B to a baseband component. Digital input signal 188B from a baseband component is fed to mixers 181B and 182B which in turn provide input to adder component 183B. Adder component 183B combines the in-phase portion of a signal and the quadrature phase portion of the signal and forwards the results to amplifier 184B. Amplifier 184B provides RF output signal 187B.

It is appreciated there are various testing approaches. There can be different types of DUTs with various configurations. In some embodiments, a DUT may be configured as a more complete device/system (e.g., integrated system, circuit board level, etc.) closer to final end use configuration. FIG. 1C is a block diagram of exemplary test environment or test system 100C in accordance with some embodiments. Exemplary test environment or test system 100C is similar to exemplary test environment or test system 100A except a device circuit board 190C is being tested as a DUT that is similar to DUT 190A.

The test environment or test system 100C of FIG. 1C includes automated test equipment (ATE) 110C and devices under test (DUT) (e.g., 1900, 199C, etc.). ATE 110C includes controller 111C, test mode selection module 112C, testing electronics 114C, demodulation information module 115C, demodulation module 117C, test or load board 119C, and a user interface (not shown). In some exemplary implementations, device 190C includes transceiver 191C, signal processing core 192C, processor/microcontroller 193C, memory storage 195C (e.g., ROM/RAM, etc.) and I/O interfaces 194C (e.g., ATE digital interface pins, etc.). In some embodiments, DUT 199C is an end-use product (e.g., a cell phone, a device compliant with an IEEE 802.11 wireless network protocol/standard, etc.). A portion of testing a DUT (e.g., DUT190C, DUT 199C, etc.) is directed to testing an analog component (e.g., RF chip, RF processor, etc.) within the DUT.

Utilizing the presented approaches (e.g., reduced header demodulation, etc.) offers several advantages as DUT configurations approach end-use device level. Selection between modes (e.g. full header mode, reduced header mode, etc.) enables flexible testing and the potential for overall reduced testing time. Reduced header demodulation still offers several benefits as DUT configurations approach the end-use level. When aiming to directly test an analog component within a DUT, reduced length test pattern streams that are more directed to an analog component can be utilized. Enabling testing that is isolated to the analog component reduces risks of other components corrupting the test results. The ability to isolate testing also facilitates “dividing” the testing or directing the testing to different DUT parts at different times, which in turn helps simplify debugging issues, etc.

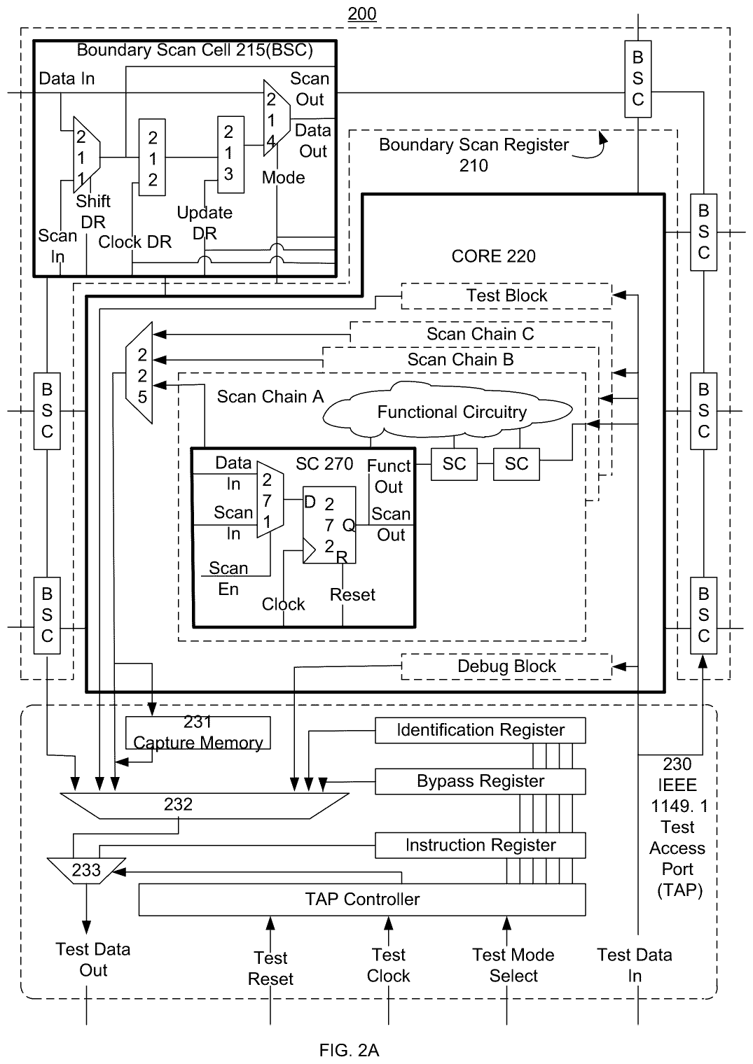

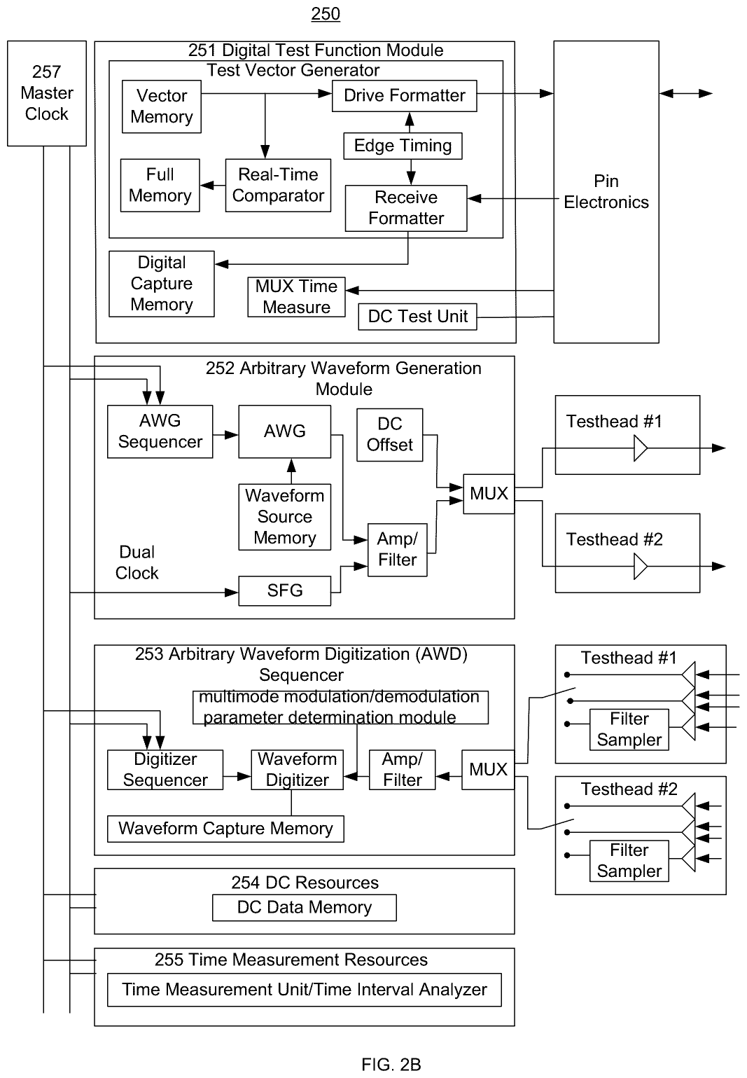

In some embodiments, a DUT may include testing capabilities. FIG. 2A is a block diagram of an exemplary DUT 200 in accordance with embodiments of the present disclosure. It is appreciated that DUT 200 is similar to DUT 120A. The DUT 200 includes Boundary Scan Register 210, Core 220 and Test Access Port 270. Boundary Scan Register 210 includes a plurality of Boundary Scan Cells (BSC). The boundary scan cells are similar to boundary scan cell 215. Boundary scan cell 215 includes multiplexers (MUXs) 211 and 214, and flip flops 212 and 213. MUX 211 is coupled to flip flop 212 which is coupled to flip flop 213, which is in turn coupled to MUX 214. Based on a shift DR signal, MUX 211 can select and forward either normal operation data input or forward scan test data input as a scan out signal and also forward to flip flop 212 for latching in response to a clock DR. Flip flop 212 is updated with information in response to an update DR signal.

MUX 214 selects and forwards either data in, or information from flip flop 213, based upon a mode control signal. Core 220 includes scan chain region A, scan chain region B, and scan chain region C. Scan chain A region includes combinational circuitry and a plurality of scan cells (SC) coupled together in a scan chain fashion. Combinational circuitry performs normal functions during mission mode operations. The scan cells can function as both sequential circuitry during mission mode operations and also support test operations (e.g., scan in, capture, scan out, etc.) during test mode operations. Test information can be communicated from one scan cell to another in the scan chain. It is appreciated that a DUT can also include flip flops that are not part of a scan chain and flip flops dedicated to scan chain operations. Scan cell (SC) 270 includes multiplexer 271 and flip flop 272. Based on a scan enable signal, MUX 271 can select and forward either mission mode operation data input or scan test data input to flip flop 272 in response to clock and reset signals. Information is output from flip flop 272 to other mission mode operation circuitry and to other scan chain components.

Test access port (TAP) 230 includes a TAP controller coupled to a test reset input, a test clock input, a test mode input, MUX 233, an instruction register, a bypass register, and an identification register which are coupled to MUX 232. MUX 232 is also coupled to MUX 225, additional capture memory 231, the test block and the bound scan register. MUX 233 is also coupled to the instruction register, MUX 232, test data output. A test data input is coupled to the boundary scan register, the debug block, the test block, scan chain A, scan chain B, and scan chain C. DUT 200 can be compatible with various standards (e.g., JTAG, IEEE 1149.1, etc.).

Typically, there is not enough memory resources (e.g., scan test chain resources, capture memory resources, and waveguide generation resources, etc.) in a DUT to conveniently support testing of various functions (e.g., communication functions, demodulation operations, etc.) without the novel approaches presented in this description. There are significant problems and challenges to include large amounts of dedicated circuitry and other components for testing to analog signal processing components (e.g., limited chip space, being relatively expensive for limited number of times components may be tested, etc.). In some embodiments, regarding a DUT that primarily performs analog signal processing during normal non-test operations, the signals are processed and forwarded to other components in the system without a need for “storing” intermediate or end results on/in the analog DUT. Analog processing components do not include much normal operation components (e.g., storage capabilities, flip flops in a scan chain, etc.) available for dual normal/test operations. Problems and issues associated with a “lack” of storage capabilities available for testing operations (e.g., capture, scan chain, etc.) becomes exacerbated with advances in technology and communication protocols.

FIG. 2B is a block diagram of an exemplary Automatic Test System (ATE) 250 in accordance with embodiments of the present disclosure. Automatic Test System 250 incudes Digital Test Function Module 251, Arbitrary Waveform Generation Module 252, Arbitrary Waveform Digitization (AWD) Sequencer 253, DC Resources 254, and Time Measurement Resources 255, all of which are coupled to Master Clock 257. Digital Test Function Module 251 includes a vector memory coupled to a real-time comparator (coupled to full memory) and drive formatter and an edge timing component. The edge timing component is coupled to a receive formatter which is coupled to a digital capture memory. Pin electronics are coupled to the drive formatter, a receive formatter, a MUX time measure, and a DC test unit.

Arbitrary Waveform Generation Module 252 includes an arbitrary waveguide generation (AWG) component which is coupled to an AWG sequencer component, a waveform source memory, and an amp/filter which is in turn coupled to an SFG and a MUX. The MUX is coupled to a DC offset component, testhead #1 and testhead #2. Arbitrary Waveform Digitization (AWD) Sequencer 253 includes a waveguide digitizer coupled to a multimode modulation/demodulation parameter determination module, a Digitizer Sequencer, a Waveform Capture Memory and an Amp/Filter which is coupled to a MUX. The MUX is coupled to testhead #1 and testhead #2. DC Resources 254 includes a DC data memory, and a Time Measurement Resources module 255 which includes a time measurement unit/time interval analyzer.

In some embodiments, there is not enough memory resources (e.g., capture memory resources, waveguide generation resources, etc.) to conveniently support testing of various functions (e.g., communication functions, demodulation operations, etc.). As more functionality is integrated in a DUT and communication protocols become more complicated, testing of the DUT in turn becomes more complicated and increases the demand for more capable testing systems. Testing is further complicated by the desire to test numerous DUTs concurrently in parallel. While the testing resources of ATEs can be considerable they are not infinite and assigning resources for all the different testing activities becomes costly and impractical, which complicates the assignment of testing resources. As a result, there is not sufficient memory available for some activities (e.g., arbitrary waveguide generation, etc.) on an individual DUT basis in conventional testing systems.

Novel systems and methods described herein enable the ATE system to perform testing of DUT modulation and demodulation performance that would otherwise be impractical or impossible. The novel systems and methods also increase the ATE system performance. Testing efficiency is improved through reducing the need for large test patterns associated with long header information (e.g., which would otherwise be time consuming, inefficient, prone to error, etc.). The amount of ATE resources (e.g., memory resources, etc.) otherwise needed to handle the large test patterns is also reduced.

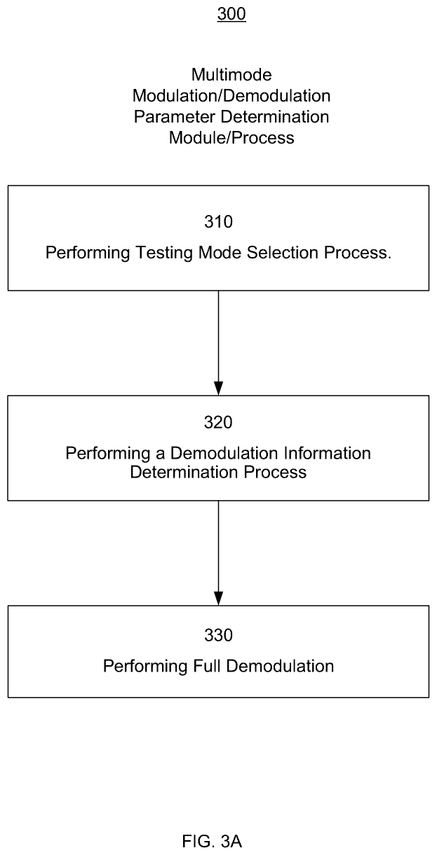

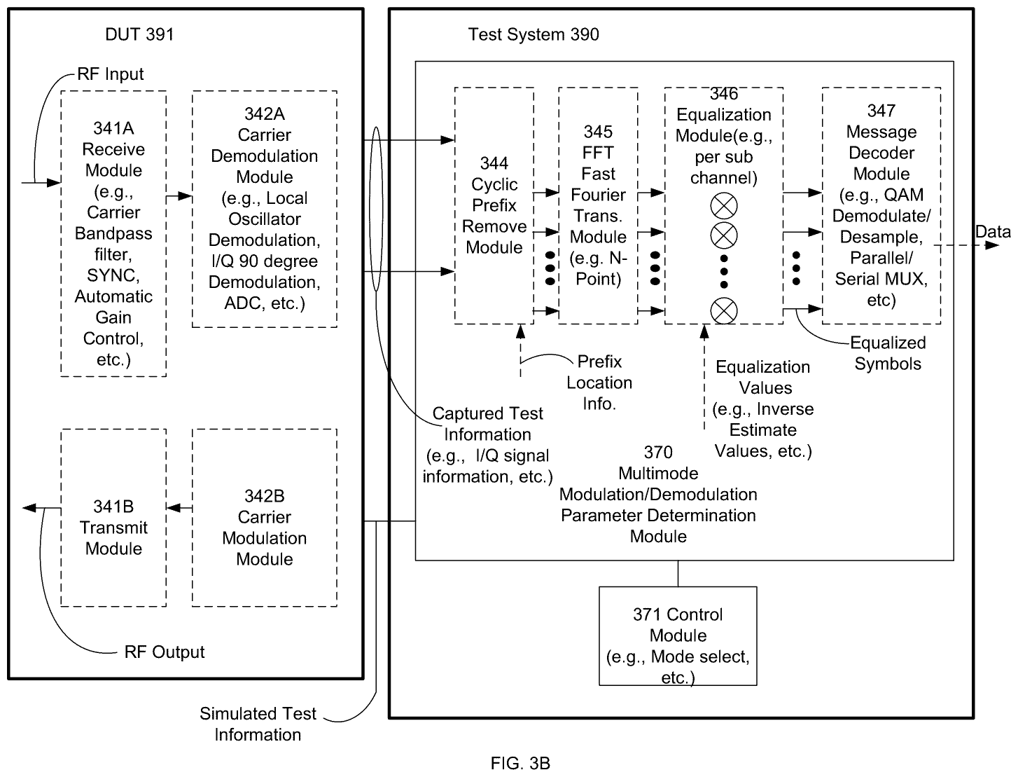

FIG. 3A is a flow chart of an exemplary multimode modulation/demodulation parameter determination method 300 including a reduced header process in accordance with embodiments of the present disclosure. Multimode modulation/demodulation parameter determination method 300 is included in some embodiments of a signal processing test method. In one exemplary implementation, multimode modulation/demodulation parameter determination method 300 is directed to testing operations in a radio frequency (RF) component (e.g., up-conversion operations, down-conversion operations, initial front-end transmission operations, initial front-end receiving operations, etc.). Multimode modulation/demodulation parameter determination method 300 readily accommodates effective testing of an RF component's performance in modulating and demodulating communication signals with reduced header information.

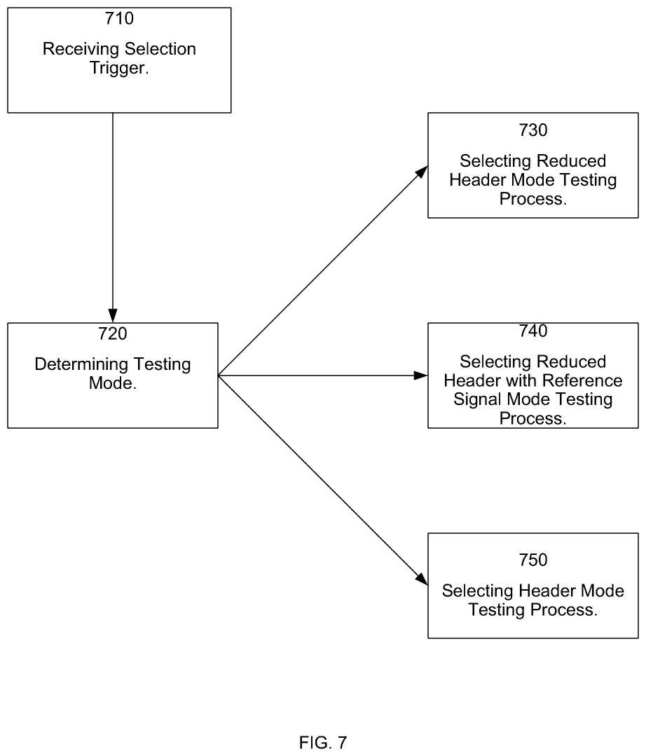

In block 310, a testing mode selection process is performed. The testing mode selection process enables flexible and efficient responses to various testing scenarios. Testing modes are available with capabilities that effectively address different demodulation issues such as communication bursts with very long header portions and so on. Additional descriptions of the testing mode selection process operations are presented in other portions of this specification (e.g. description of a testing mode selection process shown in FIG. 7, etc.).

In block 320 of FIG. 3A, a demodulation information determination process is performed. In some embodiments, various types of demodulation information (e.g., timing information, frequency errors, equalization values, etc.) are determined based upon reduced header mode operations. In some exemplary implementations, the demodulation information is determined without conventional reliance on header information. Additional descriptions of demodulation information determination process operations are presented in other portions of this specification (e.g., blocks 730, 740, 750, 800, 1600, etc.). In block 330, full demodulation is performed. In some embodiments, full demodulation includes determining various parameters associated with demodulation. The parameters can include a full equalizer value, a frequency error value, and a sampling clock error, error vector magnitude (EVM), among others. Additional descriptions of full demodulation operations are presented in other portions of this specification.

In some embodiments, full demodulation is performed from the perspective of a DUT. In some exemplary implementations, a DUT is a radio frequency (RF) integrated circuit (e.g., similar to DUTs 150A and 150B) and full demodulation is the demodulation that produces an output signal of the DUT (158A, 158B). It is appreciated that additional demodulation that is not considered part of the full demodulation may be performed on the output signal of the DUT. In some exemplary implementations, additional demodulation operations (e.g., FFT, data bit decoding, etc.) may be performed on communication signals by backend baseband digital signal processing but are not considered part of full demodulation from the perspective of a radio frequency (RF) integrated circuit DUT. In other embodiments, additional demodulation operations (e.g., FFT, data bit decoding, etc.) may be performed on communication signals by backend baseband digital signal processing but are considered part of full demodulation (e.g., from the perspective of different DUT (e.g., 190C, 199C, etc.).

FIG. 3B is a block diagram of an exemplary multimode modulation/demodulation parameter determination test environment. Multimode modulation/demodulation parameter determination test environment includes test system 390 (e.g., similar to ATE 110A, 110C, etc.) and DUT 391 (e.g., similar to DUT 120A, 150A, 150B, etc.). Test system 390 directs testing of DUT 391 in which various types of signal processing tests are performed. In some embodiments, test system 390 provides simulated test information to DUT 391 and receives captured test information (e.g., associated with real in-phase (I) signals, imaginary quadrature phase (Q) signals, etc.). It is appreciated for EVM the test system 390 can direct testing of both the transmitter RF output characteristics and receiver RF input characteristics. DUT 391 performs operations associated with receive module 341A, carrier demodulation module 342A, transmit module 341B, carrier modulation module 342B. Test system 390 includes multimode modulation/demodulation parameter determination module 370 and control module 371. Tests system 390 performs operations associated with cyclic prefix removal module 344, Fast Fourier Transform (FFT) module 345, equalization module 346, and message decoder module 347. In some embodiment, portions of carrier demodulation module 342A operations are performed in test system 390. Receive module 341 performs various activities associated with initial reception of a communication (e.g., carrier bandpass filter, synchronization operations, automatic gain control, etc.).

Carrier demodulation module 342A performs various operations associated with demodulating the carrier frequency (e.g., demodulation based upon local oscillator, coordinating 90 degree demodulation into an in-phase (I)/“real” signal component and a quadrature (Q)/“imaginary” component, etc.). Carrier modulation module 341B similarly performs various operations associated with modulating the carrier frequency. In some embodiments, operations associated with receive module 341A, the carrier demodulation module 342A, transmit module 341B, carrier modulation module 341B are performed by transceiver components and analog processing components (e.g., 191A, 172A, etc.).

Multimode modulation/demodulation parameter determination module 370 of FIG. 3B ascertains various modulation/demodulation parameters. In some embodiments, multimode modulation/demodulation parameter determination module 370 performs a multimode modulation/demodulation parameter determination method. In some exemplary implementations, the multimode modulation/demodulation parameter determination method is similar to method 300. Multimode modulation/demodulation parameter determination module 370 receives input from test system 390. In some embodiments, the input indicates a testing mode selection. Multimode modulation/demodulation parameter determination module 370 operations may be performed in test system 390.

The cyclic prefix removal module 344 removes a cycle prefix added to the signals (e.g., at the transmission source, etc.). Fast Fourier Transform (FFT) module 345 transforms the signals into signals corresponding to a discrete Fourier series configuration. Equalization module 346 performs equalization operations on the signals based on information received from (e.g., inverse estimate values, etc.). Multimode modulation/demodulation parameter determination module 370 performs data decode operations (e.g., QAM demodulate/de-sample operations, parallel to serial conversion, and MUX operations, etc.).

Message decoder module 347 performs various demodulation operations. In some embodiments, message decoder module 347 outputs a stream of data corresponding to raw transmitted data. In some exemplary implementations, message decoder module 347 decodes data symbols (e.g., QAM demodulate/De-sample data constellation point information, and Parallel to Serial Multiplexing (MUX) to concatenate logical bits corresponding to the constellation point information, etc.).

Communicated information is organized in “blocks” of information that correspond to a portion of a signal communication (e.g., header portion, payload or body portion, etc.). In some exemplary implementations, the blocks of information are communicated in accordance with protocols (e.g., communication protocols, network protocols, storage protocols, etc.) that include definitions of organizations and configurations for the blocks and information. In some embodiments, the information includes a header portion and data/payload portion. In some embodiments, a communication protocol configures information in accordance with communication protocol layers and the header portion includes supplemental information (e.g., signal processing related parameters, constants, metadata, etc.) associated with the protocol layer and the data payload portion includes data/information from another protocol layer.

Moreover, the communication protocol layers are organized in a communication protocol layer hierarchy. It is appreciated there can be several layers in a communication protocol layer hierarchy. In some exemplary implementations, the protocol layers are organized from a layer that is directed to the configuration of user/host application information/data to a layer that is directed to the configuration of information for actual transmission/reception on a physical communication media, with multiple layers in between. In some embodiments, the layers are referred to as higher or lower with respect to one another's relative position in the hierarchy. A layer directed to the configuration of user/host application information/data is referred to as a higher layer and a layer that is directed to the configuration of information for actual transmission/reception on a physical communication media is referred to as a lower layer. In some exemplary implementations, a layer that is directed to the configuration of user/host application information/data is referred to as a lower layer and a layer that is directed to the configuration of information for actual transmission/reception on a physical communication media is referred to as a higher layer.

The header portion is information that is transmitted before the payload portion. It is appreciated that some protocols have different designations (e.g., preamble, header, etc.) for information that is transmitted before the data/payload portion. In an effort to avoid confusion, when referenced herein, header information includes information received in a preamble portion of a signal, information received in a header portion of a signal, and a combination of information received in both a preamble portion and a header portion of a signal.

In some embodiments, signals are configured in accordance with protocol data units (PDUs) of communication protocols. In some exemplary implementations, a PDU is a single unit of information communicated (e.g., transmitted, received, etc.) among similar entities (e.g., entities considered in a similar protocol level, peer entities of a network, etc.). A PDU includes a portion of information associated with a header portion/section and information associated with a data/payload portion or section. A data/payload portion can be considered a service data unit (SDU). In some exemplary implementations, the service data unit is a unit of information passed between a higher communication protocol level (e.g., a level closer to the user/host application level, etc.) and a lower communication protocol level (e.g., a level closer to the physical communication level, etc.) to be serviced/encapsulated by the lower communication protocol level. It is appreciated that a first communication protocol layer payload portion (e.g., from the perspective of a first communication protocol layer, etc.) can include information that is configured in a second communication protocol layer as second communication protocol layer header information and second communication protocol layer payload information. The first communication protocol layer is a higher communication protocol layer and the second communication protocol layer is a lower communication protocol layer.

It is appreciated that the described novel approach is flexible in that it is configurable for implementation with various communication protocols. In some embodiments, the described novel approach is compatible with the IEEE 802.11 family of wireless network protocols/standards (e.g., 802.11 a/b/g/n/ac/ax/be etc.). In other embodiments, the described novel approach is compatible with a WIFI family of wireless network protocols/standards (e.g., Wi Fi 4, 5, 6, 7, etc.). The described novel approach may also be compatible with communication hierarchical models/suites (e.g., Open Systems Interconnection (OSI), Internet Communication Suite, Transmission Control Protocol/Internet Protocol (TCP/IP), etc.). The basic frame organization/configuration of an 802.11 family burst comprises a header portion followed by a data/payload portion (which includes OFDM symbols).

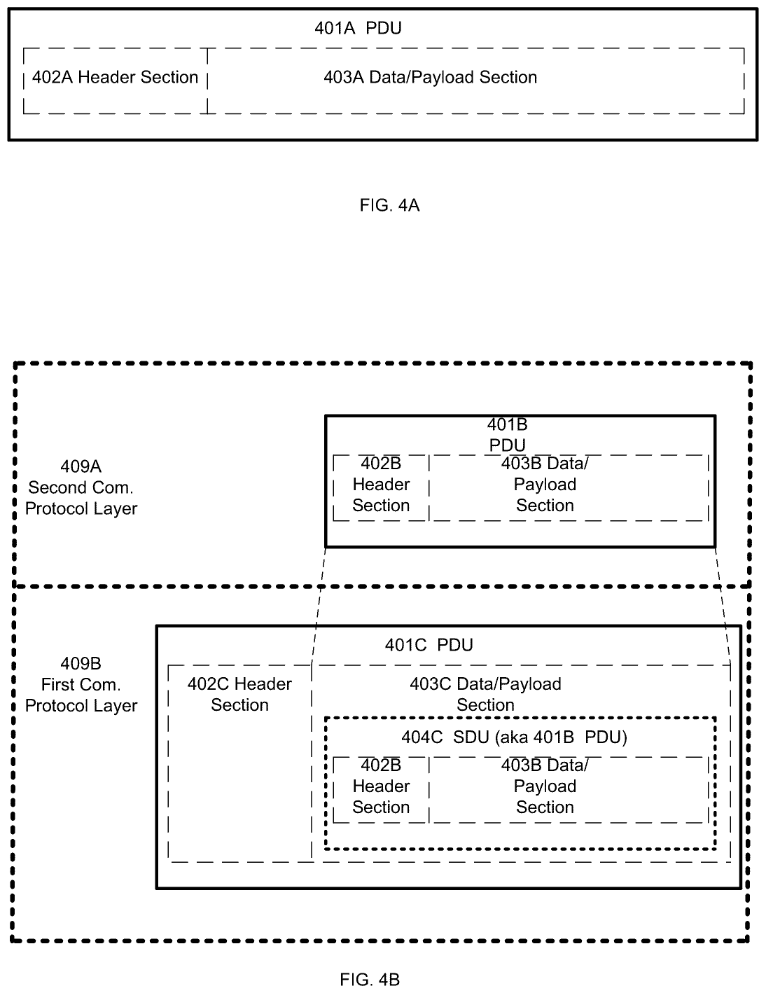

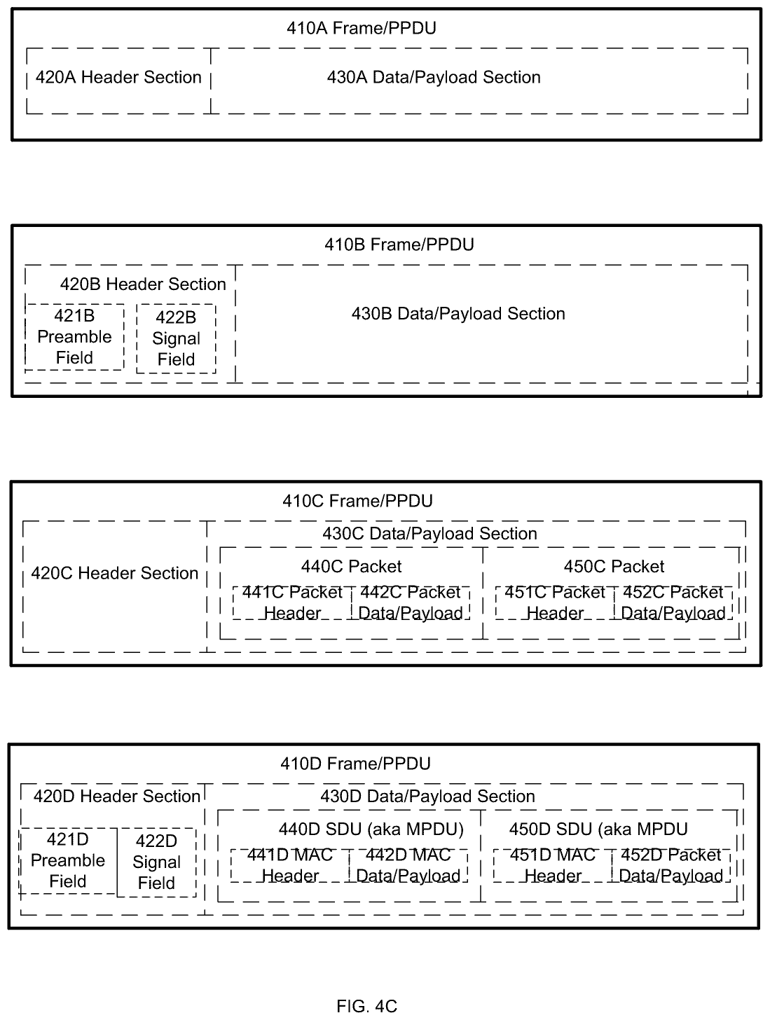

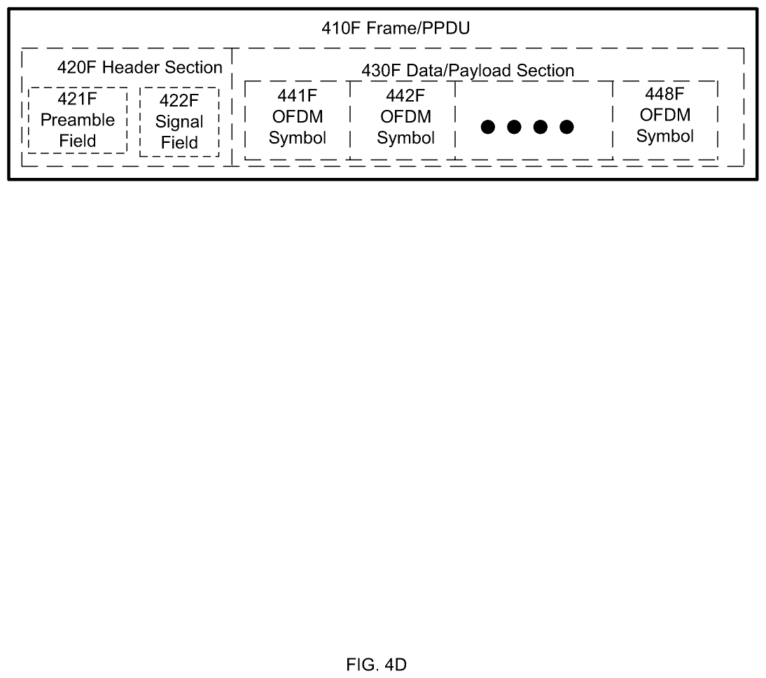

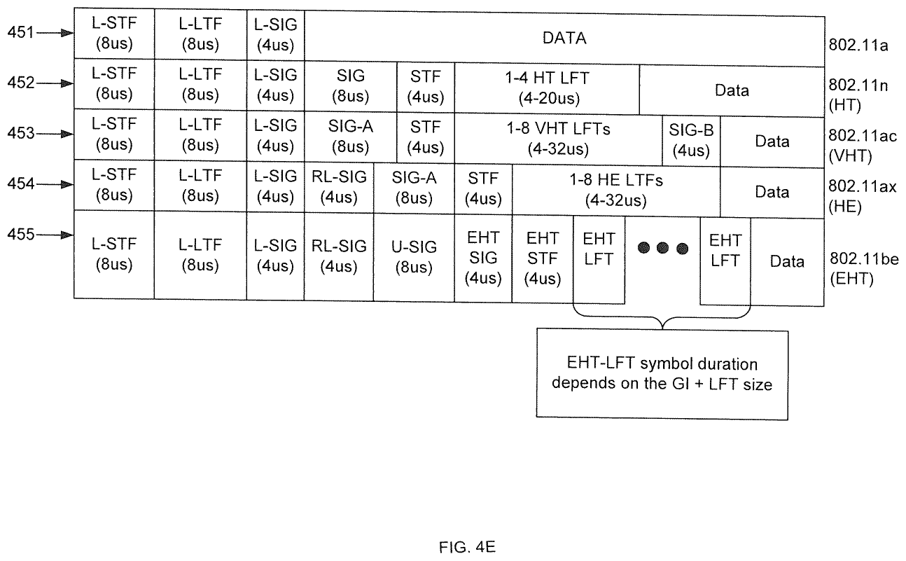

FIG. 4A is a block diagram of exemplary PDU 401A frame or packet in accordance with some embodiments. PDU 401A is configured in accordance with a communication protocol. PDU 401A includes a header portion/section 402A and a data/payload portion 403A. The header portion/section 402A and data/payload portion/section 403A comprise information organized in fields. It is appreciated the PDU 401A can be considered a communication frame, communication packet, and so on. It is appreciated that the communication information can be configured with other fields not shown (e.g., tail/tailer portions/sections at the end of the PDUs, etc.).

FIG. 4B is a block diagram of exemplary PDU frame or packet at different communication protocol/model layers in accordance with embodiments of the present disclosure. PDU 401B is a block diagram of an exemplary frame at a second communication protocol layer 409A. In some exemplary implementations the communication configuration (or “frame”) 401B includes a header portion/section 402B and a data/payload portion 403B. PDU 401C is a block diagram of exemplary frame at a first communication protocol layer 409B. In some exemplary implementations, the communication configuration (or “frame”) 401C includes a header portion/section 402C and a data/payload portion 403C.

Information is processed in accordance with each layer's requirements as the information “moves” from layer to layer in a communication protocol hierarchy. The processing often involves adding or deleting header information associated with a layer. Whether the header information is added or deleted typically depends on whether the overall direction is higher or lower in the communication protocol hierarchy. In some embodiments, header information associated with a lower level is added when a PDU from higher level moves to the lower level to create a “new” PDU at the lower level. In some embodiments, the higher layer PDU is considered a lower level Service Data Unit (SDU) encapsulated by (e.g., “wrapped inside, etc.) the lower level PDU. Payload section 403C includes SDU 404C (also known as PDU 401B from layer 409A) and is encapsulated with header section 402C to form “new” PDU 401C.

Whether or not communication information/signal includes reduced/no header information is relative to/depends on the perspective of a communication protocol layer. From the perspective of one communication protocol layer, if a communication/signal is missing some or substantially all header information then the communication/signal can be considered reduced header/headerless; while from the perspective of another communication protocol layer, the communication information can be considered to include header information or have a header. In some exemplary implementations, the payload section 403C comprising the SDU 404C (aka PDU 401B) is considered headerless even though SDU 404C includes header information in header section 402B from PDU 401B. In some embodiments, if the header section 402C is missing (e.g., not added to the information etc.) the communication signal is also considered headerless. In some embodiments, data/payload portion 403C includes communication configuration PPDU 401B (which in turn includes a header portion/section 402B and a data/payload portion 403B).

A reduced header information demodulation process in accordance with the preset disclosure operates on a payload portion of a PDU. In some exemplary implementations, the payload portion of the PDU is considered a “headerless” process from the perspective of the communication protocol layer associated with the PDU. In some exemplary implementations, a reduced header information demodulation process operates on information which is headerless from the perspective of the first communication protocol layer 409B (the information includes data payload section 303C information and not information from header section 402C). The payload information (e.g., 403C, etc.) is considered “headerless” from the perspective of a protocol layer (e.g., 409B, etc.) while the payload information includes “header” (e.g., 402B) information from another protocol layer.

It is appreciated that communication protocol layers can have multiple sublayers. The sublayers have different functionality and perform different operations associated with a respective communication protocol layer. FIG. 4C includes various exemplary organizations and configurations of information (also called “frames”) in PPDUs in accordance with some embodiments.

Communication configuration 410A is a block diagram of an exemplary frame in accordance with some embodiments. Communication configuration 410A is compatible with a physical protocol data unit (PDU) frame. Frame 410A includes a header portion/section 420A and a data/payload portion 430A. The header portion/section 420A and data/payload portion/section 430A comprises information organized in fields.

Communication configuration 410B is a block diagram of an exemplary frame in accordance with some embodiments. Frame 410B is compatible with a physical layer protocol data unit (PPDU). Frame 410B includes header portion/section 420B and data/payload portion/section 430B. In some embodiments, header portion/section 420B includes preamble field 421B and signal field 422B.

Frame 410C is a block diagram of an exemplary communication information organization and configuration (also called a “frame”) in accordance with some embodiments. Frame 410C is compatible with a physical layer protocol data unit (PPDU). Frame 410C includes header portion/section 420C and data/payload portion/section 430C. In some embodiments, data/payload portion/section 430C includes packet 430C and packet 450C. Packet 440C includes packet header portion/section 441C and packet data/payload portion/section 442C. Packet 450C includes packet header portion/section 451C and packet data/payload portion/section 452C.

Frame 410D is a block diagram of an exemplary communication information organization and configuration (also called a “frame”) in accordance with some embodiments. Frame 410D is compatible with a physical layer protocol data unit (PPDU). Frame 410D includes header portion/section 420D and data/payload portion/section 430D. In some embodiments, header section 420D includes preamble field 421D, and physical header 422D.

In some exemplary implementations, data/payload portion/section 430D includes physical layer service data unit (SDU) 440D (aka MPDU) and physical layer service data unit (SDU) 450D (aka MPDU). Physical layer service data unit (SDU) 440D includes MAC layer PDUs (MPDUs). MPDU 440D includes MAC header portion/section 441DD and MAC data/payload portion/section 442D. MPDU 450D includes MAC header portion/section 451DD and MAC data/payload portion/section 452D. In some embodiments, medium access control (MAC) layer protocol data unit (PDU) is the physical layer service data unit (SDU).

FIG. 4D includes an exemplary organization and configuration of information in accordance with some embodiments. Communication configuration or frame 410F is a block diagram of exemplary frame in accordance with some embodiments. Frame 410F is compatible with a frame configuration or physical layer protocol data unit (PPDU) configuration. Frame 410F includes header portion/section 420F and data/payload portion/section 430F. In some embodiments, header portion/section 420F includes preamble field 421F and signal field 422F. Data/payload portion/section 430F includes orthogonal frequency division multiplexing OFDM Symbols 441F, 442F through 448F. It is appreciated that the modulated form of the OFDM Symbols at a lower protocol level can include header information associated with higher level protocol levels. The OFDM Symbols are configured for communication in a communication protocol physical layer and some of the OFDM Symbols include header information from protocol layers (e.g., link layer, transport layer, etc.), even though from the physical layer perspective they are considered headerless payload data.

FIG. 4E is a block diagram of different exemplary signal physical layer protocol data unit (PPDU) organizations/configurations (also called “frames”) per the IEEE 802.11 family of wireless network protocols/standards in accordance with some embodiments. The PPDUs include respective physical layer header portions and physical layer data portions. The header portions comprise various training fields that include reference training symbol and signal fields (SIG) include rate, length, and parity information. It is appreciated size of the header portions grow significantly as new communication protocol organizations/configurations of the IEEE 802.11 family change (e.g., when new versions are released, etc.).

PPDU configuration 451 complies with the IEEE 802.11a/g communication protocol and the header includes a legacy short training field (L-STF), legacy long training field (L-LTF), and legacy-signal field (L-SIG). PPDU configuration 452 on the other hand complies with the IEEE 802.11n high throughput (HT) communication protocol and the header includes a legacy short training field (L-STF), legacy long training field (L-LTF), legacy-signal field (L-SIG), high throughput signal field (SIG), high throughput short training field (STF), and 1 to 4 high throughput long training fields (HT LTFs). PPDU configuration 453 complies with the IEEE 802.11ac very high throughput (VHT) communication protocol and the header includes a legacy short training field (L-STF), legacy long training field (L-LTF), legacy-signal field (L-SIG), very high throughput signal field-A (SIG-A), very high throughput short training field (STF), 1 to 8 very high throughput long training fields (VHT LTFs), and very high throughput signal field-B (SIG-B).

Additionally, PPDU configuration 454 complies with the IEEE 802.11ax high efficiency (HE) communication protocol and the header includes a legacy short training field (L-STF), legacy long training field (L-LTF), legacy-signal field (L-SIG), repeated Non-HT Signal Field (RL-SIG), high efficiency signal field-A (SIG-A), high efficiency short training field (STF), 1 to 8 high efficiency long training fields (VHT LTFs). PPDU configuration 455 lastly complies with the IEEE 802.11be (HET) and is an extremely high throughput communication protocol and the header includes a legacy short training field (L-STF), a legacy long training field (L-LTF), a legacy-signal field (L-SIG), a repeated legacy Signal Field (RL-SIG), a universal signal field (U-SIG), a high efficiency signal field (EHT-SIG), a high efficiency short training field (EHT-STF), and high efficiency long training fields (EHT-LFTs). The EHT-LFT symbol duration depends on the GI+LFT size.

In some embodiments, the reduced header information demodulation testing systems and methods in accordance with the present disclosure are compatible with subcarrier communication approaches. In some exemplary implementations, the subcarrier communication approaches include a plurality of tones organized in communication channels. The tones may be organized and configured in accordance with am IEEE 802.11 wireless network protocol/standard.

There are at least two aspects of changing communication protocol standards that pose significant challenges for testing operations. The first aspect is the header portions and corresponding header information grow with new protocol standards meaning more information is required to sample and capture during testing. The second aspect is the bandwidths become larger thereby resulting in increased sampling rates. In some exemplary implementations, a DUT needed 400 samples to test an OFDM 802.11a compliant signal and between 15360 to 24320 samples to test an OFDM 802.11be compliant signal. As previously indicated, many communication DUTs have limited resources (e.g., memory, scan test cells, etc.) for testing operations and the increased information (e.g., associated with sampling captures, etc.) required for testing overstresses the limited resources. The limited resources become full with information regarding the header portion and therefore cannot handle appropriate testing of the payload portion. Reduced header information demodulation testing systems and methods in accordance with the present disclosure overcome these issues and advantageously enable appropriate testing of the payload portion. There is also less stress on memories of DUTs and ATE systems to store information associated with waveforms (e.g., AWG component output, etc.).

It is appreciated that different power levels can be assigned to different RU and RUs can be assigned across various carrier bandwidths. There are more tones/subcarriers in a layer than tones assigned to user data communication. Some tones/subcarriers can be utilized for control operations (e.g., pilot, guard/null spacing, etc.). It is appreciated the RUs and tones can be organized and configured in accordance with an IEEE 802.11 wireless network protocol/standard.

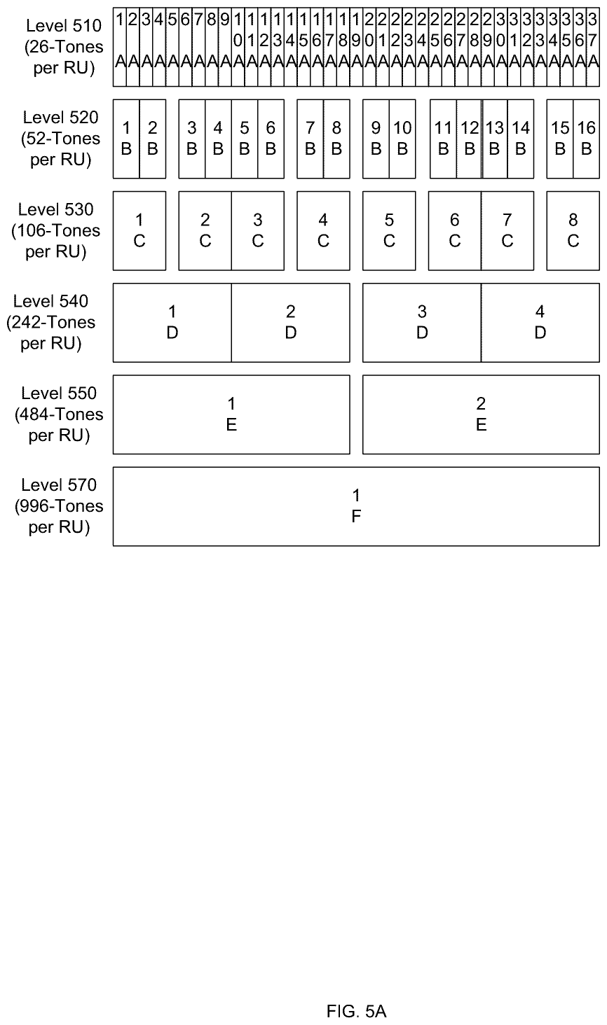

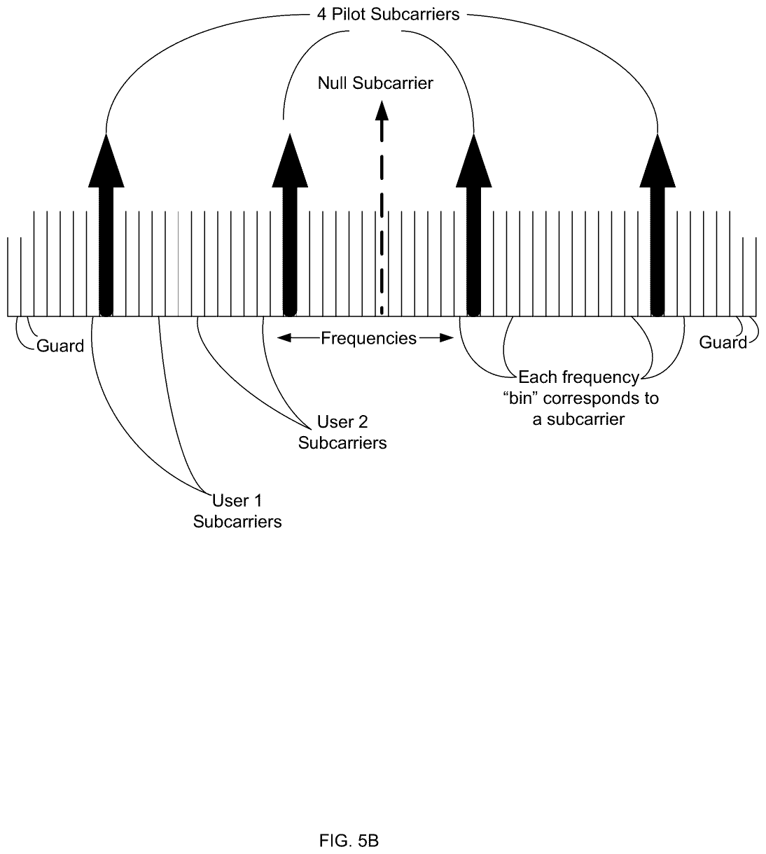

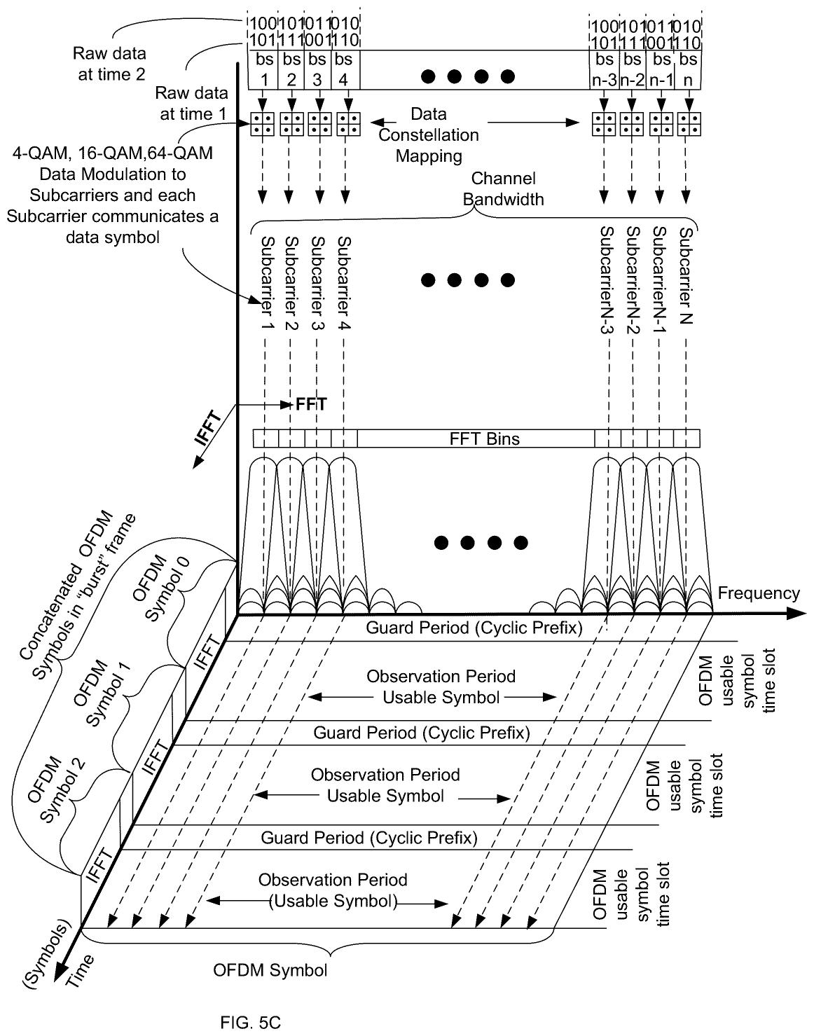

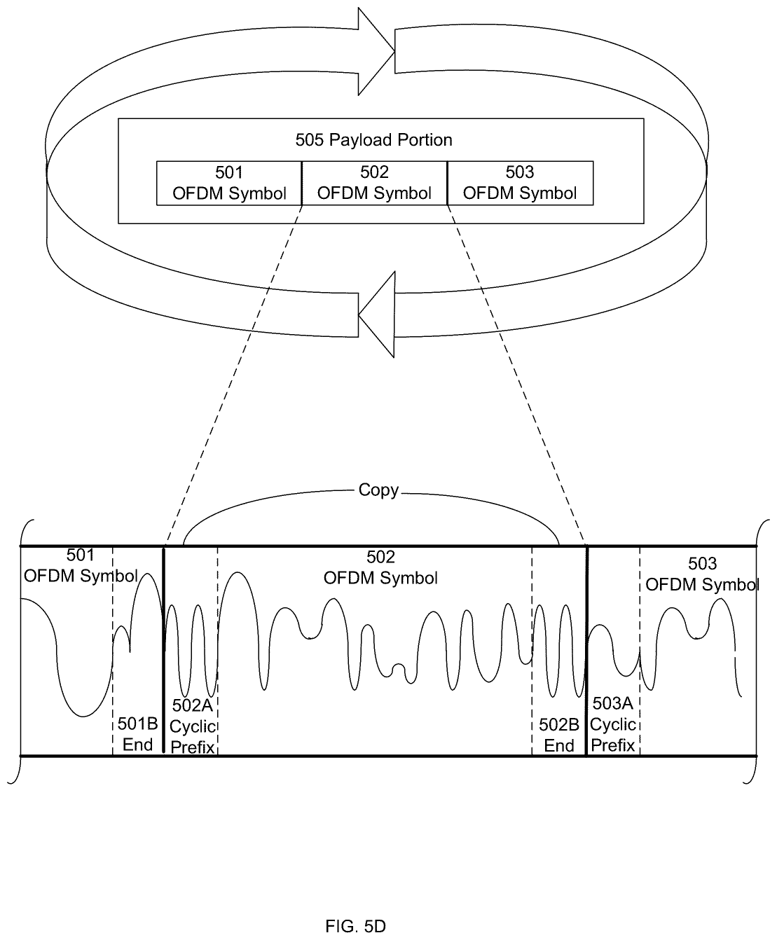

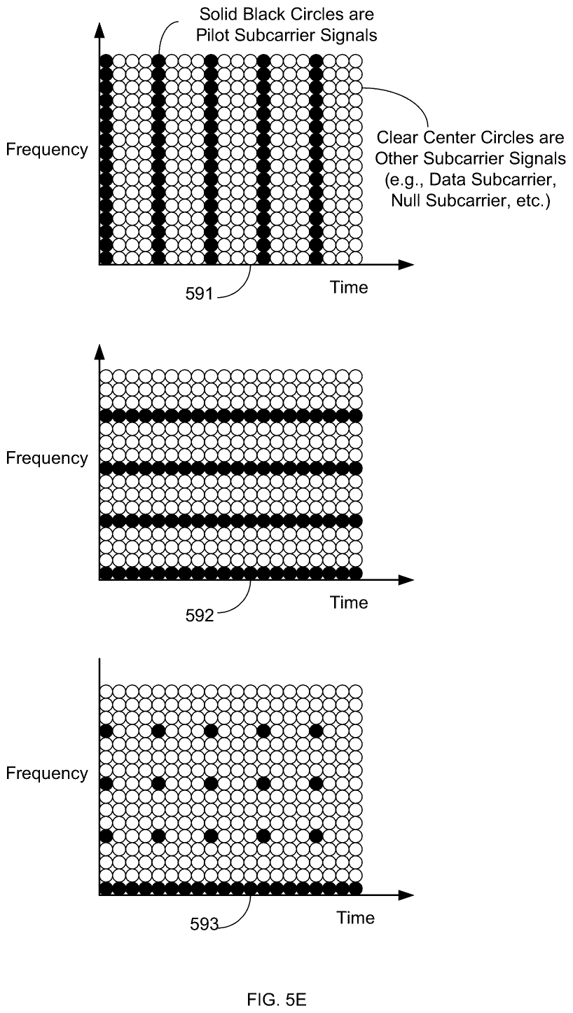

FIG. 5A is a block diagram of an exemplary signal configuration in accordance with some embodiments. The tones are arranged in different levels based upon the number of tones included in a resource unit (RU). In some exemplary implementations, a resource unit is used to denote a group of subcarriers (e.g., tones, etc.) used in communications (e.g., downlink transmission, uplink transmissions, etc.). For instance, the Level 510 includes 37 RUs (1A through 37A) in which each RU comprises 26 tones, level 520 includes 16 RUs (1B through 16B) in which each RU comprises 52 tones, level 530 includes 8 RUs (1C through 8C) in which each RU comprises 106 tones, level 540 includes 4 RUs (1D through 4D) in which each RU comprises 242 tones, level 550 includes 2 RUs (1E and 2E) in which each RU comprises 484 tones, and level 570 includes 1 RU (1F) comprising 996 tones.

In some embodiments, the subcarriers are associated with a frequency bandwidth or range. The frequency bandwidth is defined by a communication protocol, (e.g., an IEEE 802.11 wireless network protocol/standard, etc.). In other embodiments, the reference signals are associated with predetermined defined characteristics that are known. The respective received reference signal characteristics are determined and compared to corresponding predetermined defined characteristics.

FIG. 5B is a block diagram of an exemplary frequency spectrum of subcarriers and corresponding bins in accordance with embodiments of the present disclosure. Each frequency bin corresponds to a subcarrier. User subcarriers and corresponding bins are distributed throughout the spectrum (e.g., user 1 subcarriers, user 2 subcarriers, etc.). The block diagram also indicates subcarriers' locations/spacing for reference tones/signals (e.g., pilot tones, etc.) in accordance with some embodiments. In between the pilot bins, there are data bins. At both ends of the spectrum, there are subcarriers/bins that act as guard subcarriers (e.g., to help mitigate interference from other spectrums. In some exemplary implementations, there is a non-pilot tone null subcarrier bin at the center carrier frequency value.

FIG. 5C is a graphical block diagram of an exemplary transmission of OFDM symbol tones/signals in accordance with embodiments of the present disclosure. The transmission includes OFDM symbols 0, 1, and 2 concatenated in a “burst” frame sequence over the time domain. One OFDM Burst includes OFDM Symbols. An OFDM symbol includes data bit streams 1 through n assigned to subcarriers 1 through N bins respectively. One modulated subcarrier equals one point in frequency and time. An IFFT creates an OFDM waveform from the OFDM Subcarriers. One OFDM symbol includes an IFFT OFDM Waveform plus a Guard Interval.

The novel presented approaches enable determination of the start of each OFDM symbols 0, 1, and 2 based on information in the OFDM symbols in payload portion of the “burst” frame without relying on information from a header portion of a “burst” frame. It is appreciated novel approaches described herein are compatible with implementation in a variety of communication protocols (e.g., OFDM protocols, OFDMA protocols, etc.).

FIG. 5D is a block diagram of an exemplary OFDM symbol payload portion transmission with reduced header information in accordance with embodiments of the present disclosure. As indicated previously, header information (e.g., preamble information, reference information, etc.) is often used to correct (e.g., equalize, etc.) issues with a communication. OFDM symbol payload portion transmission 505 includes OFDM symbols 501, 502, and 503. OFDM symbols 501, 502, and 503 are configured in a looping pattern. In some embodiments, the payload data is configured without preamble training. For example, the start of OFDM symbol 501 loops around to the end of OFDM symbol 503 reference symbols. The pattern is considered continuous (e.g., has no beginning and no end, etc.). OFDM symbol 502 includes cyclic prefix portion 502A at the start of OFDM symbol 502 and end portion 502B. Cyclic prefix portion 502A is a copy of end portion 502B. OFDM symbol 501 includes a cyclic prefix portion and end portion 501B. OFDM symbol 503 includes a cyclic prefix portion 503A at the start of OFDM symbol 503 and an end portion.

FIG. 5E is a block diagram of various exemplary subcarrier configuration assignments in accordance with embodiments of the present disclosure. The dot or circles represent various subcarriers within a communication bandwidth. The solid dark colored circles represent pilot subcarrier signals and the clear center circles represent other subcarrier signals (e.g., data subcarriers, null subcarriers, etc.). The Y axis corresponds to frequency values of various subcarriers and the X axis represents transmission of the subcarriers over time. Different pilot subcarrier configurations (e.g., block, comb, scattered, etc.) can be implemented to address different conditions or concerns. While pilot signals provide valuable information regarding a DUT's performance, designating all subcarriers all the time as pilots does not allow communication of other data. Thus, configuration of pilot subcarriers is often a balancing tradeoff between different objectives. In configuration 591, all subcarriers in a bandwidth are utilized as pilot subcarriers at intermittent times and provide indications of all subchannel conditions. In configuration 592, intermittent subcarriers in a bandwidth are utilized as pilot subcarriers that continuously provide indications of subchannel conditions for those subcarriers. In configuration 593, one pilot subcarrier information is continuously transmitted and other pilot subcarrier information is intermittent with respect to frequency and time. A pilot subcarrier signal is a reference signal that has characteristics (e.g., BPSK modulation, etc.) resistant to misinterpretation due to communication conditions (e.g., channel conditions, equipment oscillation differences, etc.).

The various subcarrier configurations are predetermined (e.g., known by an ATE, etc.). The subcarrier configuration protocols can be publicly known (e.g., in accordance with published industry standards, IEEE 802-11 family of protocols, etc.) or privately known (e.g., private interpretation of industry standard, confidential configuration, trade secret, etc.). The subcarrier configuration information can be accessed by an ATE and utilized to perform various novel reduced header systems and methods presented in other portions of this description. In some embodiments, the subcarrier configurations are utilized to extract information (e.g., related to timing, frequency error, ideal values, equalizers, etc.) from payload portions of a communication. In some exemplary implementations, the information is extracted from complicated payload portions without relying on the availability of header information.

The intention is to accurately transmit the information in the original data stream. In some embodiments, exemplary data streams are illustrated in FIG. 5C. In the process of being communicated, the data is modulated in accordance with several constellation maps. Errors or deviations from the ideal values in the respective constellation maps are often associated with communication issues (.e.g., inadequate channel features, frequency response characteristics, scatter, fading, power loss with distance, etc.).

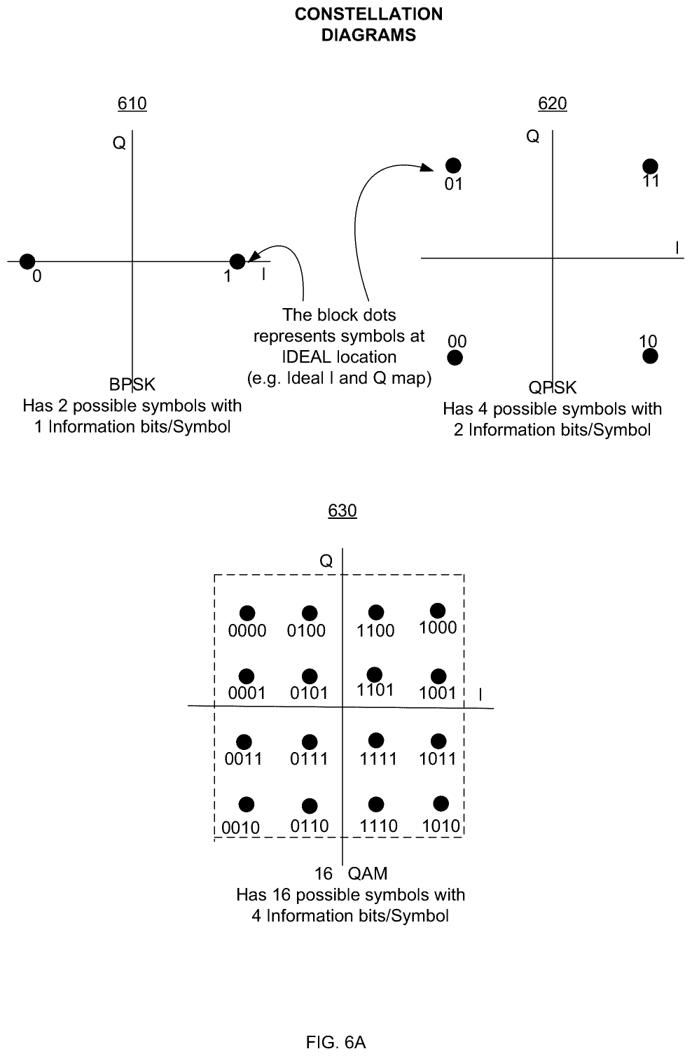

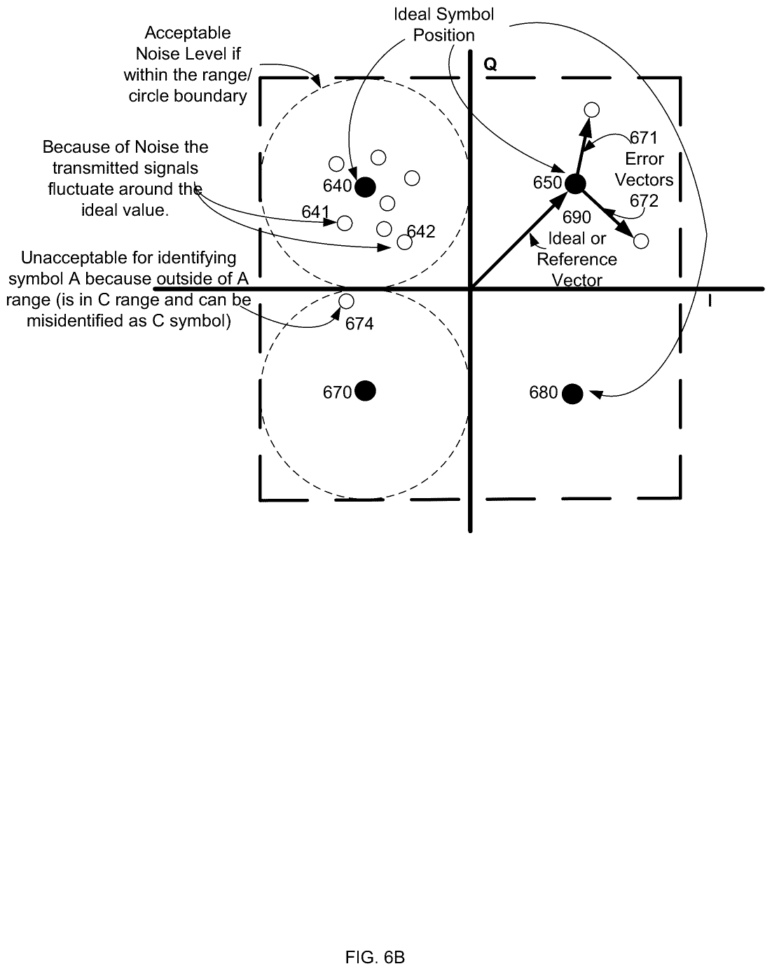

FIG. 6A is a block diagram of several exemplary constellation maps associated with signal communications in accordance with embodiments of the present disclosure. The block dots represent symbols at IDEAL locations (e.g. Ideal I and Q map). Constellation map 610 is a BPSK map that has 2 possible symbols with 1 Information bits/symbol. Constellation map 620 is a QPSK map that has 4 possible symbols with 2 Information bits/symbol. Constellation map 630 is a 16 QAM map that has 16 possible symbols with 4 Information bits/symbol. It is appreciated there can be various other QAM configurations (e.g., 64 QAM, 256 QAM, 1024 QAM, etc.).

FIG. 6B is a block diagram of several exemplary constellation map errors associated with signal communications in accordance with some embodiments. The constellation map includes ideal symbol locations shown as solid black dots (e.g., 640, 650, 670, 680, etc.) and locations of symbols associated with transmitted signals shown as hollow dots (e.g., 641, 642, 674, etc.). The constellation map shows ideal or reference vector 690 and effort vectors 671 and 672.

FIG. 7 is a flow chart of an exemplary testing mode selection process 700 in accordance with embodiments of the present disclosure. Testing mode selection process 700 provides flexible and adaptable selection between testing modes (e.g., a header included mode, a reduced header training mode, a reduced header mode; etc.). Testing mode selection process 700 enables an ATE to execute various testing scenarios with different testing characteristics and capabilities. In some embodiments, the selection enables “backward” compatibility with legacy testing approaches and also enables implementation of novel testing approaches described herein that would otherwise be impractical or impossible in legacy testing approaches.

In block 710, a selection trigger is received. The selection trigger can be based upon the communication protocol, or the overall testing approach, and so on. There may be a desire to do some testing of a DUT with a signal with a full header and then with another signal with a reduced header. There may be a desire to get a statistical sampling of a DUTs full header processing capability and then use a reduced header to increase overall throughput. For example, first test if the header information portion is properly process/stored in limited chip memory and then a second “run” to see if the payload is processed/stored correctly.

In block 720, a testing mode is determined based upon the received trigger information. Capabilities of different available testing modes are considered in responding to the selection trigger at 720. In some embodiments, a selection trigger may indicate that a first DUT does not include sufficient memory to handle testing of communication bursts with larger header information. In some embodiments, when a DUT fails a first test run, the failure indication serves as a trigger to perform a second test run using a different testing mode.

In block 730, a reduced header mode testing process is selected. In some embodiments, a DUT does not include sufficient resources (e.g., memory, etc.) to efficiently perform demodulation testing. When a communication protocol specifies relatively large header information beyond the capability of the DUT to adequately respond to testing scenarios, a reduced header mode testing process can be selected at 730 to overcome issues associated with large amounts of header information.

In block 740, a reduced header with reference signal mode testing process is selected. In some embodiments, a reduced header with reference signal mode testing process is selected as a secondary test. In some exemplary implementations, a reduced header mode testing process is selected for a first test run on a DUT and a reduced reader with reference signal mode testing for a second test run. Performing a second test run using a different test mode may identify some anomalies not caught by the first test run. The anomalies may be due to a testing characteristic of the first test mode that the second test mode is not likely to be impacted by.

In block 750, a header mode testing process is selected. In some embodiments, header mode testing process may produce more reliable results for particular complicated test scenarios. In testing scenarios calling for very high QAM demodulation, the results of the header mode testing process may be more reliable than a reduced header mode testing process and a reduced header with reference signal mode testing process. A reduced header mode testing process 800 is included in a demodulation determination process (e.g., similar to block 320, etc.).

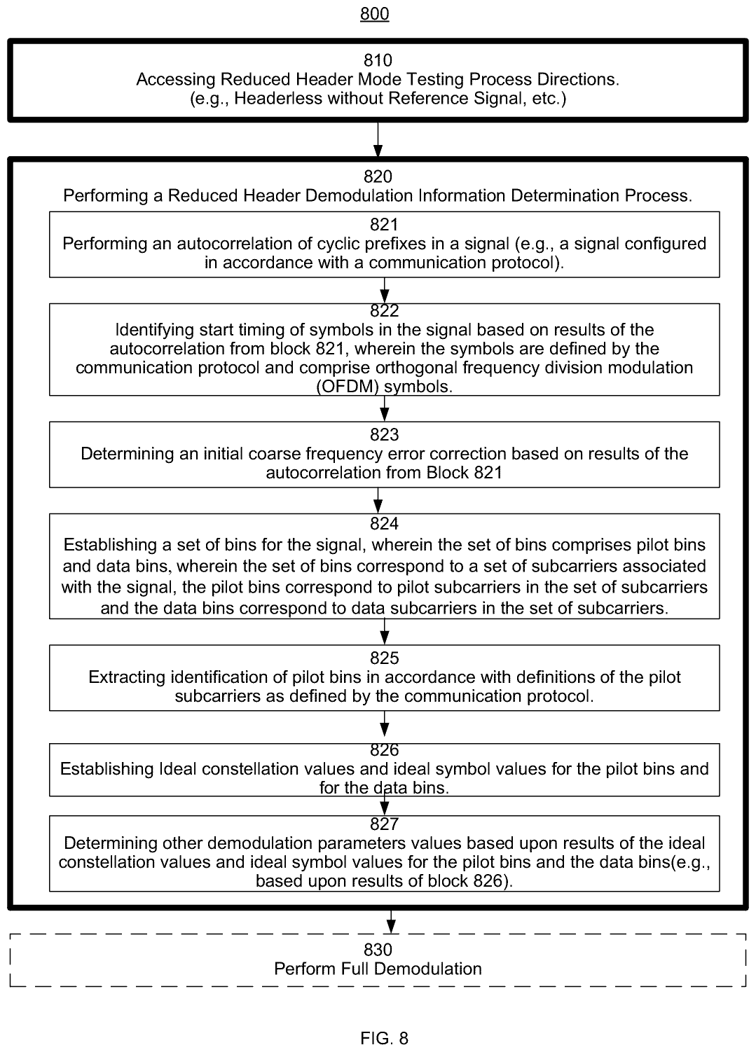

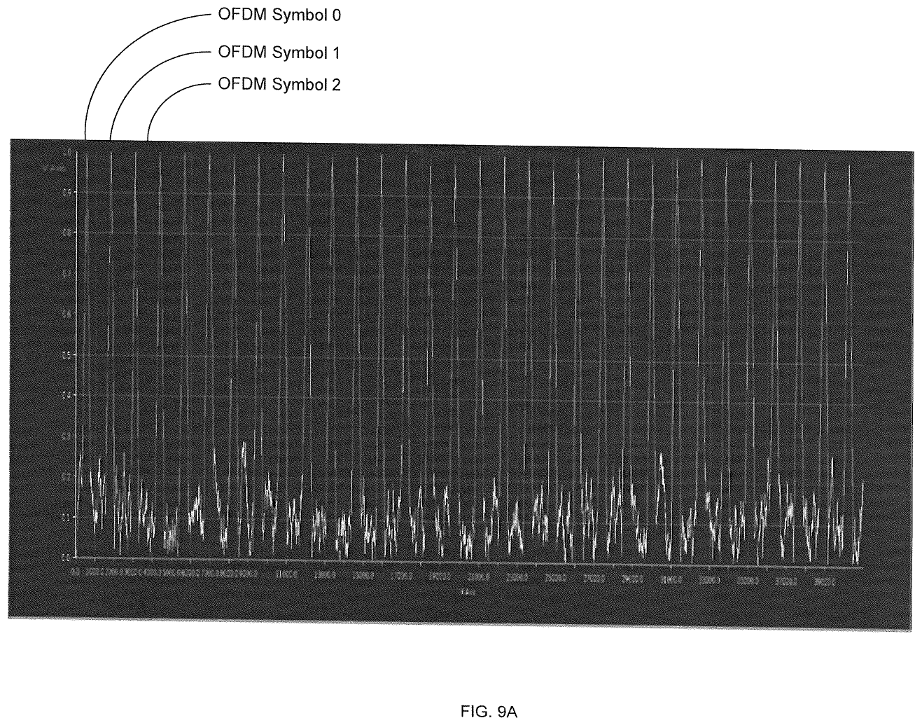

FIG. 8 is a block diagram of an exemplary reduced header mode testing process 800 in accordance with embodiments of the present disclosure. Reduced header mode testing process 800 is included in some embodiments a reduced header communication signal processing test method. The reduced header mode testing process is utilized when reference signal information is reduced/not available. In some exemplary implementations, there is no reference signal to compare a capture against (e.g., to determine/calculate impairments with, etc.). The reduced header mode testing process is utilized when a receiving component (e.g., DUT, etc.) has reduced information about a received signal (e.g., reduced modulation related information, header information, preamble information, signal configuration information, etc.). In some exemplary implementations, the reduced header (information) does not include various fields of information (e.g., short training field, long training field, a Synchronization (Sync) field, header field, signal field, service field, modulation selection bit/field, rate field, etc.). In other exemplary implementations, a portion of the fields are included in the reduced header (information). The received information is less than would otherwise be available in a normal field/non-test situation.

In block 810, reduced header mode testing process directions are accessed (e.g., Headerless without Reference Signal, etc.). In some exemplary implementations, reduced header mode testing process directions are based upon a selection of a reduced header mode testing process (e.g., similar to a selection in block 710, etc.). The selection may be made based on various conditions (e.g., a DUT does not have sufficient resources to handle testing of communications with full header information, it is desirable to have smaller test patterns directed to testing of payloads with reduced header information, it is desirable to have multiple testing runs with different test characteristics, etc.).

In block 820, a reduced header demodulation information determination process is performed. In some embodiments, a reduced header demodulation information determination process determines information to be utilized in testing modulation/demodulation operations (e.g., signal processing operations, etc.). In some exemplary implementations, a reduced header demodulation information determination process includes blocks 821, 822, 823, 824, 825, and 826.

In block 821, an autocorrelation of cyclic prefixes in a signal is performed. In some embodiments the signal is a looping signal (e.g. similar to the signal in FIG. 5D, etc.) The signal is configured in accordance with a communication protocol). In some exemplary implementations, the communication protocol corresponds to a communication protocol standard in the family of IEEE802.11 wireless network protocols/standards. In some embodiments, a peak search function is performed on the results of the auto-correlation.

In block 822, a start timing of symbols in the signal is identified based on results of the autocorrelation from block 821, where the symbols are defined by the communication protocol. The symbols can comprise orthogonal frequency division modulation (OFDM) symbols. In some exemplary implementations, the start and end location/timing of a symbol with respect to one another is identified (e.g., where an OFDM symbol starts and ends with respect to the start and end of other OFDM symbols, etc.).

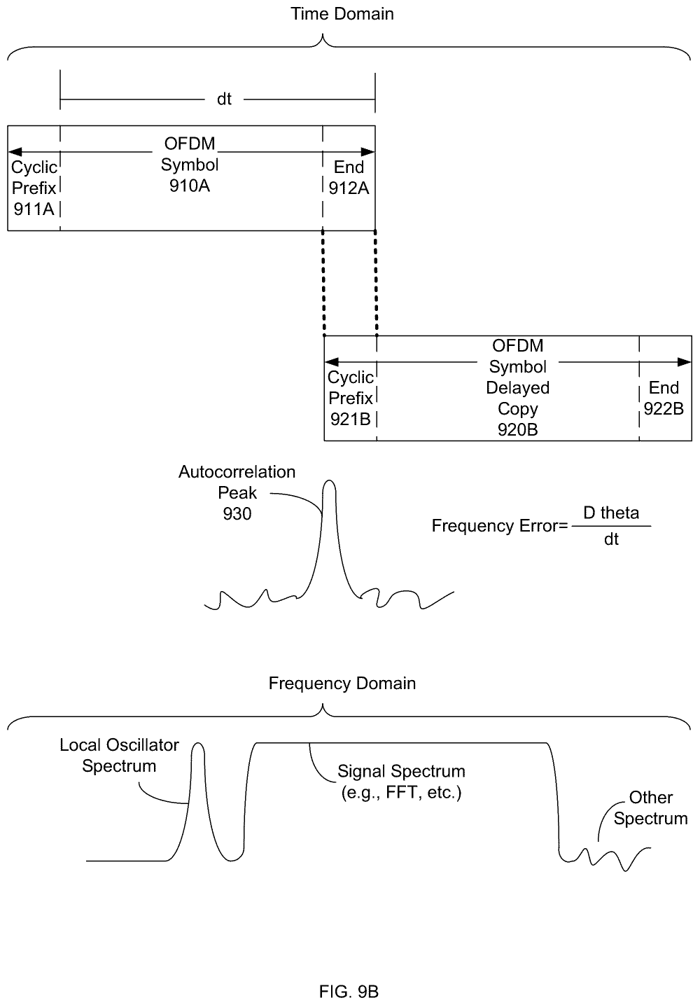

In block 823, an initial coarse frequency error correction is determined based on results of the autocorrelation from block 821. Differences in phase and coarse frequency errors can also be determined from analysis of the peaks in the autocorrelation result. In some embodiments, differences in peak locations from expected peak locations can indicate a phase difference and corresponding frequency errors. In some exemplary implementations, the initial coarse frequency error correction is determined by processes explained with reference to FIGS. 9A and 9B. As explained in other portions of this description, the initial coarse frequency error correction can be an average of respective individual frequency error corrections.

In block 824, a set of bins for the signal is established, where the set of bins comprises pilot bins and data bins. The set of bins corresponds to a set of subcarriers associated with the signal, where the pilot bins correspond to pilot subcarriers in the set of subcarriers and the data bins correspond to data subcarriers in the set of subcarriers. In some exemplary implementations, a Fast Fourier Transform (FFT) operation is performed on a portion of the signal associated with an OFDM symbol and the results are utilized to establish the set of bins.

In block 825, an identification of pilot bins is extracted in accordance with definitions of the pilot subcarriers as defined by the communication protocol. In some embodiments, identification of the pilot bins includes identifying locations of pilot bins with respect to one another and also other bins in the set of bins. It is appreciated that identification of and definition of subcarrier (e.g., pilot subcarriers, data subcarrier, null subcarriers, etc.) configurations and locations with respect to one another can vary (e.g., as presented in description of FIGS. 5A through 5E, explanation in other portions of this description, etc.).

In block 826, ideal constellation values and ideal symbol values are established for the pilot bins and for the data bins. In some embodiments, an interpolation is used to establish ideal constellation values and ideal symbol for data bins. It is appreciated various types of interpolation (e.g., straight line, least squares, iterative update/redetermination, etc.) are compatible with and readily implemented in Reduced Header Mode Testing Process 800. Additional descriptions of interpolation process operations are presented in other portions of this specification (e.g. description of process 1200A, 1200B, etc.).

In block 827, other demodulation parameters values are determined based upon results of the ideal constellation values and ideal symbol values for the pilot bins and the data bins (e.g., based upon results of block 826, etc.). In some embodiments, an equalizer value from a first bin is initially applied to a second bin and subsequently updated based on results of block 826. In some exemplary implementations, the first bin and second bin are adjacent or next to one another. The configuration of the first bin and the second bin with respect to one another's proximity may be defined by a communication protocol (e.g., industry standard, IEEE 802.11 family of communication protocols, etc.).

In some embodiments, after the reduced header demodulation information determination process from block 820 is performed the operations proceed to block 830 and an exemplary full demodulation is performed. The full demodulation is similar to block 330. In some embodiments, full demodulation is similar to some aspects of conventional demodulation analysis. After information from block 820 is available, the process can proceed with full demodulation determining information similar to conventional information that would otherwise not traditionally have otherwise been available from reduced header signals.

FIG. 9A is a block diagram of exemplary autocorrelation graph results in accordance with some embodiments. In some exemplary implementations, the autocorrelation is directed to cyclic prefixes in an OFDM symbol (e.g., similar to those shown in FIG. 5D, etc.). The peaks in the graph are the locations of the resulting auto-correlation of a signal with a cyclic prefix included and a delayed version of the signal. The Y axis is normalized correlation (unitless) in increments of 0.1 and the X axis is samples (unitless) in increments of 1000 samples per grid width.

In some exemplary implementations, a reduced header demodulation information determination process (e.g., similar to block 820) is performed. Autocorrelation is performed on a looping signal producing peak indications at locations of OFDM symbols in the signal (e.g., results similar to those in FIG. 9A, 9B, etc.). The autocorrelation provides timing related information and coarse frequency error information. Timing of concatenation boundaries of OFDM symbols within the looping signal are determined based on the peaks in the autocorrelation results. Portions of the signal associated with different OFDM symbols are identified (e.g., start and end of the OFDM symbols, etc.) based on a peak search of the autocorrelation results. The start and end of the OFDM symbols is similar to the start and end of OFDM symbols 0, 1, and 2 in FIG. 5C. Differences in phase and coarse frequency errors can also be determined from analysis of the peaks in the autocorrelation result.

FIG. 9B is a block diagram of exemplary auto-correlation process in accordance with embodiments of the present disclosure. OFDM symbol 910A includes cyclic prefix 911A and corresponding end portion 912A. Copy OFDM symbol 920B includes cyclic prefix 921B and corresponding end portion 922B. Copy OFDM symbol 920B is a copy of OFDM symbol 910A. The copy of OFDM symbol 920B is shifted in the time domain by an amount of time corresponding to the Fast Fourier Transform or FFT size, etc.). As the autocorrelation is performed during the shift an autocorrelation peak 930 is detected when the cyclic prefix 921B lines up with end portion 912A in the time domain. The autocorrelation peak 930 has both amplitude and phase. When there is no coarse frequency error the phase is zero. When there is a non-zero phase there is a coarse frequency error. The coarse frequency error is defined as the D theta divided by dt, where D theta is equal to the phase and dt is the amount of time from the beginning of the OFDM symbol to the end of the OFDM symbol (without counting the cyclic prefix).

The lower portion of FIG. 9B includes a block diagram of frequency domain spectrums including the local oscillator spectrum, signal spectrum, and other spectrum (e.g., due to other components that introduce frequency response, digitizer, other out of band spectrum, etc.). In some exemplary implementations the local oscillator is there and in other exemplary implementation the local oscillator may not be there or may be somewhere else. In some embodiments, the coarse frequency error correction can get the response close to the true frequency error. In some exemplary implementations, the coarse frequency error correction avoids substantial EVM increase (e.g., below EVM associated with some residual frequency error if spectrum is not clean, etc.). The timing information associated with the OFDM symbols and the coarse frequency error correction enables later reliable extraction of ideal symbols. Extracting the ideal symbol values and retrieving the capture values provides information for the frequency domain analysis (e.g., after an FFT, etc.) explained in other portions of this description. The equalizer values explained in other portions of this description (e.g., in process 1200A, 1200B

With reference to both FIGS. 9A and 9B,in some embodiments, the coarse frequency error for the respective individual peaks in FIG. 9A (e.g., corresponding to peaks if OFDM symbol 0, OFDM symbol 1, OFDM symbol 2, etc.) are determined similar to the error frequency determination for OFDM symbol 910A. The resulting respective individual frequency errors are averaged for multiple peaks (e.g., the peaks in FIG. 9A). In some embodiments, the resulting respective individual frequency errors are averaged for multiple peaks in a payload portion of a burst or frame. An average frequency error correction is determined based on the average frequency error value. The average frequency error correction is applied to a waveform (e.g., payload portion of a burst or frame, etc.).

A FFT operation is performed on the respective portions of the signal associated with OFDM symbols 0, 1, and 2 producing respective channel bandwidth subcarriers (e.g., similar to subcarriers bins 1 through subcarrier N in FIG. 5C, etc.). While the values of the subcarriers in the respective bins may vary over time (e.g., with different OFDM symbols, etc.) the respective locations of the bins in the bandwidth are defined by a communication protocol and remain fixed. Since the location of pilot bins is set by the communication protocol, subcarriers associated with respective pilot bins are readily identified. The communication protocol also specifies BPSK modulation is used for the pilot subcarriers and a BPSK analysis explained in other portions of this description is used to determine ideal values for pilot subcarriers in the respective pilot bins.

Ideal constellation values and ideal symbol values are established for the pilot bins and for the data bins (e.g., in block 826, etc.) and this includes determining equalizer values. In some exemplary implementations, equalizers are established for the pilot subcarriers and data subcarriers associated with respective pilot bins and data bins.

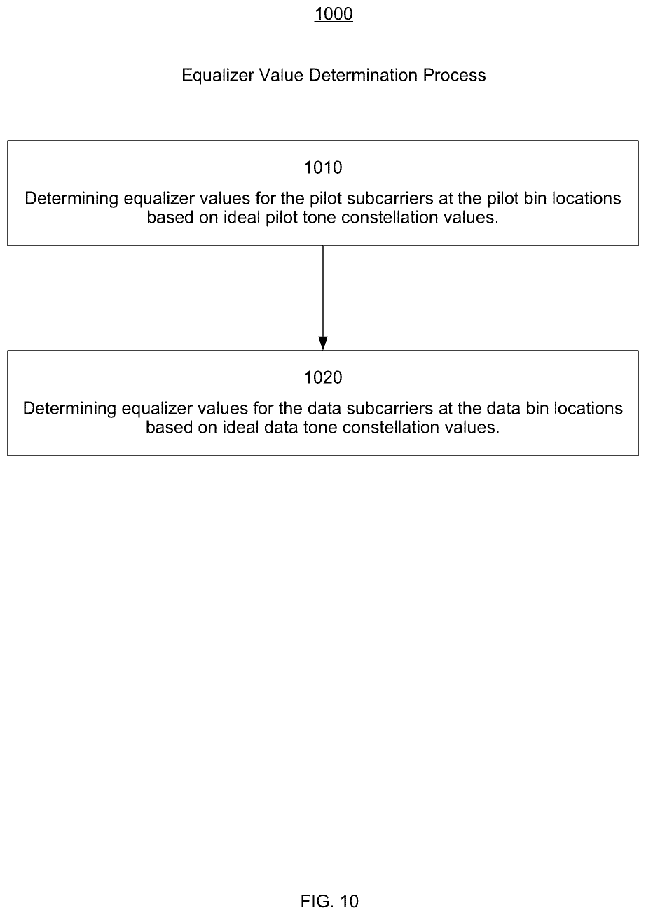

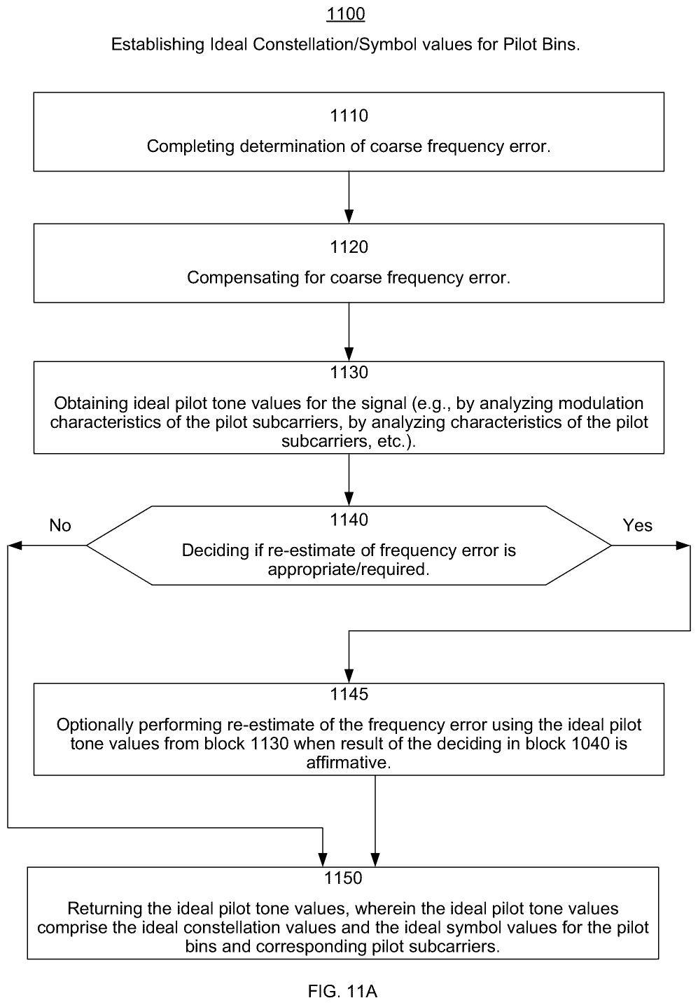

FIG. 10 is a flow chart of an exemplary equalizer value determination process 1000 in accordance with embodiments of the present disclosure. In some embodiments, the equalizer values are obtained from results of analyzing frequency responses in pilot bins and data bins. The equalizer values (e.g., for the pilot bins, for the data bins, etc.) are inverses of respective frequency response values. In some embodiments, this is for OFDM symbols available in the capture and then averaged. It is appreciated that equalizer value determination and interpolation processes described herein are applicable to both magnitude correction and phase correction. Interpolation process 1000 is included in some embodiments of a reduced header mode testing process (e.g., process 800, etc.).

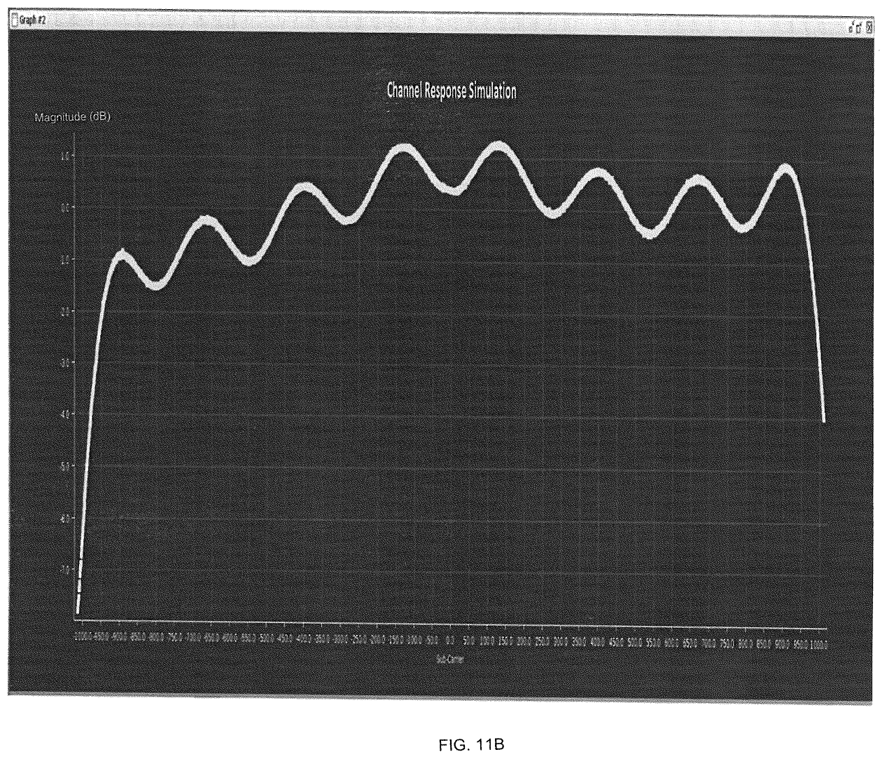

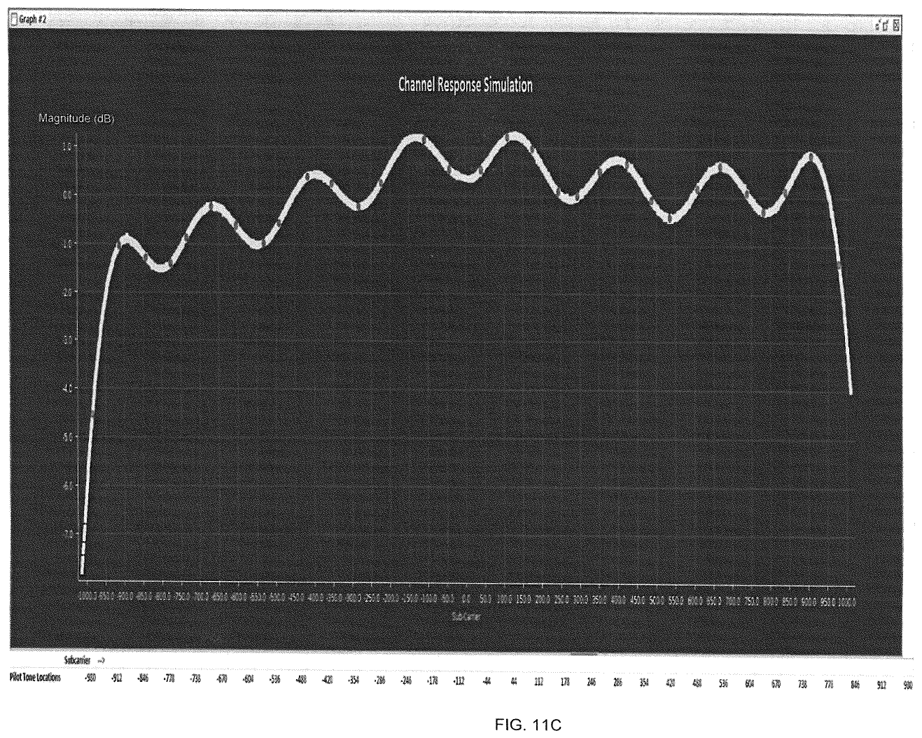

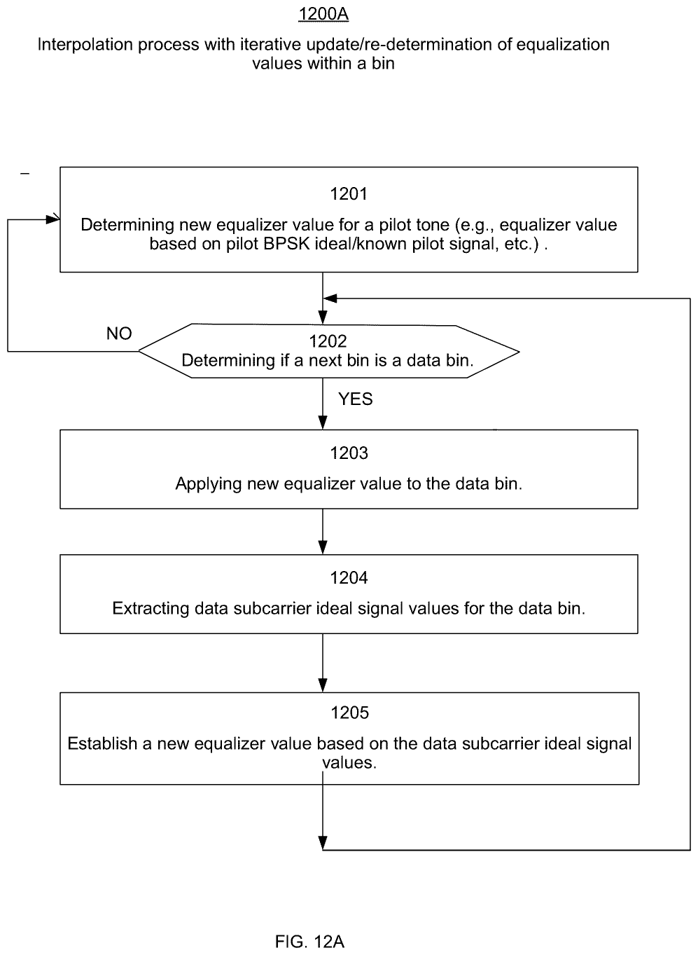

In block 1010, equalizer values are determined for the pilot subcarriers at the pilot bin locations based on ideal pilot tone constellation values. In some embodiments, a frequency response is based on a difference between ideal pilot tone constellation values and received/captured pilot tone values. Additional descriptions of the determining equalization values are presented in other portions of this specification (e.g. description of process 1100 shown in FIG. 11, etc.).

In block 1020, equalizer values are determined for the data subcarriers at the data bin locations based on ideal data tone constellation values. Determining equalizer values at the data bin locations is based on equalizer value results of the determining equalizer values step at the pilot bin locations. In some exemplary implementations, the equalizer values determined for the data subcarriers at the data bin locations are based on interpolation between the equalizer values from block 1010 for the pilot subcarriers at the pilot bin locations.

In some embodiments, establishing ideal constellation values and ideal symbol values for the pilot bins (e.g., in block 826, etc.) includes performing an ideal pilot tone determination process. The ideal pilot tone determination process establishes ideal constellation values and ideal symbol values for the pilot bins. Other processes (e.g., interpolation, etc.) are used to establish ideal constellation values and ideal symbol values for the data bins.

FIG. 11A is a flow chart of an exemplary ideal pilot tone determination process 1100 in accordance with embodiments of the present disclosure. In some exemplary implementations, ideal pilot tone values are obtained for ideal pilot tone constellation points and ideal symbols. In block 1110, a determination of coarse frequency error is completed. In some embodiments, results of an autocorrelation peak search function process are utilized in determining a coarse frequency error. The compensation value is the difference between an expected frequency of the pilot bin as defined by a communication protocol standard and the received or capture frequency of the pilot bin.

In block 1120, a coarse frequency error is compensated for. In some embodiments, compensating for the coarse frequency error includes adjusting a captured pilot bin subcarrier signal value by a compensation value. The compensation value is equal in magnitude and the negative of the coarse error value. For example, if a captured pilot bin subcarrier signal is 2.4499 GHz with a frequency error of 100 kHz below the expected value, then the compensation is to. add 100 kHz to 2.4499 GHz for a value of 2.45 GHz. If a captured pilot bin subcarrier signal is 2.4501 GHz with a frequency error 100 kHz above the expected value, then the compensation is to subtract 100 kHz from2.4501 GHz for a value of 2.45 GHz.

In block 1130, pilot tone values for the signal are obtained. In some embodiments, the pilot tones are modulated in accordance with a Binary Phase-Shift Keying BPSK protocol. In some exemplary implementations, pilot tones are relatively immune to noise. BPSK signals are more immune to noise due to the low constellation density in the IQ plane. A small amount of noise can cause a symbol error in a 1024-QAM constellation type, for example, whereas this same amount of noise will not cause a symbol error in a BPSK constellation plain. There is an increasing inverse exponential relationship between logarithmic bit error rate values and signal noise ratio decibels values. The probability of errors looking at different constellation types versus signal not noise ratio (BPSK probability of error is the same as QPSK) increases as the QAM values increase. In some exemplary implementations, to have a symbol error rate of 10e-6 for a BPSK/QPSK signal, an SNR of about 13 dB is required, whereas to achieve the same thing for a 256QAM signal, for example, an SNR of about 28 dB must be achieved.

In block 1140, a decision is made if re-estimate of frequency error is appropriate/required and if so, estimation of the fine tune frequency error is performed in block 1145 is performed, otherwise block 1150 is performed. If user selects “LowSNR” for the FrequencyEstimationMethod, then the process moves to block 1145. If “HighSNR” is selected for the “FrequencyEstimationMethod” then the process skips to block 1050.

In block 1145, a re-estimate process of the frequency error using the ideal pilot tone and/or data bin values from block 1130 is optionally performed when a result of the deciding in block 1040 is affirmative. In some embodiments, the re-estimation provides a more accurate frequency error estimation by using the ideal pilot tone values and/or data bin values as well.

In block 1050, the ideal pilot tone values are returned. In some embodiments ideal pilot tone values are associated with ideal pilot bin values and ideal pilot subcarrier values (e.g., ideal pailot subcarrier symbol values, etc.). With the returned ideal pilot tone values, more accurate estimates of frequency errors can be realized.

The novel presented approaches overcome numerous challenges for demodulation with reduced header information. FIG. 11B is an exemplary graph of a simulated channel response when there is a signal with a full header or a signal with a non-blind known stimulus in accordance with some embodiments. The non-blind known stimulus can be similar to a PayloadOnlyIdealIQWaveform discussed in other portions of this description. As shown in FIG. 11B, in some embodiments the system is readily able to get the known channel response on every used subcarrier. However, traditionally challenges arise when a system only has pilot tones to obtain the initial frequency responses. The Y axis is magnitude (dB) from −7.0 dB to 1.0 dB in increments of 1.0 dB and the X axis is subcarrier frequencies from −1000.0 Hz to 1000.0 Hz in increments of 50 Hz.

FIG. 11C is a graph illustrating the locations of exemplary pilot bin frequency responses in accordance with some embodiments. The known pilot bin frequency responses are not very populated compared to the otherwise unknow data bin frequency responses. In some embodiments, interpolation is performed to establish frequency response values for data bins in between the pilot bins. It is appreciated, the frequency responses shown in FIG. 11C for the data bins are not known until the interpolation is performed. The Y axis is magnitude (dB) from −7.0 dB to 1.0 dB in increments of 1.0 dB and the X axis is subcarrier frequencies from −1000.0 Hz to 1000.0 Hz in increments of 50 Hz.

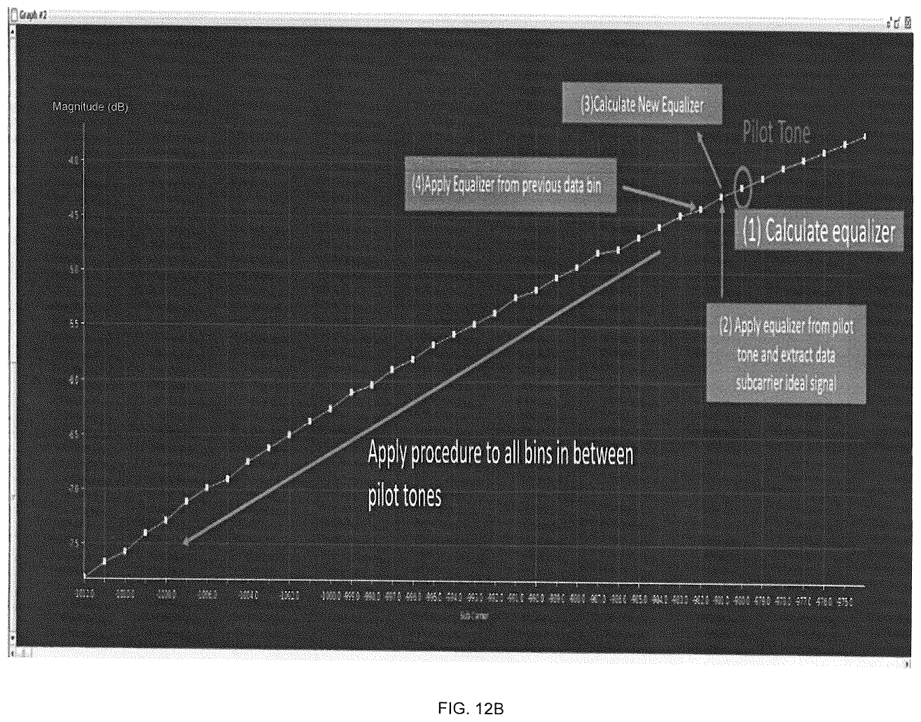

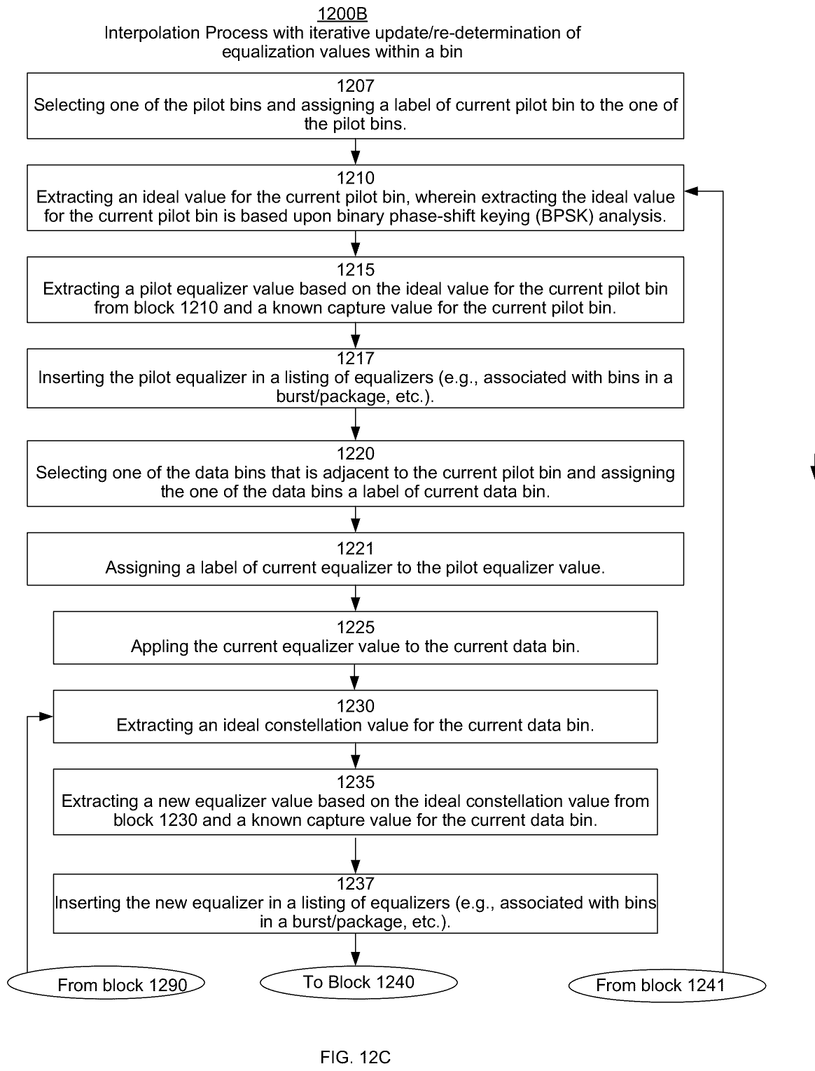

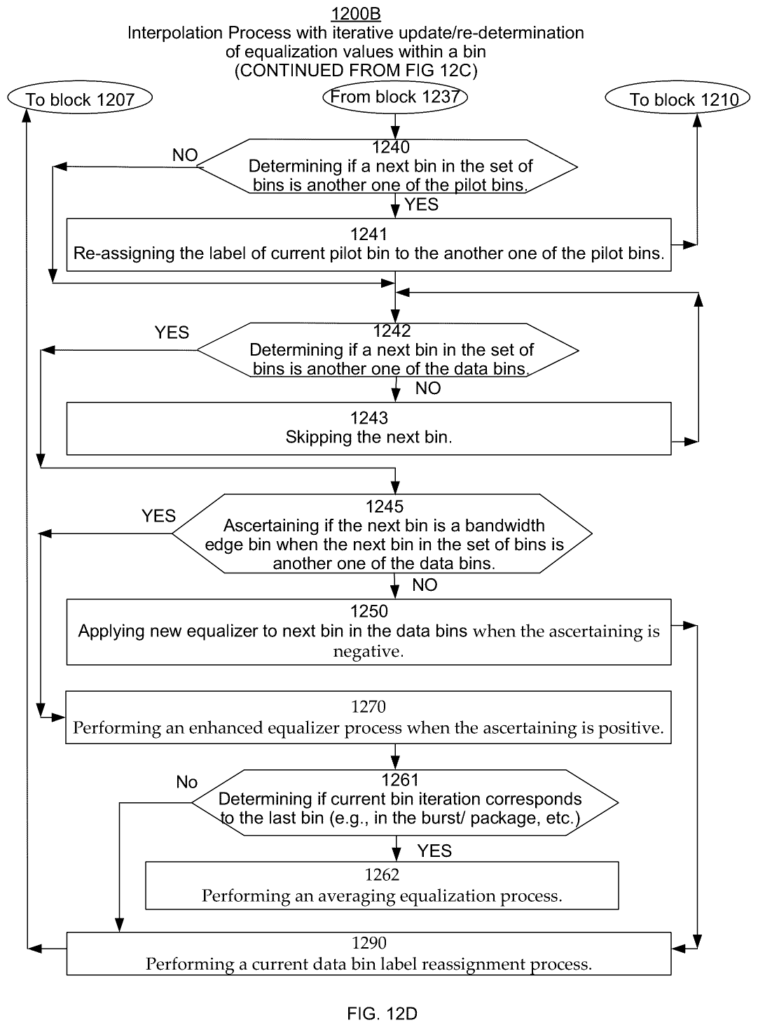

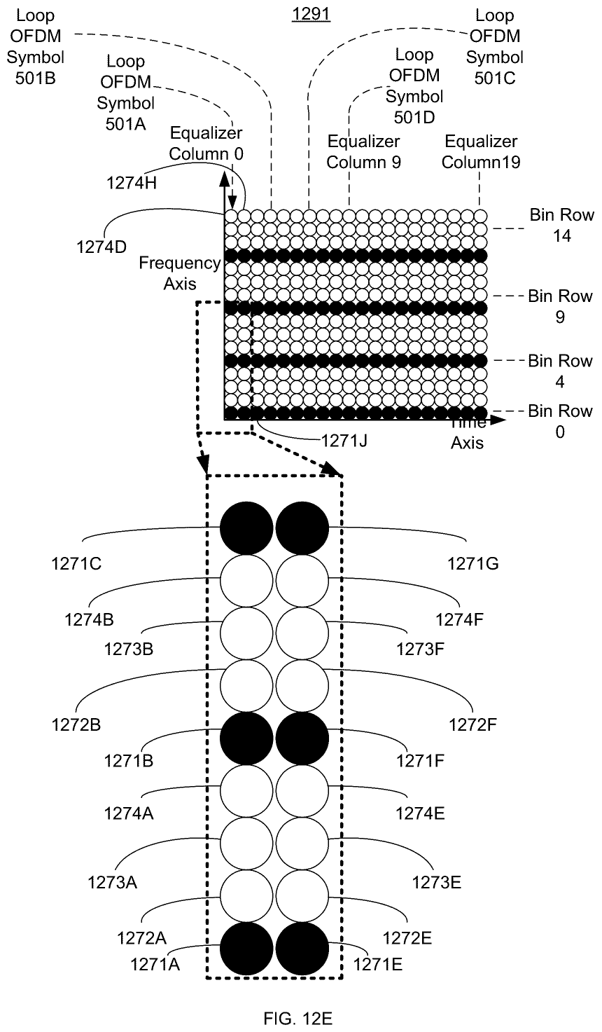

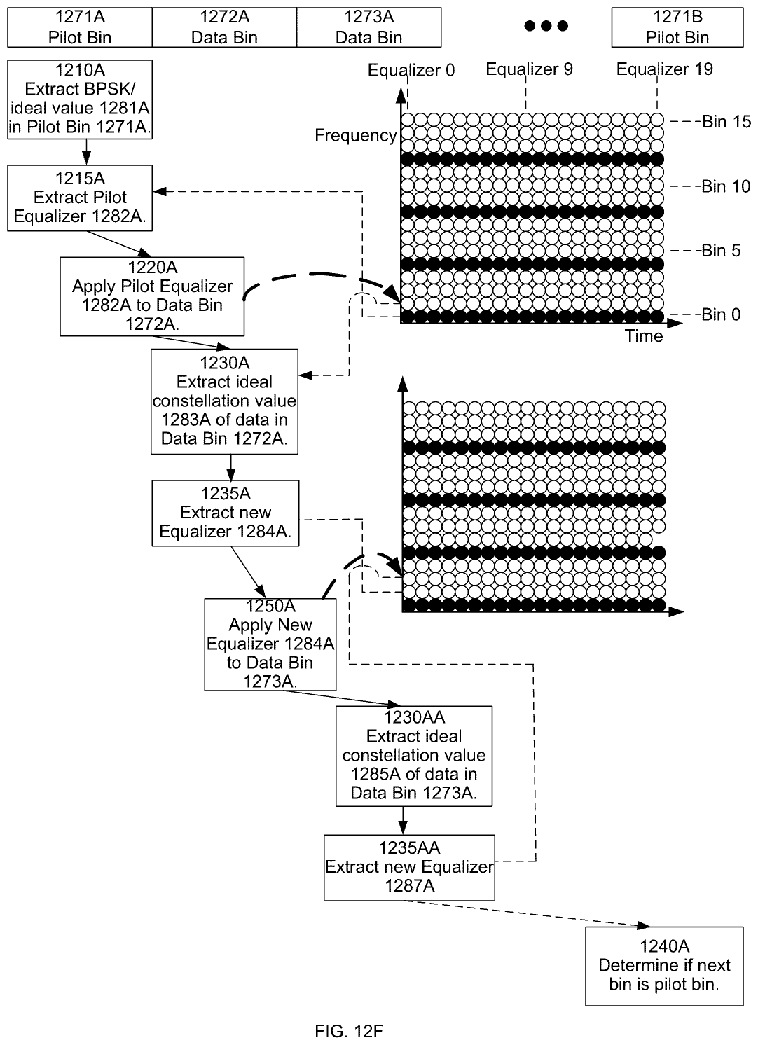

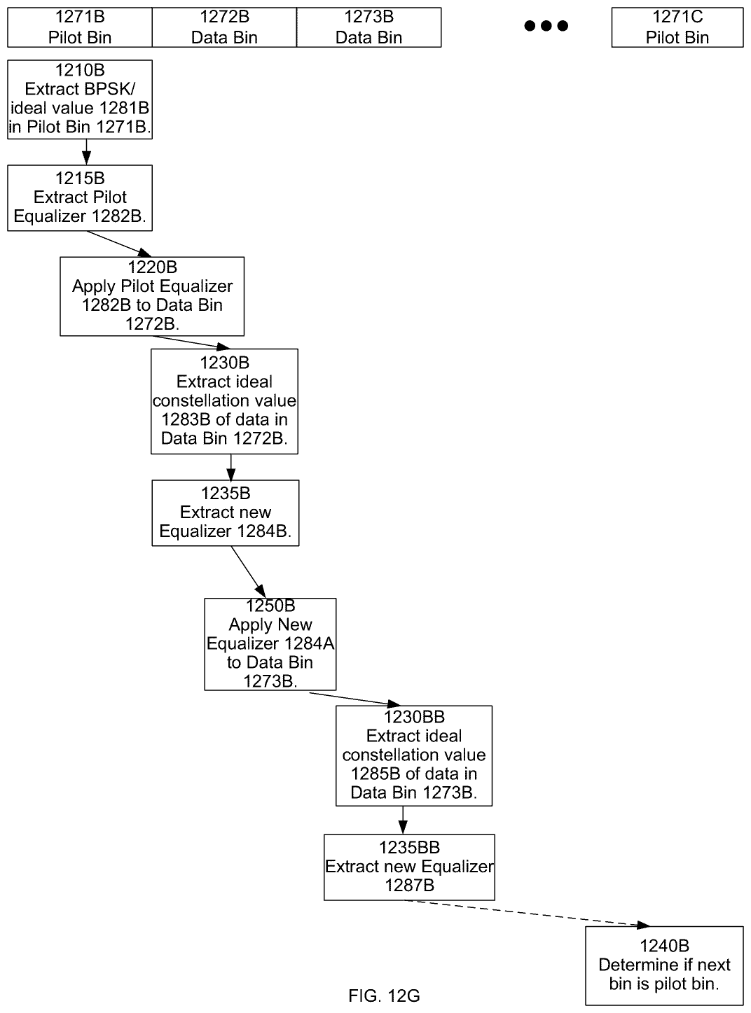

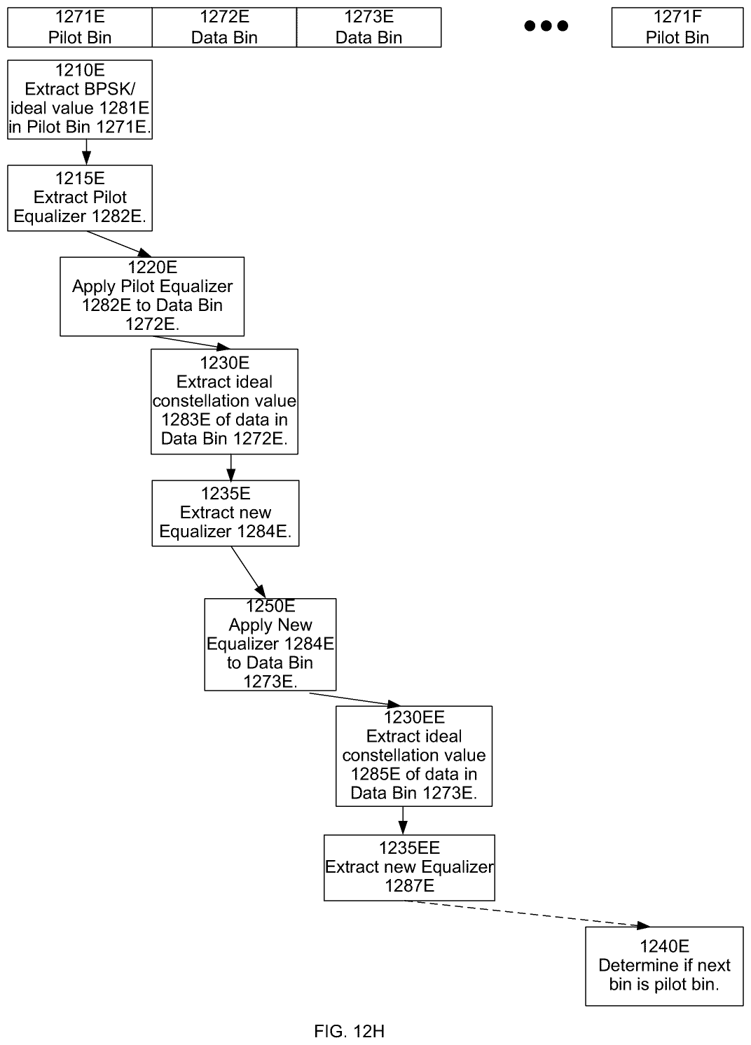

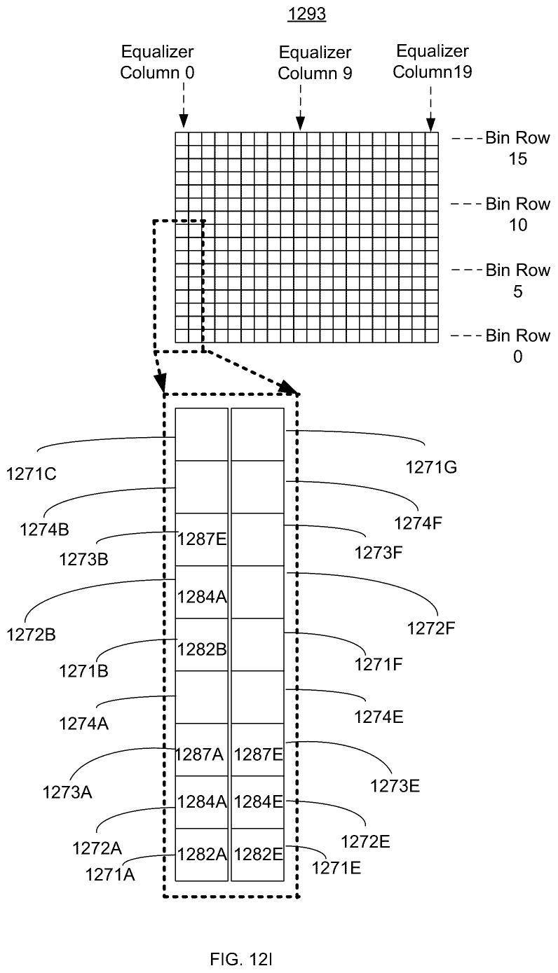

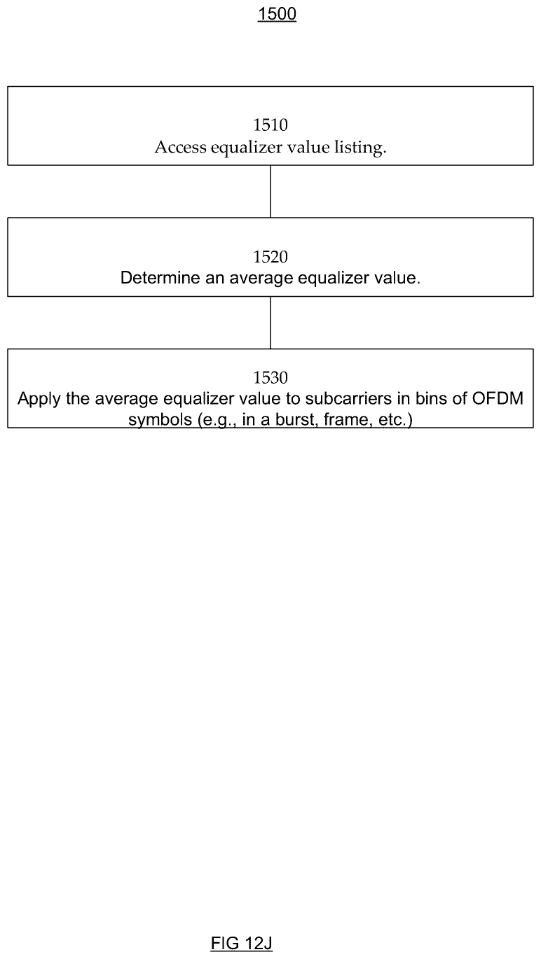

FIG. 12A is a flow chart of exemplary interpolation process 1200A with iterative update/re-determination of equalization values within a bin, in accordance with embodiments of the present disclosure. Interpolation process 1200A is included in some embodiments of a reduced header communication signal processing test method. Exemplary interpolation process 1200A with iterative update/re-determination of equalization values provides a more accurate interpolation of equalization values than the less iterative update interpolation processes of conventional straight line and conventional least squares interpolation, etc. Having more accurate equalization rates enables more accurate demodulation operations on a DUT and corresponding testing processes of those operations. This approach enables testing of DUTs where full frames or packets with full header information cannot otherwise be easily handled/demodulated in a testing environment. It is appreciated that interpolation process 1200A with iterative update/re-determination of equalization values within a bin are applicable to both magnitude correction and phase correction.

In block 1201 of FIG. 12A, a new equalizer value for a pilot tone is determined. In some embodiments the equalizer value is based on pilot binary phase shift keying (BPSK) of an ideal/known or easily extracted pilot signal value, etc. BPSK analysis of the signal has only two constellation points at opposite portions of the X-axis as shown in exemplary constellation map 610. Given the relatively large distance between the constellation points in BPSK as compared to other constellation maps (e.g., 620, 630, etc.) there is little chance of miss-associating a received signal value with the wrong ideal constellation point. In addition, there is little chance noise would be so significant as to add confusion to deciding on a proper constellation point. Thus, the difference of a received or capture signal value from the ideal constellation point provides a reliable indication channel response. The inverse of the channel response is equal to the equalizer value.

In block 1202, a determination is made if a next bin is a data bin. In some embodiments, a next bin is assumed to be a data bin if it does not have characteristics of a pilot bin or a null bin. The next bin is assumed to be a data bin if it is not one of the previously identified pilot bins and it has some transmitted signal characteristics (e.g., as opposed to a null bin which is not expected to have transmitted signal characteristics).

In block 1203, the new equalizer value is applied to the data bin. In some embodiments, applying a new equalizer from an adjacent bin provides a more accurate estimate of a preliminary equalizer value for the current data bin. Applying the preliminary new equalizer from an adjacent bin to the current data bin provides a reasonable initial correction of the current bin corresponding subcarrier values.

In block 1204, data subcarrier ideal signal values are extracted for the data bin. In some embodiments, the data subcarrier ideal signal values are based upon a relationship between the results of block 1203 to known expected values in accordance with communication protocol standards. By using the results of block 1203, the chances of misidentification of an appropriate corresponding ideal constellation point values are significantly reduced as compared to other conventional approaches.

In block 1205, a new equalizer value is established based on the data subcarrier ideal signal values. Establishing a new equalizer value for the current data bin based on the data subcarrier ideal signal values from bock 1204 provides an increasingly accurate interpolation result. The increasingly accurate estimate of an appropriate equalization value enables avoidance and often reversal of frequency response error issues.

FIG. 12B is a graph of results of an interpolation process with iterative update/re-determination of equalization values within a bin, in accordance with embodiments of the present disclosure. The graph includes an indication of relationships between various bins and associated subcarriers in a communication bandwidth. The graph also provides an illustration of the manner in which the described novel iterative interpolation approaches enable accurate adjustments for utilization in efficient testing of DUT demodulation performance. The Y axis is magnitude (dB) from −7.5 dB to −4.0 dB in increments of 0.5 dB and the X axis is subcarrier frequencies from −1012.0 Hz to 975.0 Hz in 1.0 Hz increments.

FIG. 12C and FIG. 12D are flow charts of exemplary interpolation process 1200B with iterative update/re-determination of equalization values within a bin, in accordance with embodiments of the present disclosure. Interpolation process 1200B is included in some embodiments of a reduced header communication signal processing test method. In some embodiments interpolation process 1200B is similar to interpolation process 1200A. With iterative update/re-determination of equalization values interpolation process 1200B also provides more accurate interpolation of equalization values than less iterative update interpolation processes such as the conventional straight line or conventional least squares interpolation, etc. It is appreciated that interpolation process 1200B with iterative update/re-determination of equalization values within a bin are applicable to both magnitude correction and phase correction.

The process 1200B performs functions directed to analysis of the pilot bins. In block 1207, one of the pilot bins is selected and assigned a label of current pilot bin. In block 1210, an ideal value is extracted for the current pilot bin, where extracting the ideal value for the current pilot bin is based upon binary phase-shift keying (BPSK) analysis. In block 1215, a pilot equalizer value based on the ideal for the current pilot bin from block 1210 and a known capture value for the current pilot bin are extracted. In block 1217, the pilot equalizer is inserted in a listing of equalizers associated with bins in a burst or frame package.

The process performs functions directed to analysis of the next data bin. In block 1220, one of the data bins that is adjacent to the current pilot bin is selected and a label of a current data bin is assigned to the one of the data bins. In block 1221, a label of current equalizer is assigned to the pilot equalizer value. In block 1225, the current equalizer value is applied to the current data bin. In block 1230, an ideal constellation value is extracted for the current data bin. In block 1235, a new equalizer value is extracted based on the ideal constellation value from block 1230 and a known capture value for the current data bin. In block 1237, the new equalizer is inserted in a listing of equalizers associated with bins in a burst or frame package.

The process includes checks for subsequent bins that are not data bins (e.g., a pilot bin, a null bin, etc.). In block 1240, a determination is made if a next bin in the set of bins is another one of the pilot bins. In block 1241, the label of current pilot bin is re-assigned to another one of the pilot bins. In block 1242, a determination is made if a next bin in the set of bins is another one of the data bins. In block 1243, the next bin is skipped (e.g., the result in block indicates the next bin is not a data bin, etc.). In some embodiments, if there is a null bin between the pilot bin and a data bin, the process “skips” over the null bin and analyzes the next data bin or pilot.

The process also includes the possibility of handling special situations (e.g., handling data bins at the edges of the bandwidth, restarting analysis at subsequent pilot bins, etc.). In bock 1245, if the next bin is a bandwidth edge bin, it is ascertained when the next bin in the set of bins is another one of the data bins. It is appreciated null bins are skipped over when proceeding to block 1250 and block 1270. In block 1250, the new equalizer is applied to next bin in the data bins when the ascertaining is negative. In block 1270, enhanced equalizer process is performed when the ascertaining is positive. In block 1261, a determination is made if current bin iteration corresponds to the last bin (e.g., in the burst or framepackage, etc.). If the current bin is the last bin the process proceeds to block 1262 and if the current bin is not the last bin the process proceeds to block 1290. In block 1290, a current pilot bin label reassignment process is performed. In block 1262, an averaging equalization process is performed.

In some embodiments, process 1200B proceeds until all the bins in a bandwidth are processed. The process can proceed in an increasing frequency bins/subcarriers direction, decreasing frequency bins/subcarriers directions, or both. In some embodiments, a pilot is selected as the initial pilot and the process proceed towards decreasing frequency bins/subcarriers. When it arrives at the lowest frequency bin/subcarrier in the bandwidth, it returns to the initial pilot and the process proceed towards increasing frequency bins/subcarriers until it gets to the highest frequency bin/subcarrier in the bandwidth. In some embodiments, a full demodulation process (e.g., similar to block 230, 830, etc.) is performed based on results of Interpolation Process 1200B.

FIG. 12E is a block diagram of an exemplary subcarrier bin configuration 1291 in accordance with embodiments of the present disclosure. The dot or circles represent various subcarrier bins (also known as the transmit spectrum within a communication bandwidth). The solid dark colored circles represent pilot subcarrier bins, also known as pilot bins, and the clear center circles represent data subcarrier bins (aka data bins). It is appreciated the subcarrier bin configuration can include other subcarrier bins (not shown). The Y axis corresponds to frequency values of various subcarriers and the X axis represents transmission of the subcarriers over time.

It is appreciated subcarrier bin configuration 1291 represents a communication burst or frame of subcarrier bins and corresponding OFDM symbols in accordance with some embodiments of the disclosure. The columns of bins correspond to bins within respective OFDM symbols. The bins are also tracked in rows of bins (e.g., bin row 0 bin row 4, bin row 9, bin row14, etc.). It is appreciated the organization of OFDM symbols included subcarrier bin configuration 1291 can vary. In some embodiments, each column is associated with a different OFDM symbol. In some exemplary implementations, the OFDM symbols are in a loop that repeats (e.g., similar to payload portion 505) in the subcarrier bin configuration (e.g., OFDM symbol 4501 repeats as 501A, 501B, 501C, 501D, etc.). While the subcarrier bin configuration 1291 is directed to subcarrier bin configuration, there are also equalization values associated with the respective bins (e.g., equalizers associated with bins in column 0, equalizers associated with bins in column 9, equalizers associated with bins in column 19, etc.). The bins include 1274D, 1274H, 1271J and in the expanded view section 1271A, 1272A, 1273A, 1274A, 1271B, 1272B, 1273B, 1274B, 1271C, 1271E, 1272E, 1273E, 1274E,1271F, 1272F, 1273F, 1274F, and 1271G.

The equalizer values associated with the bins are determined in accordance with interpolation process 1200B in some embodiments. FIGS. 12F, 12G and 12H are flow charts explaining exemplary implementations of interpolation process 1200B in accordance with some embodiments of the present disclosure. It is appreciated that the blocks in FIGS. 12F, 12G and 12H (e.g., 1210B in FIG. 12F, block 1210E in FIG. 12G, block 1210K in FIG. 12H, etc.) are different iterations of the respective process blocks in FIGS. 12C and 12D 9 (e.g. block 1210 in FIG. 12C, etc.).

FIG. 12F is a block diagram of exemplary signal information processing operations in accordance with embodiments of the present disclosure. There are several bins, including pilot bin 1271A, data bin 1272A, data bin 1273A, and pilot bin 1271B. The process begins with pilot bin 1271A in block 1210A where an ideal constellation value associated with the pilot bin value 1281A (aka pilot bin ideal value) is extracted for pilot bin 1271A. In block 1215A a pilot equalizer 1282A is extracted. In block 1220A the pilot equalizer 1282A is applied to data bin 1272A. In block 1230A an ideal constellation value 1283A for data in data bin 1272A is extracted. In block 1235A a new equalizer 1284A is extracted. In block1250A, the new equalizer 1284A is applied to data bin 1273A. In block 1230AA (e.g., the process returns to another iteration of block 1230, etc.) an ideal constellation value 1285A for data in data bin 1273A is extracted. In block 1235AA, a new equalizer 1287A is extracted. The process proceeds in other blocks (not shown) and the process continues (e.g., the new equalizer is applied to the next data bin, etc.). In block 1240A a determination is a made if the next bin is a pilot bin. When the process encounters another pilot (e.g., pilot bin 1271B, etc.) the process returns and performs another iteration of block 1210 (e.g., in FIG. 12G, etc.).

FIG. 12G is a block diagram of exemplary signal information processing operations in accordance with embodiments of the present disclosure. There are several bins, including pilot bin 1271B, data bin 1272B, data bin 1273B, and pilot bin 1271C. The process begins with pilot bin 1271B in block 1210B where an ideal constellation value associated with the pilot bin value 1281B (aka pilot bin ideal value) is extracted for pilot bin 1271B. In block 1215B a pilot equalizer 1282B is extracted. In block 1220B the pilot equalizer 1282B is applied to data bin 1272B. In block 1230B an ideal constellation value 1283B for data in data bin 1272B is extracted. In block 1235B a new equalizer 1284B is extracted. In block1250B, the new equalizer 1284B is applied to data bin 1273B. In block 1230BB (e.g., the process returns to another iteration of block 1230, etc.) an ideal constellation value 1285B for data in data bin 1273B is extracted. In block 1235BB, a new equalizer 1287B is extracted. The process proceeds in other blocks (not shown) and the process continues (e.g., the new equalizer is applied to the next data bin, etc.). In block 1240B a determination is a made if the next bin is a pilot bin. When the process encounters another pilot (e.g., pilot bin 1271C, etc.) the process returns and performs another iteration of block 1210.

The process continues from FIGS. 12 F and 12G in a similar manner for other bins in an OFDM symbol. With reference to 12E the process continues on to find an equalizer associated with bin 1274D. Thus, the process determines equalizer values for the respective bins in equalizer column 0 in FIG. 12E. The process returns to the next column and begins again with bin 1271E.

FIG. 12H is a block diagram of exemplary signal information processing operations in accordance with embodiments of the present disclosure. There are several bins, including pilot bin 1271E, data bin 1272E, data bin 1273E, and pilot bin 1271F. The process begins with pilot bin 1271E in block 1210E where an ideal constellation value associated with the pilot bin value 1281E (aka pilot bin ideal value) is extracted for pilot bin 1271E. In block 1215E a pilot equalizer 1282E is extracted. In block 1220E the pilot equalizer 1282E is applied to data bin 1272E. In block 1230E an ideal constellation value 1283E for data in data bin 1272E is extracted. In block 1235E a new equalizer 1284E is extracted. In block1250E, the new equalizer 1284E is applied to data bin 1273E. In block 1230EE (e.g., the process returns to another iteration of block 1230, etc.) an ideal constellation value 1285E for data in data bin 1273E is extracted. In block 1235EE, a new equalizer 1287E is extracted. The process proceeds in other blocks (not shown) and the process continues (e.g., the new equalizer is applied to the next data bin, etc.). In block 1240E a determination is a made if the next bin is a pilot bin. When the process encounters another pilot (e.g., pilot bin 1271F, etc.) the process returns and performs another iteration of block 1210.

The process continues in a similar manner for other bins of OFDM symbols (e.g., in the burst, frame, etc.). With reference to 12E, moving up the second column bin 1274H and returns to the next column bin 1271J. When equalization values for the burst are extracted the process proceeds to an averaging process. With reference again to FIG. 12D, in block 1290 an averaging process is performed. The averaging process is performed based upon the equalization values in the list of equalizers (e.g., developed in blocks 1217, 1237, etc.). FIG. 12I is a block diagram of equalizer value listing 1293 associated with bins of OFDM values in a burst or frame. The bins correspond to bins in FIG. 12E and the equalizer values correspond to an exemplary implementation of interpolation process 1200B (e.g., as shown in FIGS. 12F, 12G, 12H, etc.). With reference to FIG. 12F in block 1215A equalizer 1282A is extracted from pilot bin 1271A. According to interpolation process 1200B in block 1217 the equalizer 1282A is inserted in a listing (e.g., equalizer value listing 1293, etc.). It is appreciated the equalizer values can be inserted in a list stored in a memory.

FIG. 12J is a flow chart of an average equalizer process 1500 in accordance with some embodiments of the disclosure. Average equalizer process 1500 offers the opportunity for overall improved handling of frequency errors and equalization correction. In some embodiments, the averaging can help avoid overcorrection due to an outlier or aberration in a particular bin. In some exemplary implementations, the averaging can help smooth results over time (e.g., in the horizontal row direction, etc.) and across subcarrier frequencies (e.g., in the vertical OFDM symbol direction, etc.). In some exemplary implementations, average equalizer process 1500 is included in block 1262.

In block 1510, equalizer values are accessed. In some embodiments, equalizer value listing 1293 is accessed. In some exemplary implementations, the accessed equalizer values are associated with OFDM symbols in a communication burst or frame. The equalizer values may be accessed from a memory or other mechanism.

In block 1520, an average equalization value is determined. It is appreciated the average equalization value can be directed to different averaging objectives. With reference to both FIGS. 12J and 12I together, the averaging equalization value can correspond to an average of the equalization values in a row of equalizer value listing 1293 (e.g., bin row 0 bin row5, etc.). The averaging equalization value can correspond to an average of the equalization values in a column of equalizer value listing 1293 (e.g., equalizer column 0, equalizer column 9, etc.) The averaging equalization value can correspond to an average of the equalization value in a burst or frame (e.g., burst or frame 1291, etc.).

In block 1530, the average equalizer value is applied to subcarriers in bins of OFDM symbols. In some embodiments, applying the average equalizer to the subcarriers leads to the ability of mitigating residual errors. It is appreciated average equalizer values can be applied in a various configurations. A first average equalizer value for a first row of subcarrier bins can be applied to corresponding subcarriers for the first row and a second average equalizer value for a second row of subcarrier bins can be applied to corresponding subcarriers for the second row. A first average equalizer value for a first column of subcarrier bins can be applied to corresponding subcarriers for the first column and a second average equalizer value for a second column of subcarrier bins can be applied to corresponding subcarriers for the second column. An average equalizer value can be applied to subcarriers in bins of OFDM symbols in a burst, frame, etc.

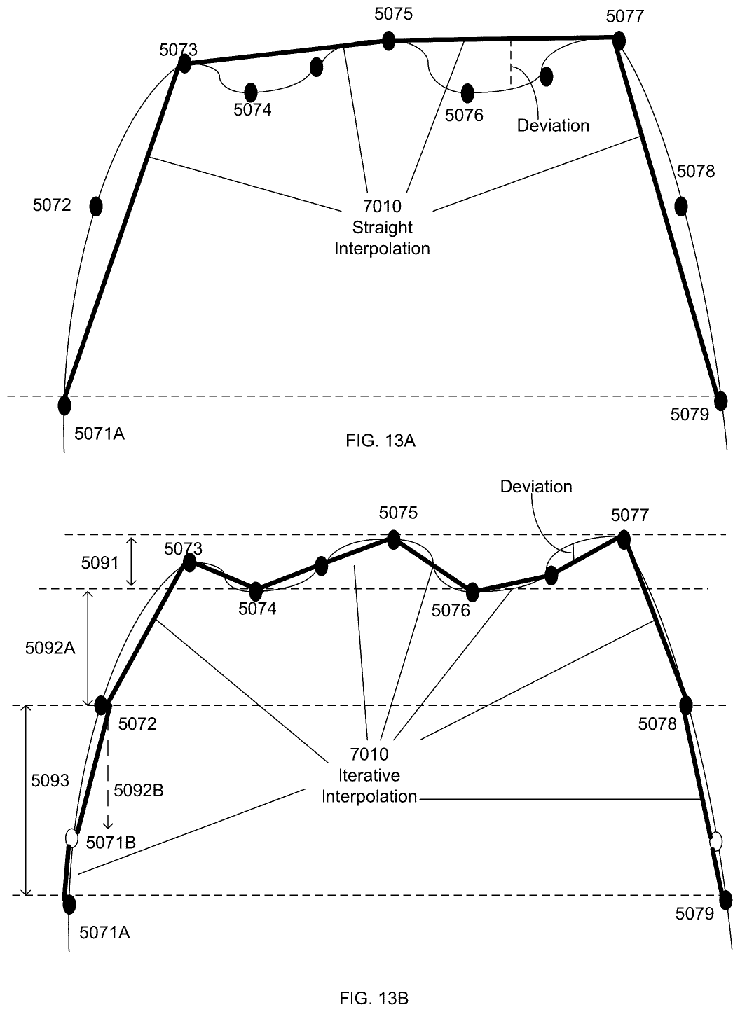

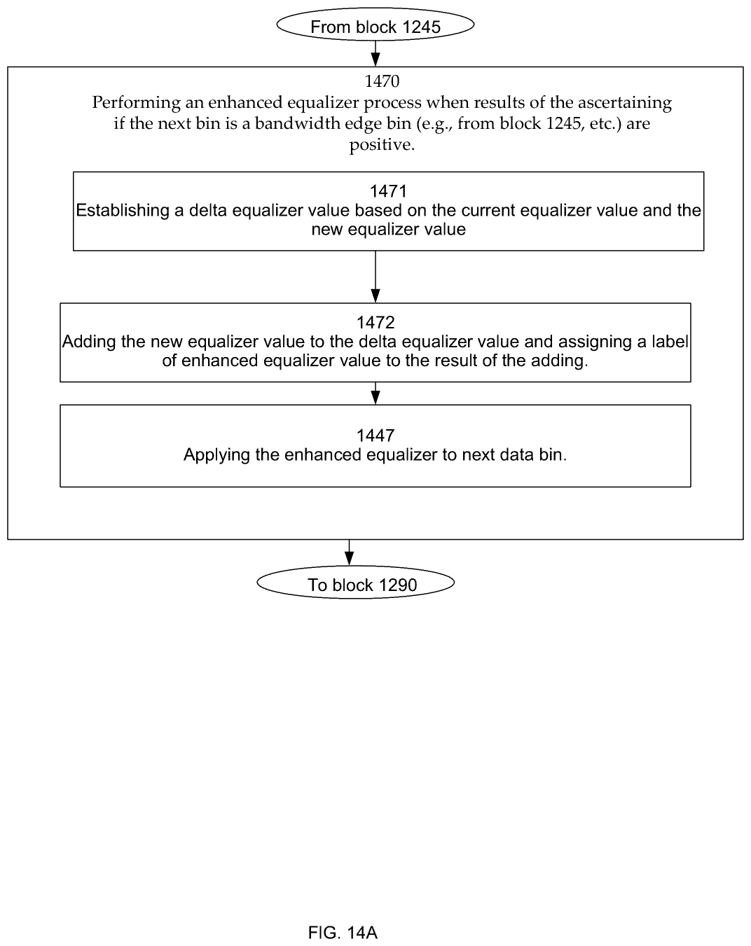

It is appreciated that various forms of interpolation are compatible with the presented novel approaches. In some embodiments, interpolation approaches may vary in accuracy. FIG. 13A is an exemplary graph of a frequency response for a bandwidth comprising multiple bins/subcarriers in accordance with embodiments of the present disclosure. The different bins/subcarrier values are indicated by the solid dots (e.g., 5071A, 5072, 5073, 5074, 5075, 5076, 5077, 5078, 5079, etc.). In FIG. 13A, the pilot bins are associated with dots 5071A, 5073, 5075, 5077, and 5079 and the data bins are associated with the remaining dots (e.g., 5072, 5074, 5076, 5078, etc.) and a straight line interpolation process is utilized to estimate the frequency responses and corresponding equalizers. While the estimate is reasonable there is a deviation from the true values.

FIG. 13B is an exemplary graph of a frequency response for a bandwidth comprising multiple bins/subcarriers in accordance with embodiments of the present disclosure. The frequency response, bandwidth, multiple bins/subcarriers, and corresponding signal in FIG. 13B are similar to those in FIG. 13A. In FIG. 13B, the pilot bins are associated with dots 5071A, 5073, 5075, 5077, and 5079 and the data bins are associated with the remaining dots (e.g., 5072, 5074, 5076, 5078, etc.) and an iterative interpolation process (e.g. similar to ones such as 1200B utilized to estimate the frequency responses and corresponding equalizers, etc.). In some embodiments, the iterative interpolation process is similar to the interpolation process with iterative update/re-determination of equalization values within a bin (e.g., illustrated in FIG. 12A, 12C, 12D, etc.). The iterative interpolation process results in values very close to true values. For example, the deviations between the interpolation values and true values in FIG. 13B are much smaller than in FIG. 13A. In some exemplary implementations, there are no symbol errors when extracting the constellation information and the iterative interpolation process values are the same as the true values.

In some implementations, a frequency line is fairly close to a flat or straight line for majority of the bins/subcarriers in the large central portion of the bandwidth but issues begin to arise (e.g., due to filter performance/limitations, etc.) towards the edges. In the central portion (solid dots between 5073 and 5077) the frequency is fairly flat or just a small ripple in the range 5091. Given the bin/subcarrier frequency responses are relatively flat or close to one another (e.g., 5073 is relatively close to 5074, etc.) the equalizer value from one serves as a relatively good initial equalization value for the other. As the frequencies get to the lower and upper boundaries or edges of the bandwidth (e.g., 5071A, 5072, 5078, 5079, etc.), the frequency response ranges (e.g., 5092A, 5093, etc.) start to decrease rapidly. In some embodiments, as the frequency decreases the magnitude of the change in the response increases in the downward direction. In some embodiments, the difference is added to the estimated equalizer values as the process traverses the bins/subcarriers closer to the edges. The estimate equalizer used for bin/subcarrier 5071B, includes the equalizer from bin/subcarrier 5072 added to the adjustment value 5092B (which equals the difference 5092A between the equalizer for bin/subcarrier 5073 and bin/subcarrier 5072) to provide an initial estimated value of 5071B. For purposes of the graph estimated value 5071B is shown associated with a fictitious bin/subcarrier 5071B which is relatively close to bin subcarrier 5071A (e.g., similar to the way bin/subcarrier 5073 is relatively close to bin/subcarrier 5074) and serves as a relatively good initial equalization value for the other.

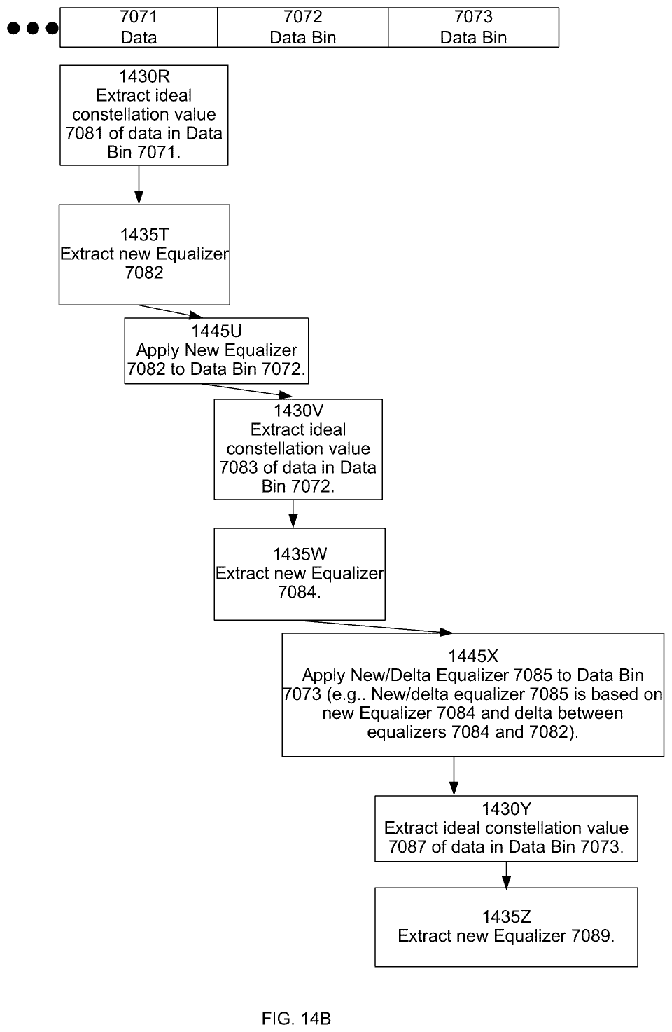

FIG. 14A is a flow chart of an exemplary enhanced equalizer process in accordance with embodiments of the present disclosure. The enhanced equalizer process can be implemented to handle special or unique data bin scenarios. In some exemplary implementations, the data bins are located at the edges of the bandwidth and as a result the difference between equalization values can vary more significantly from bin to bin. Thus, simply relying on an equalizer value from a previous bin may not be sufficiently reliable. In some embodiments, adjustments in accordance with an enhanced equalizer process provides more reliable interpolation and estimates of appropriate equalizer values.

In block 1470, an enhanced equalizer process is performed when results of the ascertaining if the next bin is a bandwidth edge bin (e.g., from block 1245, etc.) are positive. The enhanced equalizer process is similar to the enhanced equalizer process performed in block 1270. In block 1471, a delta equalizer value is established based on the current equalizer value and the new equalizer value. The delta equalizer value is the difference between the current equalizer value and the new equalizer value. In block 1472, the new equalizer value is added to the delta equalizer value and assigning a label of enhanced equalizer value to the result of the adding. Adding the new equalizer value to the delta equalizer value provides a result much closer to the true equalizer value for the next bin. In block 1447, the enhanced equalizer is applied to next data bin. Using an enhanced equalizer value provides more reliable estimates of an appropriate equalizer value for a next data bin. Thus, when the enhanced equalizer is applied to next data bin demodulation

FIG. 14B is a block diagram of exemplary signal information processing operations in accordance with embodiments of the present disclosure. There are several bins, including data bin 7071, data bin 7072, data bin 7073. The process beings with data bin 7071 and in block 1430R an ideal constellation value 7081 is extracted for data bin 7071. In block 1435T, a new equalizer 7082 is extracted and applied to data bin 7071. In block 1445U, the data equalizer 7082 is applied to data bin 7072. In block 1430V, an ideal constellation value 7083 for data in data bin 7072 is extracted. In block 1435W, a new equalizer 7084 is extracted and new equalizer 7084 is applied to data bin 7072. In block 1445X, the new/delta equalizer 7085 (e.g., new equalizer 7084 plus a delta equalizer value similar to 5092B in FIG. 13B, etc.) is applied to data bin 7073. In block 1430Y, (e.g., the process returns to another iteration of block 1430R, etc.) and an ideal constellation value 7087 for data in data bin 7073 is extracted. In block 1435Z, a new equalizer 7089 is extracted and new equalizer 7089 is applied to data bin 7073.

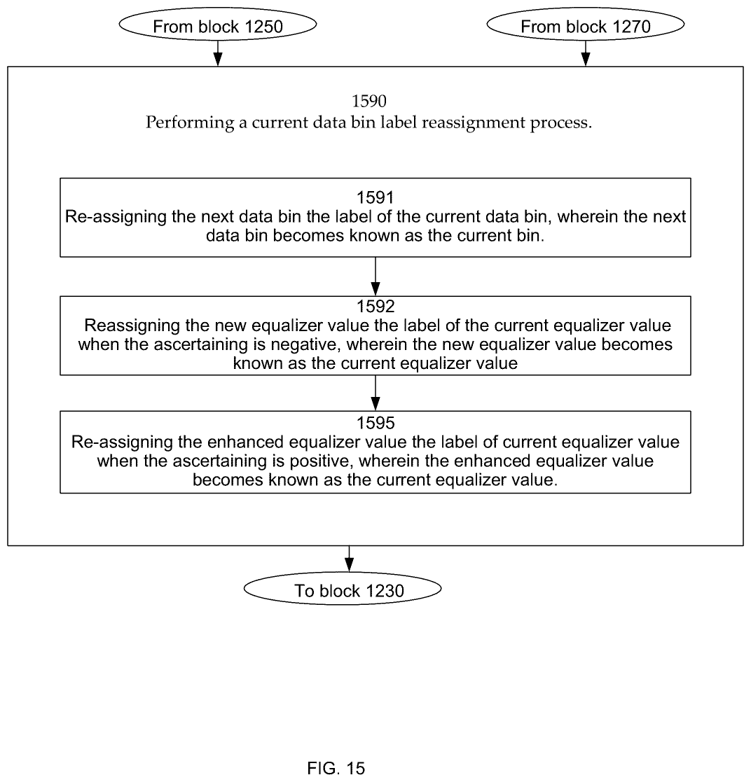

FIG. 15 is a flow chart of an exemplary current data bin label reassignment process in accordance with embodiments of the present disclosure. The block diagram of a current data bin label reassignment process is similar to the block diagram of a current data bin label reassignment process of block 1290. In block 1590, a current data bin label reassignment process is performed. Current data bin label reassignment process 1590 includes the following operations. In block 1591, the next data bin is re-assigned the label of the current data bin, wherein the next data bin becomes known as the current bin. In block 1592, the new equalizer value is re-assigned the label of the current equalizer value when the ascertaining is negative, wherein the new equalizer value becomes known as the current equalizer value. In block 1595, the enhanced equalizer value is re-assigned the label of current equalizer value when the ascertaining is positive, wherein the enhanced equalizer value becomes known as the current equalizer value.

In some embodiments, a full demodulation process (e.g., similar to block 230, 830, etc.) is performed based on results of interpolation processes (e.g., 1200A, 1200B, etc.). In some embodiments, performing full demodulation is performed similar to in a normal manner (e.g., similar to non-test environment, similar to utilization of full header information, etc.). Performing full demodulation is similar to demodulation in a real world field environment. Performing full modulation is similar to performing modulation when associated header/preamble information is available in the signal transmission. In some exemplary implementations, performing full modulation includes determining full equalizer values, accurately establishing frequency error, sampling clock error, and so on. In some embodiments all result parameters needed to test a RF WIFI component/device are determined.

It is appreciated other interpolation processes can be implemented. In some embodiments, a linear or polynomial fit response or interpretation is implemented. In some exemplary implementations, iterative interpolation processes (e.g., 1200A, 1200B, etc.) is selected and implemented instead of a linear or polynomial interpolation when device captures potentially give a larger than expected erroneous value for some interpolated bins (e.g., which in turn may lead to an even larger channel response interpolation error, etc.). In some embodiments, interpolation pilot locations are not highly populated.

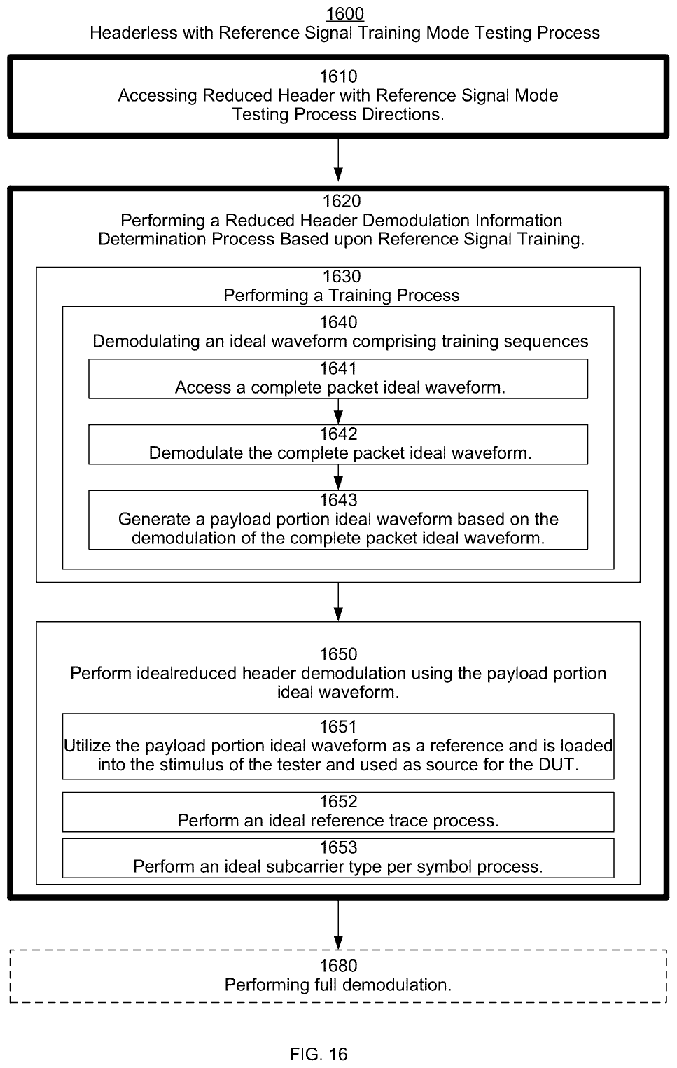

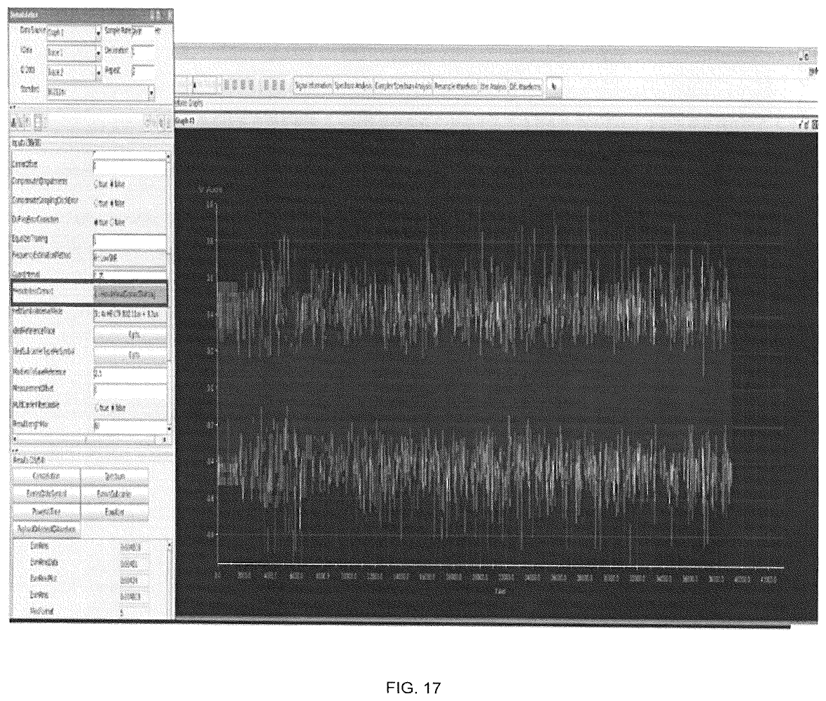

FIG. 16 is a flow chart of an exemplary reduced header with reference signal training mode testing process 1600 in accordance with embodiments of the present disclosure. In the reduced header with reference signal training mode testing process, a known ideal payload signal is extracted from a full Wi-Fi signal. The ideal payload signal (e.g., PayLoadOnlyIdealIQWaveform, etc.) has no or reduced header information. The ideal payload signal is played into the DUT. In some embodiments, a demodulator can be trained with an ideal waveform to provide an ideal payload portion of the packet (e.g., primarily data, data only, etc.) with reduced or no header information. A clean capture with low EVM is used to train the modulator to produce the ideal payload portion. This approach also enables testing of DUTs where full frames or packets with full header information cannot otherwise be easily handled/demodulated.

The process includes development of an ideal waveform based on information in a header portion of a signal. In block 1610, reduced header with reference signal mode testing process directions are accessed. In block 1620, a reduced header demodulation information determination process is performed based upon reference signal training. In block 1630, a training process is performed. In block1640, an ideal waveform comprising training sequences is demodulated. In block 1641, a complete packet of an ideal waveform is accessed. In block1642, a complete packet of an ideal waveform is demodulated. In block 1643, a payload portion of an ideal waveform is generated based on the demodulation of the complete packet ideal waveform. In some embodiments the payload waveform is a payload-only ideal waveform (e.g., IQ waveform, etc.).

The process includes demodulation testing based on use of the ideal waveform. In block 1650, reduced header demodulation is performed using the payload-portion of the ideal waveform. The reduced header demodulation can be headerless demodulation performed using headerless payload-only portion of the ideal waveform. In block 1651, the payload portion ideal waveform is utilized as a reference and is loaded into the stimulus of the tester and used as source for the DUT. In block 1652, an ideal reference trace process is performed. In some embodiments the ideal reference tract process comprises defining constellation points of ideal demodulation signals. In block 1653, an ideal subcarrier type per symbol process is performed. In some embodiments, the input parameter IdealReference Trace defines the constellation points of the ideal demodulated signal and the parameter IdealSubcarrierTypePerSymbol defines the subcarrier type for each element of the ideal reference trace. In some exemplary implementations, the IdealReferenceTrace is a complex array whose length is twice that of the IdealSubcarrierTypePerSymbol.

In block 1680, full demodulation is performed. In some embodiments, full demodulation is similar to some aspects of a conventional demodulation analysis. After information from block 1650 is available, the process can proceed with full demodulation determining information similar to conventional information that would otherwise not traditionally have been available from reduced header signals.

FIG. 17 is a screen shot of an example 802.11ax 20 MHz ideal waveform graphical user interface (GUI) in accordance with embodiments of the present disclosure. The waveform in the GUI is a complete packet containing the header part and the data part. In some embodiments, training includes a full burst in order to generate a payload-only ideal signal. The Y axis is amplitude (unitless) in increments of 0.2 and the X axis is time (uS) in increments of 2000.

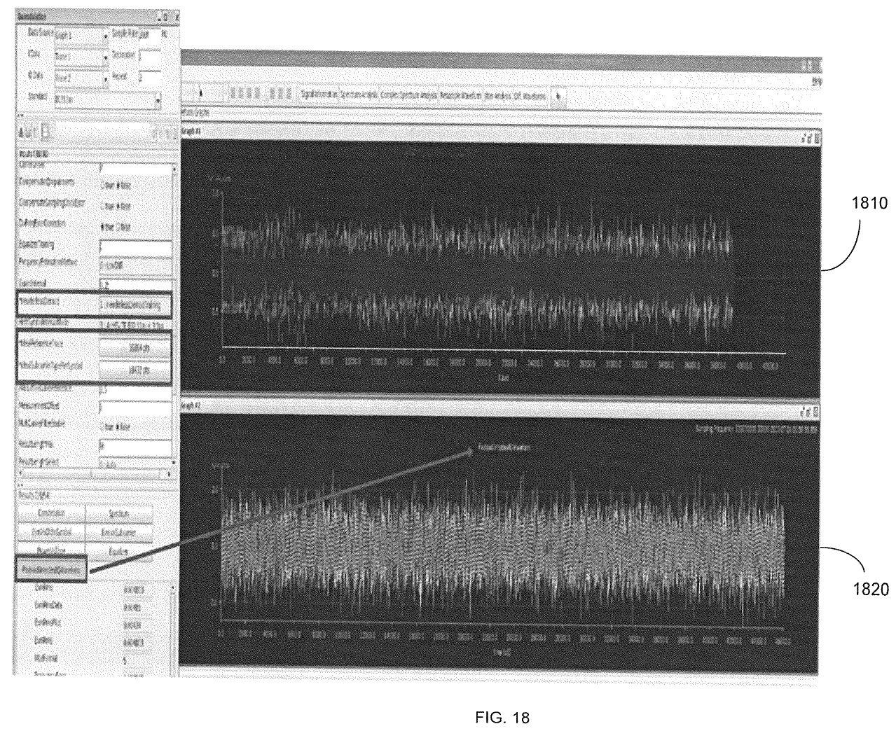

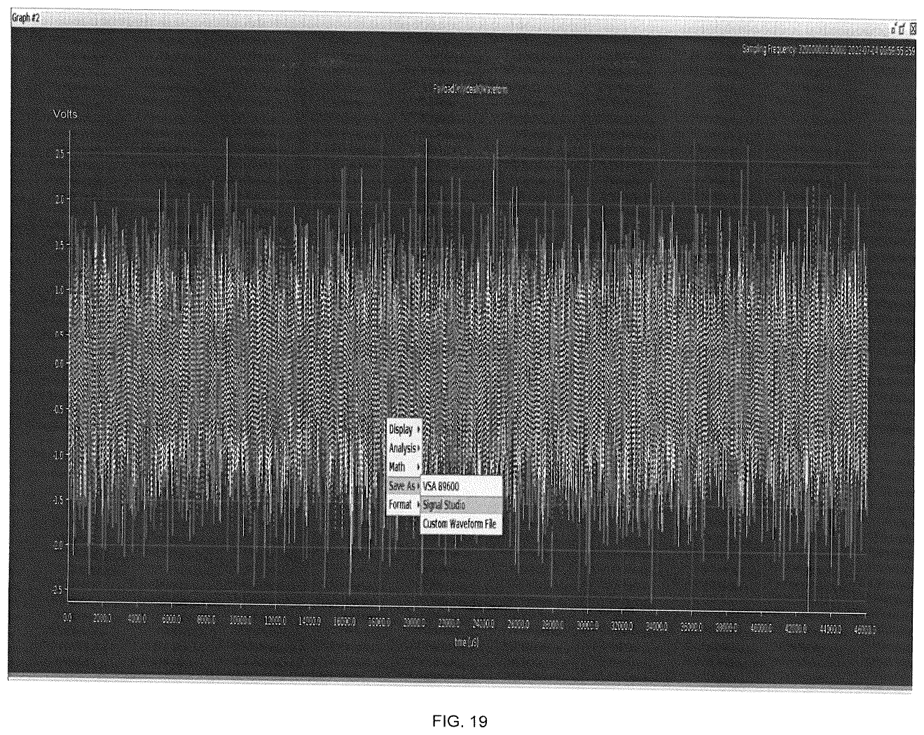

FIG. 18 is a screen shot of an exemplary the payload-only ideal IQ waveform graphical user interface (GUI) when the input parameter HeaderlessDemod is set to training in accordance with some embodiments. A HeaderlessDemodTraining and Execute option is employed to implement development and creation of the payload-only ideal IQ waveform. The graph is provided by the PayloadOnlyIdealIQWaveform operation. The waveform 1810 is waveform of a complete packet containing the header part and the data payload part of a communication and waveform 1820 is waveform of a data payload only part of a communication. In waveform 1810 the Y axis is amplitude (Volts) in increments of 0.5 and the X axis is time (uS) in increments of 2000. In waveform 1820 the Y axis is amplitude (volts) in increments of 2.0 and the X axis is time (uS) in increments of 2000.

FIG. 19 is a screen shot of a graph of an exemplary extracted payload-only ideal signal in accordance with embodiments of the present disclosure. FIG. 19 illustrates some of the characteristics of operations in block 1653 such as the input parameter IdealReferenceTrace defines the constellation points of the ideal demodulated signal and the parameter IdealSubcarrierTypePerSymbol defines the subcarrier type for each element of the ideal reference trace. In some exemplary implementations the IdealReferenceTrace is a complex array whose length is twice that of the IdealSubcarrierTypePerSymbol. The Y axis is amplitude (volts) in increments of 0.5 and the X axis is time (uS) in increments of 2000.

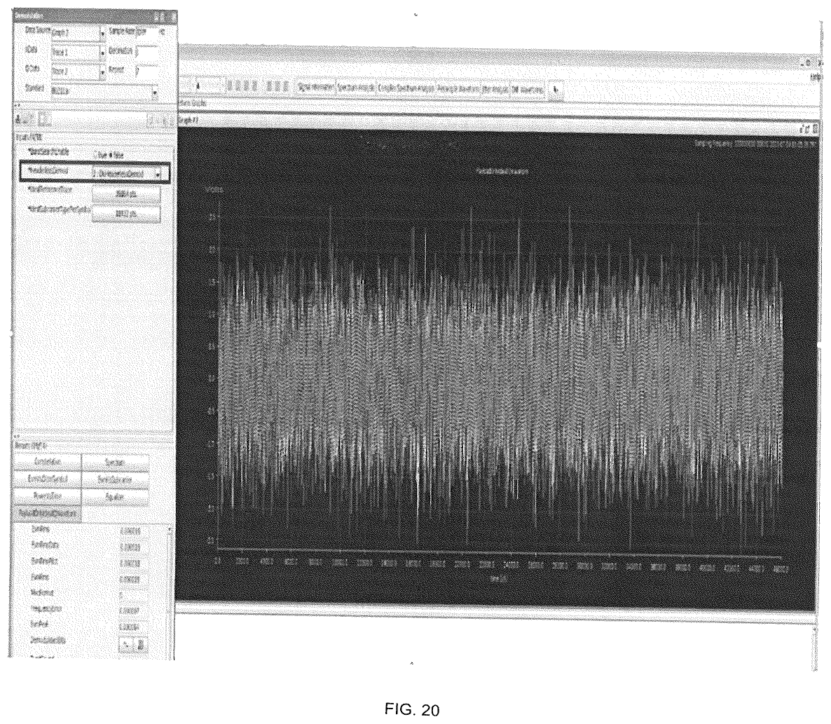

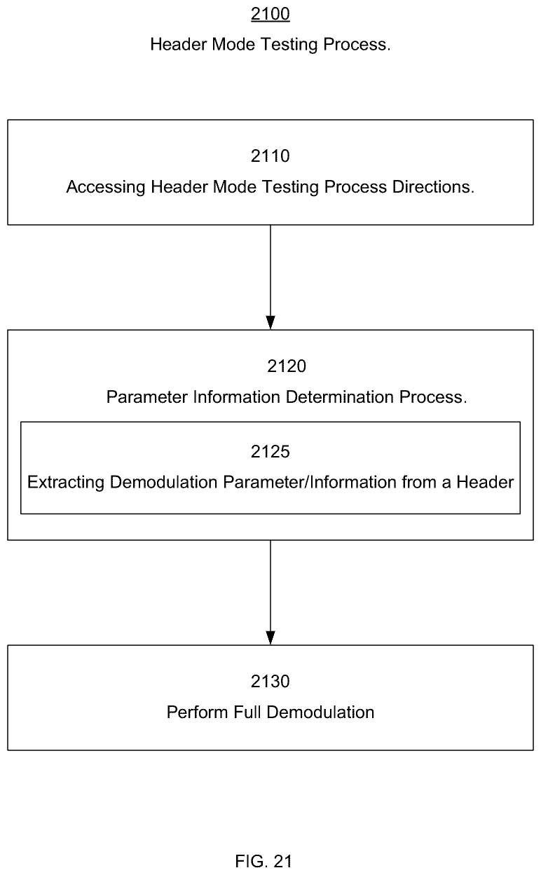

FIG. 20 is a screen shot of a graph of a demodulated payload-only signal within a GUI in accordance with embodiments of the present disclosure. To perform a headerless demodulation using the ideal payload-only waveform, the input parameter to headerless demodulation is based on training (e.g., DoHeaderlessDemod and set BurstSearchEnable to false, etc.). The Y axis is amplitude (volts) in increments of 0.5 and the X axis is time (uS) in increments of 2000.

FIG. 21 is a flow chart of an exemplary header mode testing process 2100 in accordance with embodiments of the present disclosure. In block 2110, header mode testing process directions are accessed. In some embodiments, the header mode testing directions are accessed from a memory included in an ATE system. In block 2120, a parameter information determination process is performed. The parameters are associated with frequency offset, timing information, equalization, and so on. The parameters are utilized in demodulating communication systems. In block 2125, demodulation parameter information is extracted from a header. The configuration of the information is defined by a communication protocol. The information is extracted from the fields in the header (e.g., a short a training field, long training field, a signal field, etc.). In block 2130, full demodulation is performed.

Much of the description is presented with reference to public communication protocols. It is appreciated, the novel presented systems and methods are also readily applicable to protocols that are not publicly known (e.g., privately established by a testing entity, establish by a DUT manufacturer and confidentially conveyed to ATE entity, etc.). Types of modulation (e.g., BPSK, QPSK, etc.) can be assigned to subcarriers and ideal values can be established, which in turn are “known” by the ATE. Signals and corresponding information can be configured according to various types of protocols (e.g., public, private, etc.). Various values (e.g., timing, frequency errors, equalizers, EVM, performance values, modulation values, demodulations values, etc.) can be established based upon captured information compared to the ideal values. The values can be applied to other signals (e.g., adjacent subcarriers, etc.). The configuration or organization of subcarriers within a bandwidth (e.g., with respect to one another, in frequency bins, etc.) can be established and known to the ATE. Presented novel iterative interpolation systems and methods can be utilized to determine information regarding various signals (e.g., pilot subcarriers, data subcarriers, etc.). Thus, it is appreciated that novel presented systems and methods are applicable to a wide variety of different testing scenarios and conditions. In some exemplary implementations, the novel presented systems and methods are readily applicable to protocols with predetermined characteristics and definitions (e.g., modulation definitions, configuration definitions, etc.).

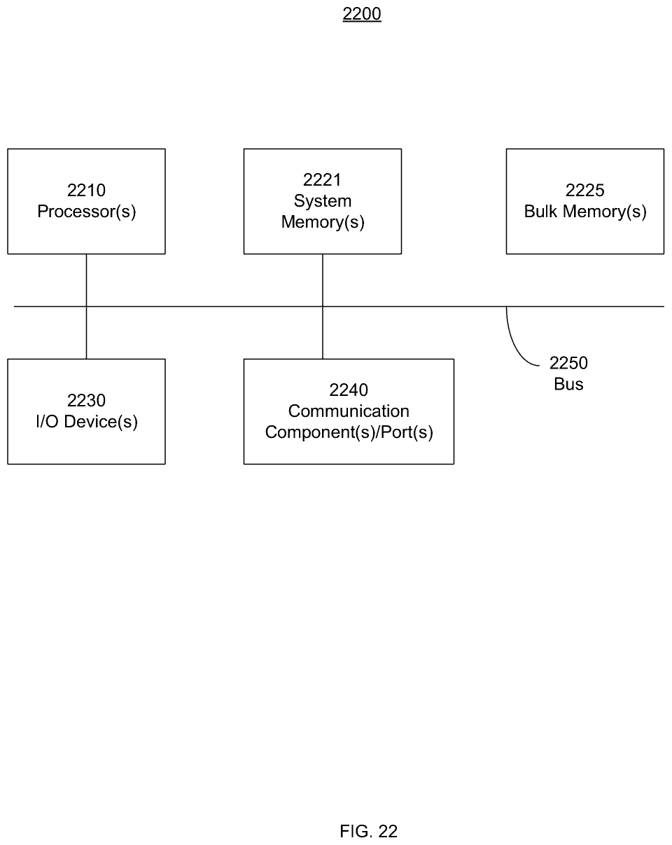

FIG. 22 is a block diagram of an exemplary electronic system 2200 which may be used as a platform to implement and control methods in accordance with some embodiments. In some embodiments, electronic system 2200 is a work station running an algorithm associated with novel systems and methods presented in this description. Electronic system 2200 can be included in an ATE system (e.g., ATE 110A, ATE 110C, etc.). Electronic system 2200 can be a “server” computer system. Electronic system 2200 includes a central processor(s) 2210, system memory 2215, bulk memory 2225 (e.g., hard drive, external memory, etc.), input/output (I/O) devices 2230, communication component/port 2240, and bus 2250. It is appreciated that one or more non-transitory computer-readable media (e.g., system memory 2215, bulk memory 2225, etc.) that store instructions which, when executed by one or more processors (e.g., central processor(s), etc.), cause the one or more processors to perform operations of the methods and processes set forth in other portions of this description (e.g., methods 300, 700, 1000,1100, 1200A, 1200B, 1590, 1600, etc.).

Bus 2250 is configured to communicatively couple and communicate information between the other components (e.g., central processor(s) 2210, system memory 2215, bulk memory 2225, input/output (I/O) devices 2230, communication component/port 2240, etc.). Central processor(s) 2210 is configured to process information and instructions. System memory 2221 (e.g., reads only memory (ROM), random access memory (RAM), etc.) and bulk memory(s) 2225 are configured to store information and instructions for the central processor complex 2215. I/O device(s) 2230 can communicate information to the system (e.g., central processor 2210, memory 2225, etc.). I/O devices 2230 may be any suitable device for communicating information and/or commands to the electronic system (e.g., a keyboard, buttons, a joystick, a microphone, a touch sensitive digitizer panel, display component, light emitting diode (LED) display, etc.). Communication port 2240 is configured to exchange/communicate information with external devices/network (not shown). A communication port 940 can have various configurations (e.g., RS-232 ports, universal asynchronous receiver transmitters (UARTs), USB ports, infrared light transceivers, Ethernet ports, IEEE 13394, synchronous ports, etc.) and can communicate with an external network.

In some embodiments, methods and processes set forth in other portions of this description are implemented by algorithms executed on a work station (e.g., electronic system 2200, etc.). Algorithms for accessing information (e.g., retrieving from memory, downloading from a network, etc.) are readily implemented for some of the method and process operations (e.g., 810, block 1610, etc.). Aspects of performing full demodulation blocks (e.g., 330, 830, 1680, etc.) that may be similar to conventional demodulation methods and processes may be implemented with algorithms similar to conventional algorithms. It is appreciated that the algorithm modules described herein are expressed in pseudo code that can be readily converted for implementation in various programming languages.

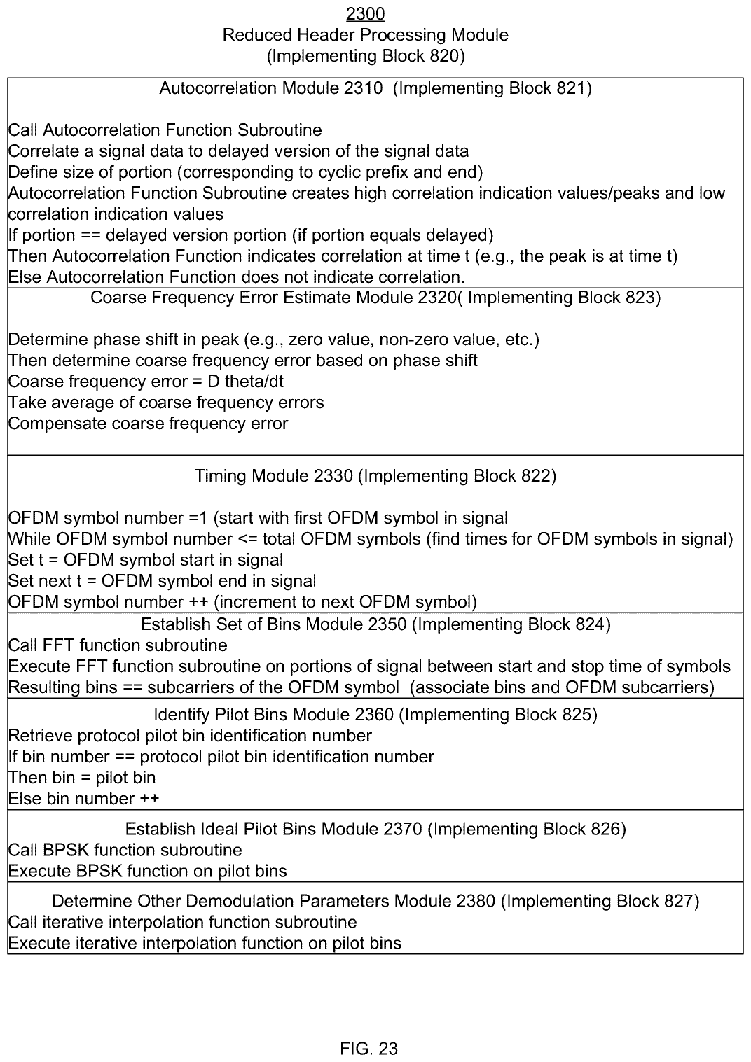

FIG. 23 is a block diagram of exemplary algorithm Reduced Header Processing Module 2300 in accordance with embodiments of the present disclosure. Reduced Header Processing Module 2300 is directed to implementing block 820 of method 800. Reduced Header Processing Module 2300 includes Autocorrelation Module 2310 (Block 821), Coarse Frequency Error Estimate Module 2320 (Block 823), Timing Module 2330 (Block 822), Establish Set of Bins Module 2350 (Block 824), Identify Pilot Bins Module 2360 (Block 825), and Establish Ideal Pilot Bins Module 2370 (Block 826). Autocorrelation Module 2310 is directed to implementing block 821. Coarse Frequency Error Estimate Module 2320 is directed to implementing block 823. Timing Module 2330 is directed to implementing block 822. Establish Set of Bins Module 2350 is directed to implementing block 824. Identify Pilot Bins Module 2360 is directed to implementing block 825. Establish Ideal Pilot Bins Module 2370 is directed to implementing block 826. Determine Other Demodulation Parameters Module 2380 is directed to implementing block 827.

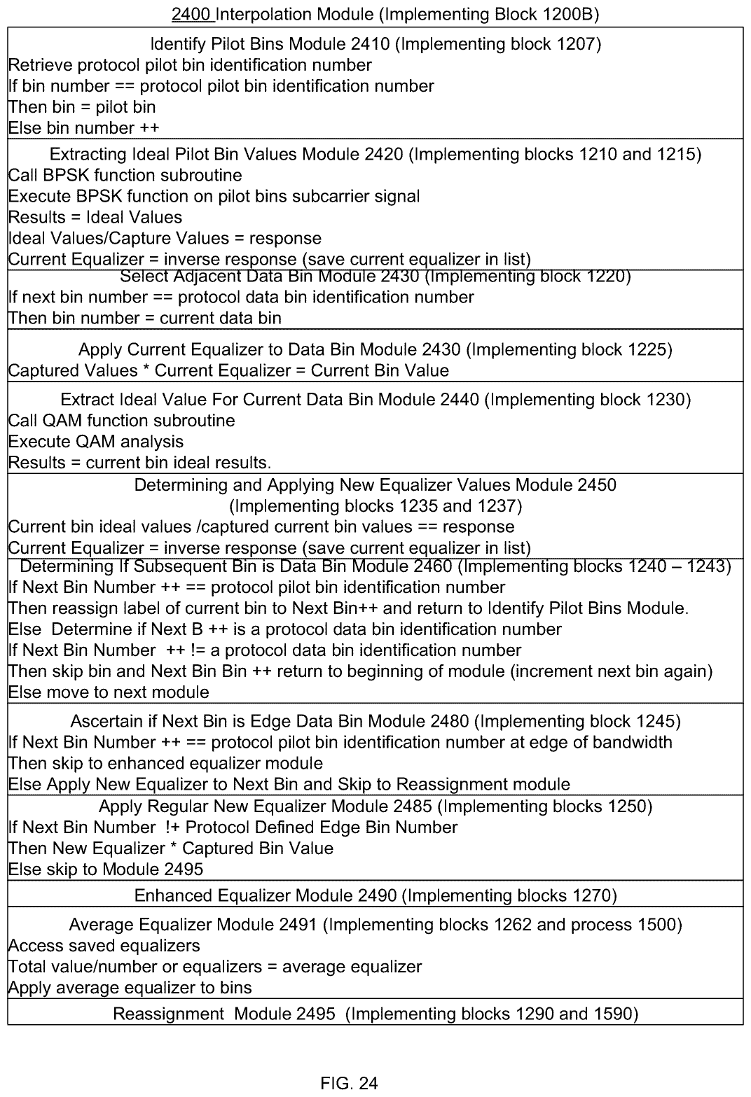

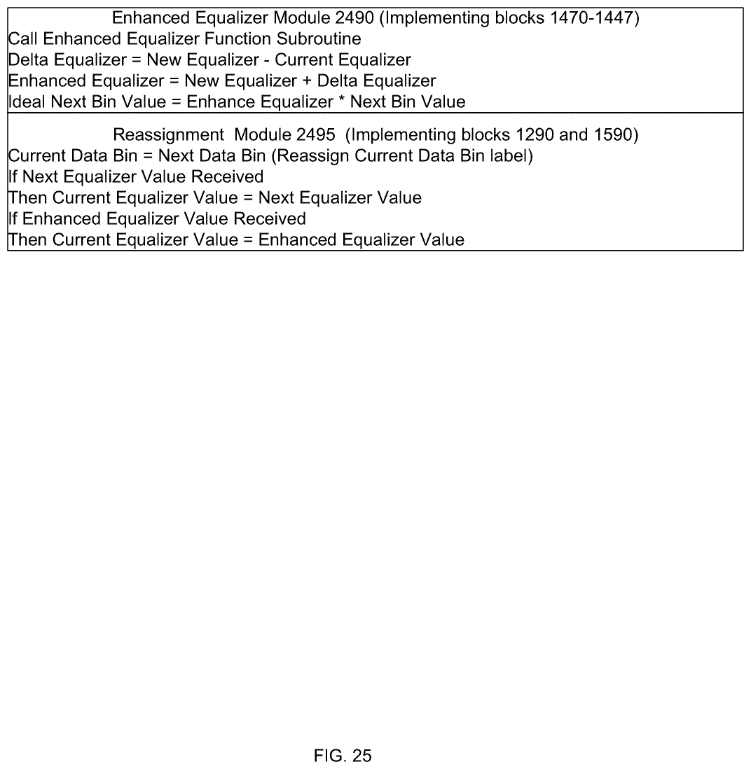

FIG. 24 is a block diagram of exemplary algorithm interpolation module 2400 in accordance with embodiments of the present disclosure. Interpolation module 2400 is directed to implementing iterative interpolation process 1200B. Interpolation Module 2400 includes Identify Pilot Bins Module 2410, Extracting Ideal Pilot Bin Values Module 2420, Select Adjacent Data Bin Module 2430, Apply Current Equalizer to Data Bin Module 2430, Extract Ideal Value For Current Data Bin Module 2440, Determining and Applying New Equalizer Values Module 2450, Determining If Subsequent Bin is Data Bin Module 2460, Ascertain if Next Bin is Edge Data Bin Module 2480, Apply Regular New Equalizer Module 2485, Enhanced Equalizer Module 2490, and Reassignment Module 2495. FIG. 25 is an expanded versions of exemplary Enhanced Equalizer Module 2490 and Reassignment Module 2495.

The modules within interpolation module 2400 are directed to implementing blocks within interpolation process 1200B. Identify Pilot Bins Module 2410 is directed to implementing block 1207. Extracting Ideal Pilot Bin Values Module 2420 is directed to implementing blocks 1210 and 1215. Select Adjacent Data Bin Module 2430 is directed to implementing block 1220. Apply Current Equalizer to Data Bin Module 2430 is directed to implementing block 1225. Extract Ideal Value For Current Data Bin Module 2440 is directed to implementing block 1230. Determining and Applying New Equalizer Values Module 2450 is directed to implementing blocks 1235 and 1237. Determining If Subsequent Bin is Data Bin Module 2460 is directed to implementing blocks 1240-1243. Ascertain if Next Bin is Edge Data Bin Module 2480 is directed to implementing block 1245. Apply Regular New Equalizer Module 2485 is directed to implementing block 1250. Enhanced Equalizer Module 2490 is directed to implementing block 1270. Average Equalization Module 2941 is directed to implementing blocks 1262 and 1500. Reassignment Module 2495 is directed to implementing blocks 1290 and 1590.

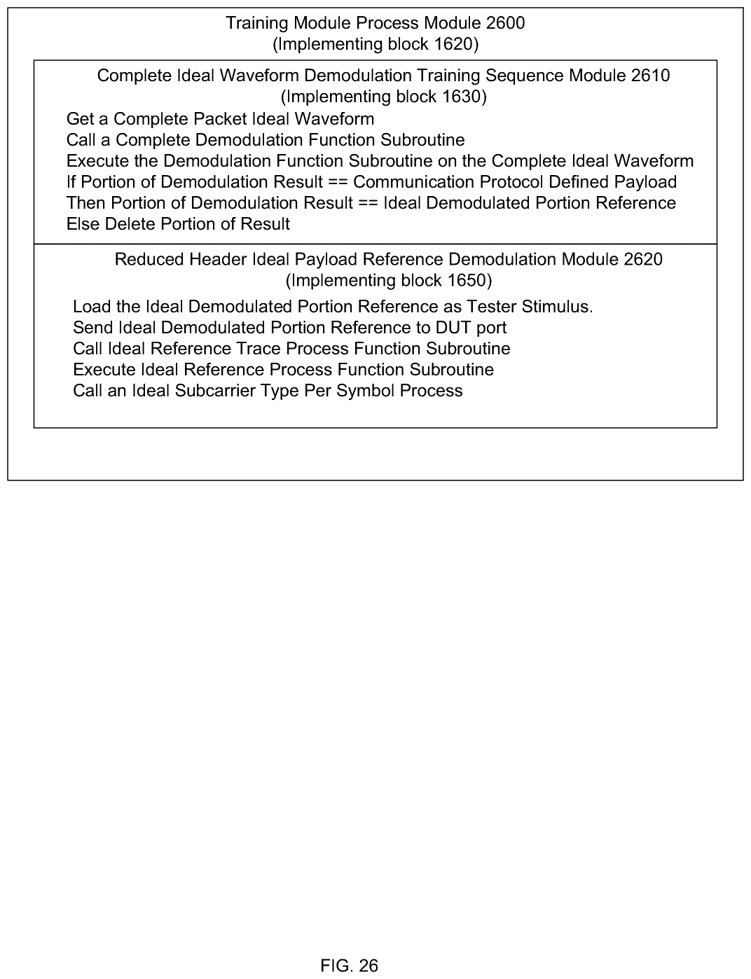

FIG. 26 is a block diagram of exemplary algorithm Training Module Process Module 2600 in accordance with embodiments of the present disclosure. Training Module Process Module 2600 includes Complete Ideal Waveform Demodulation Training Sequence Module 2610 and Reduced Header Ideal Payload Reference Demodulation Module 2620. Training Module Process Module 2600 is directed to implementing block 1620. Complete Ideal Waveform Demodulation Training Sequence Module 2610 is directed to implementing block 1630.

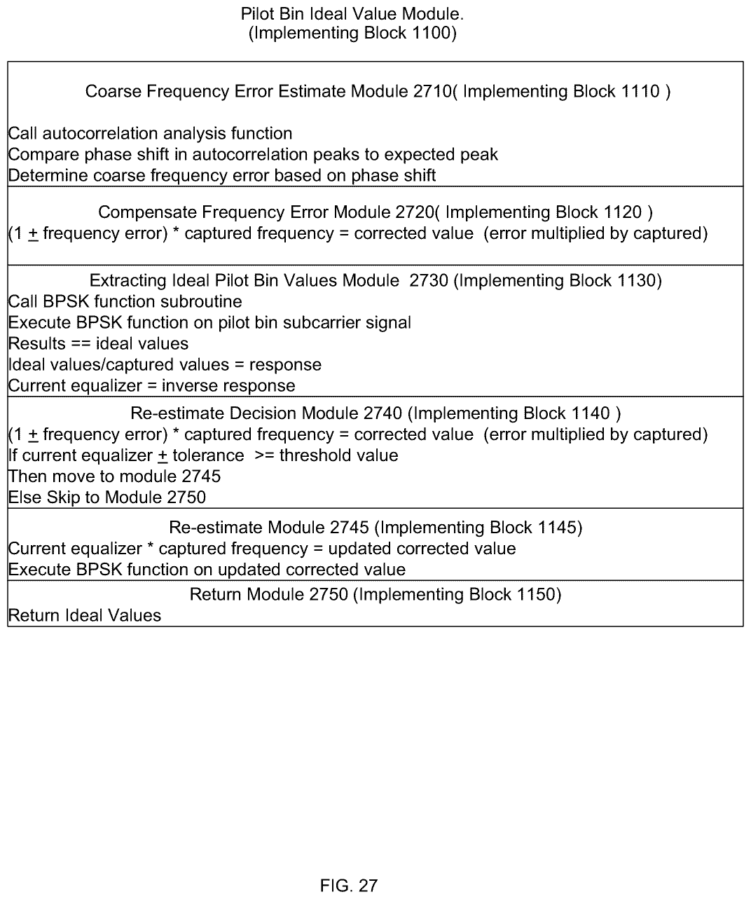

FIG. 27 is a block diagram of exemplary algorithm Pilot Bin Ideal Value Module 2700 in accordance with embodiments of the present disclosure. Pilot Bin Ideal Value Module 2700 is directed to implementing block 1100. Pilot Bin Ideal Value Module 2700 includes Coarse Frequency Error Estimate Module 2710, Compensate Frequency Error Module, Extracting Ideal Pilot Bin Values Module 2730, Re-estimate Decision Module 2740, Re-estimate Module 2745, and Return Module 2750. Coarse Frequency Error Estimate Module 2710 is directed to implementing block 1110. Compensate Frequency Error Module 2720 is directed to implementing block 1120. Extracting Ideal Pilot Bin Values Module 2730 is directed to implementing block 1130. Re-estimate Decision Module 2740 is directed to implementing block 1140. Re-estimate Module 2745 is directed to implementing block 1145. Return Module 2750 is directed to implementing block 1150.

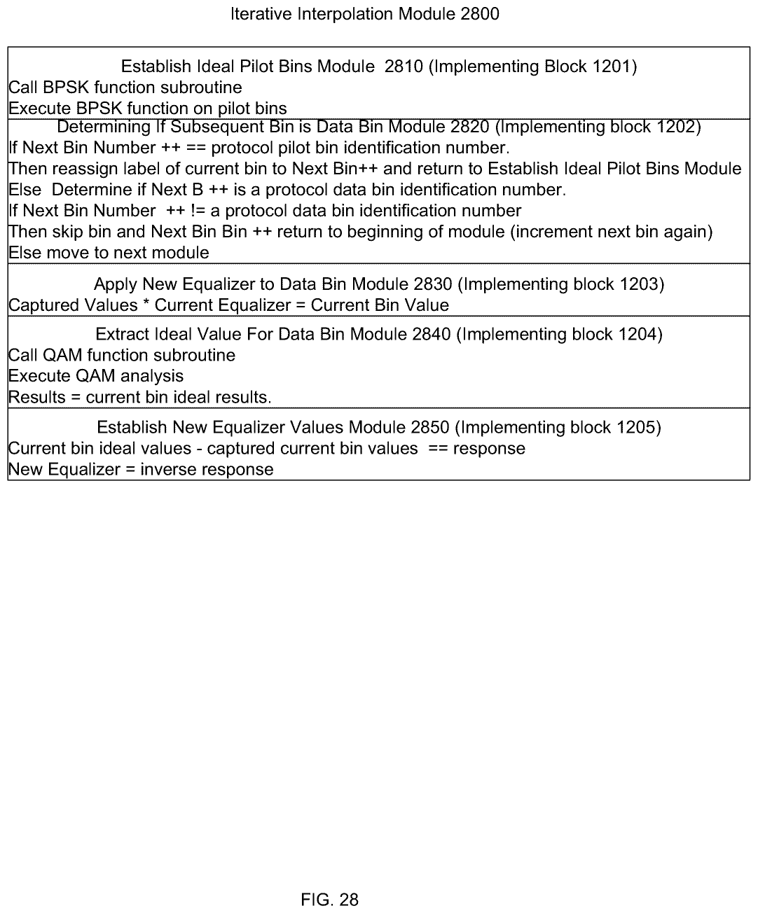

FIG. 28 is a block diagram of exemplary algorithm Iterative Interpolation Module 2800 in accordance with embodiments of the present disclosure. Iterative Interpolation Module 2800 is directed to implementing process 1200A. Iterative Interpolation Module 2800 includes Establish Ideal Pilot Bins Module 2810, Determining If Subsequent Bin is Data Bin Module 2820, Apply New Equalizer to Data Bin Module 2830, Extract Ideal Value For Data Bin Module 2840, and Establish New Equalizer Values Module 2850. Establish Ideal Pilot Bins Module 2810 is directed to implementing block 1201. Determining If Subsequent Bin Is Data Bin Module 2820 is directed to implementing block 1202. Apply New Equalizer to Data Bin Module 2830 is directed to implementing block 1203. Extract Ideal Value For Data Bin Module 2840 is directed to implementing block 1204. Establish New Equalizer Values Module 2850 is directed to implementing block 1205.

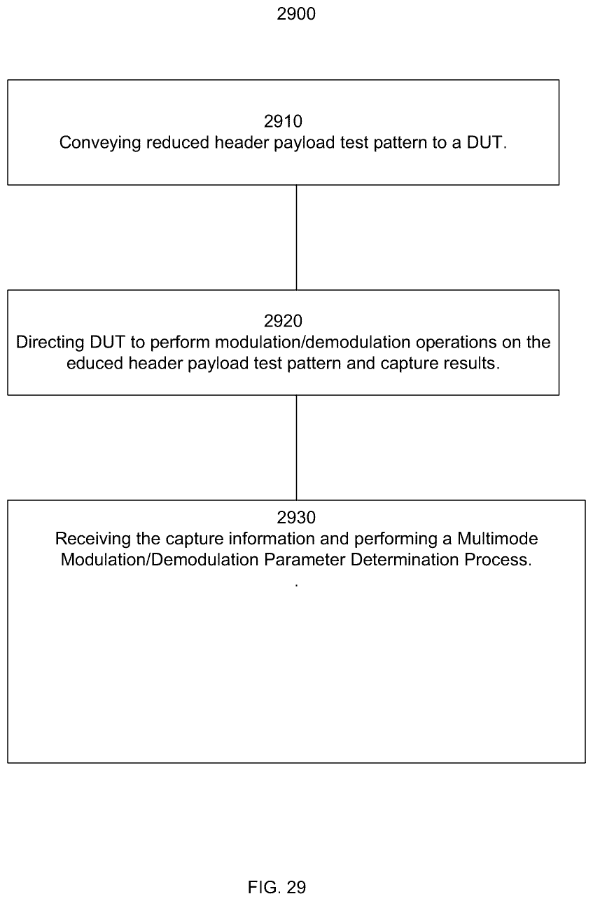

FIG. 29 is a block diagram of a testing method 2900 in accordance with embodiments of the present disclosure. In block 2910 a reduced header payload test pattern is conveyed to a DUT. In block 2910, a DUT is directed to perform modulation/demodulation operations on the reduced header payload test pattern and capture results. The capture information is received and a Multimode Modulation/Demodulation Parameter Determination Process is performed. The capture information is received and a Multimode Modulation/Demodulation Parameter Determination Process is performed.

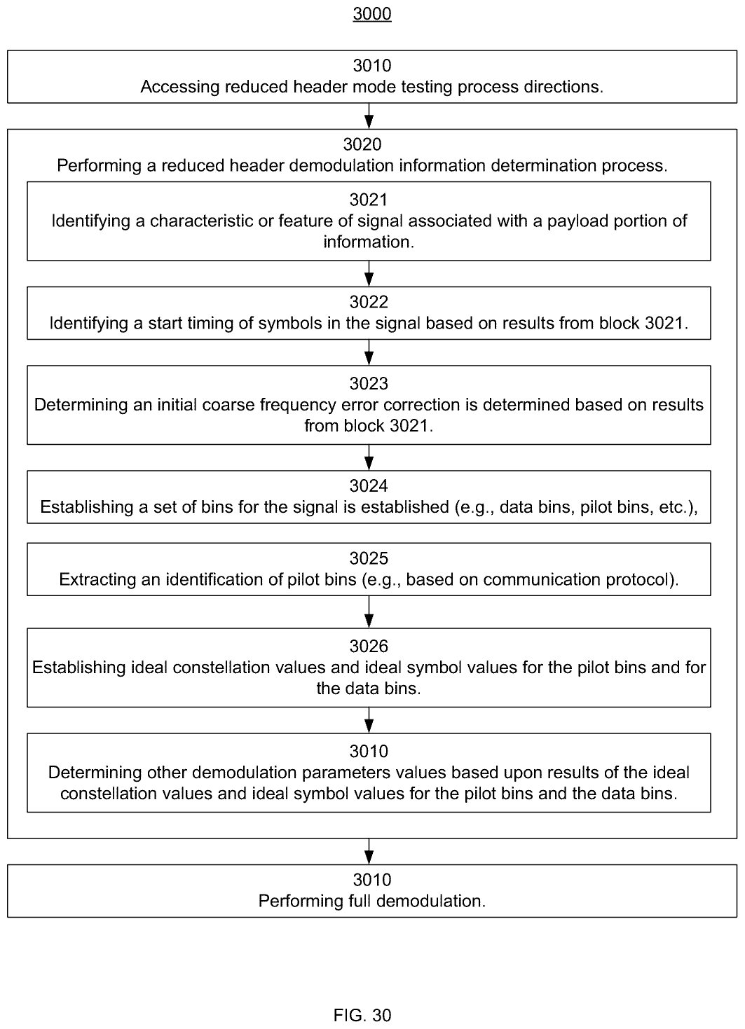

FIG. 30 is a block diagram of an exemplary reduced header mode testing process 3000 in accordance with embodiments of the present disclosure. Reduced header mode testing process 3000 is included in a reduced header communication signal processing method. The reduced header mode testing process is utilized when reference signal information is reduced/not available. In some exemplary implementations, reference signal information (e.g., reference symbols, etc.) that would otherwise be included in a header portion or preamble portion (e.g., included in a short training field, long training field, etc.) is not available. The reduced header mode testing process is utilized when a receiving component (e.g., DUT, etc.) has reduced information about a received signal (e.g., reduced modulation related information, header information, preamble information, signal configuration information, etc.). The received information is less than would otherwise be available in a normal field/non-test situation.

In block 3010, reduced header mode testing process directions are accessed (e.g., Headerless without Reference Signal, etc.). In some exemplary implementations, reduced header mode testing process directions are based upon a selection of a reduced header mode testing process (e.g., similar to a selection in block 710, etc.). The selection may be made based on various conditions (e.g., a DUT does not have sufficient resources to handle testing of communications with full header information, it is desirable to have smaller test patterns directed to testing of payloads with reduced header information, it is desirable to have multiple testing runs with different test characteristics, etc.).

In block 3020, a reduced header demodulation information determination process is performed. In some embodiments, a reduced header demodulation information determination process determines information to be utilized in testing modulation/demodulation operations (e.g., signal processing operations, etc.). In some exemplary implementations, a reduced header demodulation information determination process includes blocks 3021, 3022, 3023, 3024, 3025, and 3026.

In block 3021, a characteristic or feature of a signal associated with a payload portion of information is identified. The characteristic or feature provides (e.g., has a correlation to, association with, etc.) an indication of timing information (e.g., start time, end time, etc.). The characteristic or feature may be included in the payload portion (e.g., cyclic prefix, other configurations, etc.) within the signal. In some exemplary implementations, an analysis (e.g., autocorrelation analysis, comparison analysis, etc.) of the characteristic or feature provides results (e.g., identifiable correlation peaks, identifiable magnitude configurations in the results, identifiable phase configurations in the results, etc.) from which the timing information is derived. In some embodiments, the timing information is associated with a symbol included in the payload portion. In some embodiments, the symbol is detectable in a physical layer channel communication after modulation and prior to demodulation (e.g., after data encoding and IFFT in modulation operations, prior to FFT and data decoding in demodulation operations, etc.). A symbol can be an OFDM symbol, OFDMA symbol, and so on. In some embodiments, the signal is a looping signal (e.g. similar to the signal in FIG. 5D, etc.). The signal is configured in accordance with a communication protocol (e.g., publicly know, privately predetermined, etc.).

In block 3022, a start timing of symbols in the signal is identified based on results from block 3021. The symbols are defined by the communication protocol. In other implementations, the start and end location/timing of a symbol with respect to one another is identified (e.g., where a symbol starts and ends with respect to the start and end of other symbols, etc.).

In block 3023, an initial coarse frequency error correction is determined based on results from block 3021. Differences in phase and coarse frequency errors can also be determined from the analysis of characteristics or feature of signal associated with a payload portion of information. In some embodiments, differences in the analysis result values from expected values can indicate a phase difference and corresponding frequency errors. The expected values can be defined by or derived from definitions in communication protocols.

In block 3024, a set of bins for the signal is established, where the set of bins comprises pilot bins and data bins. The set of bins corresponds to a set of subcarriers associated with the signal, where the pilot bins correspond to pilot subcarriers in the set of subcarriers and the data bins correspond to data subcarriers in the set of subcarriers. In some exemplary implementations, a Fast Fourier Transform (FFT) operation is performed on a portion of the signal associated with a symbol and the results are utilized to establish the set of bins.

In block 3025, an identification of pilot bins is extracted in accordance with definitions of the pilot subcarriers as defined by the communication protocol. In some embodiments, identification of the pilot bins includes identifying locations of pilot bins with respect to one another and also other bins in the set of bins. It is appreciated that identification of and definition of subcarrier (e.g., pilot subcarriers, data subcarrier, null subcarriers, etc.) configurations and locations with respect to one another can vary (e.g., as presented in description of FIGS. 5A through 5E, explanation in other portions of this description, etc.). In some embodiments, a pilot signal is a special BPSK subcarrier signal that is more immune to symbol errors than the transmitted data symbols, and this relative immunity allows for reliable determination of impairments in the pilot symbol (e.g., symbol errors, frequency errors, etc.) and reliable determination of an equalizer value.

In block 3026, ideal constellation values and ideal symbol values are established for the pilot bins and for the data bins. In some embodiments, an interpolation is used to establish ideal constellation values and ideal symbol for data bins. It is appreciated various types of interpolation (e.g., straight line, least squares, iterative update/redetermination, etc.) are compatible with and readily implemented in Reduced Header Mode Testing Process 3000.

In block 3010, other demodulation parameter values are determined based upon results of the ideal constellation values and ideal symbol values for the pilot bins and the data bins (e.g., based upon results of block 826, etc.). In some embodiments, an equalizer value from a first bin is initially applied to a second bin and subsequently updated based on results of block 826. In some exemplary implementations, the first bin and second bin are adjacent or next to one another. The configuration of the first and second bin with respect to one another's proximity may be defined by a communication protocol (e.g., industry standard, IEEE 802.11 family of communication protocols, etc.).

In some embodiments, after the reduced header demodulation information determination process from block 3020 is performed the operations proceed to block 3030 and an exemplary full demodulation is performed. The full demodulation is similar to block 330. Full demodulation is similar to some aspects of conventional demodulation analysis. After information from block 3020 is available, the process can proceed with full demodulation determining information similar to conventional information that would otherwise not traditionally have otherwise been available from reduced header signals.

A header mode testing process (e.g., block 750, 2100, etc.) performs modulation and demodulation testing using information in a header portion of a communication burst or frame. The header mode testing process uses the header portion information to establish timing and reference values for comparison with pilot values. In some embodiments, a header testing process performs conventional testing of communication information and implements the header testing process with conventional algorithms.

While the disclosure has been described in conjunction with the preferred embodiments, it will be understood that they are not intended to limit the disclosure to these embodiments. On the contrary, the disclosure is intended to cover alternatives, modifications, and equivalents. The description is not intended to be exhaustive or to limit the disclosure to the precise forms disclosed, and obviously many modifications and variations are possible.

The novel testing approaches presented herein provide flexible and adaptable selection between testing modes (e.g., a header included mode, a reduced header training mode, a reduced header mode; etc.). Moreover, novel modes disclosed herein support efficient and effective testing of communication DUT's demodulation performance without relying on header information to perform the demodulation. In some embodiments, reduced header modes enable demodulation of communication signals configured (e.g., in bursts, packets, etc.) with less header information than would otherwise be typically included in accordance with communication protocols.

The presented novel approaches facilitate flexible determination of timing, frequency offset, channel response, and clock errors, fine tune frequency errors, sampling clock errors, IQ gain and phase imbalance, Error Vector Magnitude (EVM), and so on, based upon varying amounts of physical layer communication protocol header information (e.g., from full header information to no header information attached to only data/payload portion, etc.). The presented novel approaches enable efficient and effective testing of demodulation components and functionality, including increasing overall testing performance (e.g., reduced time, costs, etc.). The presented novel approaches facilitate significant conservation of testing time and financial resources.
1. In some embodiments, a reduced header communication signal processing test method comprises performing an autocorrelation of cyclic prefixes in a signal, wherein the signal is configured in accordance with a communication protocol, identifying start timing of symbols in the signal based on results of the autocorrelation, wherein the symbols are defined by the communication protocol and comprise orthogonal frequency division modulation (OFDM) symbols, determining an initial coarse frequency error correction based on results of the autocorrelation, establishing a set of bins for the signal, wherein the set of bins comprises pilot bins and data bins, wherein the set of bins correspond to a set of subcarriers associated with the signal, the pilot bins correspond to pilot subcarriers in the set of subcarriers and the data bins correspond to data subcarriers in the set of subcarriers, extracting identifications of the pilot bins in accordance with definitions of the pilot subcarriers as defined by the communication protocol, establishing ideal constellation values and ideal symbol values for the pilot bins and for the data bins, and determining other demodulation parameters values based upon results of the ideal constellation values and ideal symbol values for the pilot bins and the data bins.
2. The method of clause 1, wherein the signal is a looping signal comprising payload data without preamble training reference symbols.
3. The method of clause 1 or 2, wherein the identifying comprises performing a peak search function on results of the autocorrelation, and associating results of the peak search function with indications of the start timing of the symbols.
4. The method of any clause 1-3, wherein the communication protocol corresponds to one of a family of IEEE802.11 wireless network communication protocols/standards.
5. The method of any clause 1-4, wherein the signal comprises a physical layer payload portion of a protocol data unit without physical layer header information, wherein configuration of the physical layer payload portion of a protocol data unit otherwise complies with configuration specification of a communication protocol standard corresponding to one of a family of IEEE802.11 wireless network protocols/standards.
6. The method of any clause 1-5, wherein the establishing ideal constellation values and ideal symbol values for the pilot bins comprises completing determination of coarse frequency error, compensating for the coarse frequency error, obtaining ideal pilot tone values in the signal, wherein the ideal pilot tone values comprise the ideal constellation values and ideal symbol values for the pilot bins and corresponding pilot subcarriers, deciding if user selected “LowSNR” for the FrequencyEstimationMethod, if so, re-estimate of frequency error is appropriate, performing the re-estimate of the fine tune frequency error using pilot tone and/or data bin values in the signal when a result of the deciding is affirmative, applying the fine tune frequency error to the signal, and returning the ideal pilot tone values, wherein the ideal pilot tone values comprise the ideal constellation values and the ideal symbol values for the pilot bins and corresponding pilot subcarriers.
7. The method of clause 1-7, wherein the establishing ideal constellation values and ideal symbol values for the pilot bins and data bins comprises determining equalizer values for the pilot subcarriers in the pilot bin based on ideal pilot tone constellation values, and determining equalizer values for the data subcarriers at the data bin locations based on ideal data tone constellation values.
8. The method of Clause 7, wherein the equalizer values for the pilot bins and the equalizer values for the data bins are inverses of respective channel response values.
9. The method of clause 7 or 8, wherein the determining equalizer values for the data bins comprises interpolation between the equalizer values for the pilot bins.
10. The method of any clause 1-9, wherein establishing ideal constellation values and ideal symbol values for the pilot bins and for the data bins comprises selecting one of the pilot bins and assigning a label of current pilot bin to the one of the pilot bins, extracting an ideal value for the current pilot bin, wherein extracting the ideal value for the current pilot bin is based upon binary phase-shift keying (BPSK) analysis, extracting a pilot equalizer value based on the ideal value for the current pilot bin and a known capture value for the current pilot bin, inserting the pilot equalizer in an equalizer list, selecting one of the data bins that is adjacent to the current pilot bin and assigning the one of the data bins a label of current data bin, assigning a label of current equalizer value to the pilot equalizer value, applying the current equalizer value to the current data bin, extracting an ideal constellation value for the current data bin, extracting a new equalizer value based on the ideal constellation value and a known capture value for the current data bin, inserting the new equalizer in the equalizer list, determining if a next bin in the set of bins is another one of the pilot bins, re-assigning the label of current pilot bin to the another one of the pilot bins when the determining is positive, determining if a next bin in the set of bins is another one of the data bins, ascertaining if the next bin is a bandwidth edge bin when the next bin in the set of bins is another one of the data bins, applying the new equalizer value to the next bin when the ascertaining is negative, performing an enhanced equalizer process when the ascertaining is positive, determining if an iteration of a current bin corresponds to a last bin, performing an averaging equalization process, and performing a current data bin label reassignment process.
11. The method of any clause 1-10, wherein the enhanced equalizer process comprises establishing a delta equalizer value based on the current equalizer value and the new equalizer value, adding the new equalizer value to the delta equalizer value, and assigning a label of enhanced equalizer value to the result of the adding, and applying the enhanced equalizer value to the next bin.
12. The method of any clause 1-10, wherein the current data bin label reassignment process comprises re-assigning the next data bin the label of the current data bin, wherein the next data bin becomes known as the current bin, reassigning the new equalizer value the label of the current equalizer value when the ascertaining is negative, wherein the new equalizer value becomes known as the current equalizer value, and re-assigning the enhanced equalizer value the label of current equalizer value when the ascertaining is positive, wherein the enhanced equalizer value becomes known as the current equalizer value.
13. In some embodiments, a signal processing test system comprises a load board configured to couple with a plurality of devices under test (DUTs), a controller configured to direct testing of the plurality of DUTs, wherein the controller comprises a test mode selection module operable to select between a plurality of test modes, wherein one of the plurality of the test modes is associated with a reduced header communication signal test process applied to a signal, and testing electronics configured to test the plurality of DUTs under control of the controller, wherein the testing electronics is coupled to the load board and wherein the testing electronics comprises a demodulation information determination module operable to gather information associated with demodulation operations, wherein the demodulation operations comprise determining signal processing information based upon information in a payload portion of the signal, and a demodulation module operable to perform demodulation operations based upon information received from the demodulation information determination module.
14. The signal processing test system of clause 13, wherein the test mode selection module is operable to select the mode associated with a reduced header communication signal test process and wherein further the demodulation information determination module determines signal processing information associated with demodulation operations of the signal, and wherein the signal processing information is otherwise not included in a header portion of the signal.
15. The signal processing test system of clause 13 or 14, wherein the demodulation information determination module is operable to determine signal processing information associated with a plurality of pilot tone subcarriers and a plurality of non-pilot tone subcarriers within the signal, wherein configuration of the plurality of pilot tone subcarriers and a plurality of non-pilot tone subcarriers otherwise comply with a communication protocol standard corresponding to one of a family of IEEE802.11 wireless network protocols/standards.
16. The signal processing test system of any clause 13-15, wherein the demodulation information determination module is operable to perform a reduced header communication signal processing test method, and wherein the reduced header communication signal comprises a payload portion repeatedly transmitted in a loop and the reduced header communication signal does not have a full set of header training reference symbols specified in a communication protocol.
17. In some embodiments, a signal processing test method comprises selecting a signal processing mode between a header included mode, a reduced header training mode, and a reduced header mode, performing a signal processing information determination process in accordance with a result of the selecting a signal process mode, and performing modulation/demodulation related processes in accordance with results of the signal processing information determination process.
18. The signal processing test method of clause 17, wherein the reduced header training mode comprises performing a training process comprising demodulating an ideal waveform comprising training sequences, and performing ideal headerless demodulation using a payload-only portion of the ideal waveform, and performing full demodulation of another payload waveform utilizing results of the ideal headerless demodulation.
19. The signal processing test method of clause 17 or 18, wherein the reduced header mode comprises performing an autocorrelation of cyclic prefixes in a signal, wherein the signal is configured in accordance with a communication protocol, identifying start timing of symbols in the signal based on results of the autocorrelation, wherein the symbols are defined by the communication protocol and comprise orthogonal frequency division modulation (OFDM) symbols, determining an initial coarse frequency error correction based on results of the autocorrelation, establishing a set of bins for the signal, wherein the set of bins comprises pilot bins and data bins, wherein the set of bins correspond to a set of subcarriers associated with the signal, the pilot bins correspond to pilot subcarriers in the set of subcarriers, and the data bins correspond to data subcarriers in the set of subcarriers, extracting identifications of the pilot bins in accordance with definitions of the pilot subcarriers as defined by the communication protocol, establishing ideal constellation values and ideal symbol values for the pilot bins and for the data bins, and determining other demodulation parameters values based upon results of the ideal constellation values and ideal symbol values for the pilot bins and the data bins.
20. The signal processing test method of any clause 17-19, wherein the header included mode comprises obtaining demodulation information from a header included in the signal.

In some embodiments, one or more non-transitory computer-readable media store instructions which, when executed by one or more processors of an ATE, cause the one or more processors to perform operations of any of methods in clauses 1-12 and 17-20.

In sum, the disclosed techniques overcome the limitations of traditional systems and methods by enabling accurate demodulation of payload portions of a communication in accordance with communication protocols, without relying on header information that is otherwise specified for use by the communication protocols. In some embodiments, reduced header implementations include a training aspect in which an ideal demodulated payload waveform is extracted from a full ideal waveform (e.g., including header information, etc.) and the ideal demodulated payload waveform is used for demodulation of received or captured signals. In some embodiments, pilot bins/subcarriers are identified in payload portion of a looping communication signal and ideal pilot bin values are established. Autocorrelation of cyclic prefixes and performing peak search functions are utilized to identify the beginning of symbols (e.g., transmission symbols, OFDM symbols, etc.). Pilot bins/subcarriers within the symbols and corresponding ideal pilot bin/subcarrier values are identified (e.g., by performing a BPSK analysis, etc.), which are in turn utilized to establish an equalizer value. The equalizer value is applied to an adjacent data bin to develop a new interpolated equalizer value for the data bin. The process iteratively applies an equalizer value from a previous data bin equalizer to a subsequent data din and develops a new equalizer for the subsequent data bin until another pilot bin is encountered.

At least one technical advantage of the disclosed techniques is the ability to perform testing of demodulation operations on a DUT that would otherwise be impractical or impossible due to resource limitations. The ability of a DUT with limited memory to handle newer communication protocols can be tested. Presented novel reduced header demodulation processes provide efficient and effective demodulation on a data payload portion of a communication signal (e.g., that was traditionally were not available without full header information, etc.). Despite DUTs having limited testing related resources that would inhibit demodulation testing operations, presented novel reduced header systems and methods enable demodulation testing of DUTs by appropriately implementing and analyzing demodulation of communication signal payload portions. A number of demodulation related parameters (e.g., timing, frequency offset, channel response, clock errors, etc.) can be determined utilizing a payload portion of a signal without reliance on header information. In addition, smaller capture sizes associated with reduced header payload signals and corresponding test patterns reduces ATE upload and demodulation processing times. Testing efficiency is improved through reducing the need for large test patterns associated with long header information (e.g., which would otherwise be time consuming, inefficient, prone to error, etc.).

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions. While the preceding is directed to embodiments of the present disclosure, other and further embodiments of the disclosure may be devised without departing from the basic scope thereof, and the scope thereof is determined by the claims that follow.

Embodiments of the present disclosure are thus described. While the present disclosure has been described in particular embodiments, it should be appreciated that the present disclosure should not be construed as limited by such embodiments, but rather construed according to the following claims.

What is claimed is:

1. A reduced header communication signal processing test method, the method comprising:
performing an autocorrelation of cyclic prefixes in a signal, wherein the signal is configured in accordance with a communication protocol;
identifying start timing of symbols in the signal based on results of the autocorrelation, wherein the symbols are defined by the communication protocol and comprise orthogonal frequency division modulation (OFDM) symbols;
determining an initial coarse frequency error correction based on results of the autocorrelation;
establishing a set of bins for the signal, wherein the set of bins comprises pilot bins and data bins, wherein the set of bins correspond to a set of subcarriers associated with the signal, the pilot bins correspond to pilot subcarriers in the set of subcarriers and the data bins correspond to data subcarriers in the set of subcarriers;
extracting identifications of the pilot bins in accordance with definitions of the pilot subcarriers as defined by the communication protocol;
establishing ideal constellation values and ideal symbol values for the pilot bins and for the data bins; and
determining other demodulation parameters values based upon results of the ideal constellation values and ideal symbol values for the pilot bins and the data bins.

2. The method of claim 1, wherein the signal is a looping signal comprising payload data without preamble training reference symbols.

3. The method of claim 2, wherein the identifying comprises:
performing a peak search function on results of the autocorrelation; and
associating results of the peak search function with indications of the start timing of the symbols.

4. The method of claim 1, wherein the communication protocol corresponds to one of a family of IEEE802.11 wireless network communication protocols/standards.

5. The method of claim 1, wherein the signal comprises a physical layer payload portion of a protocol data unit without physical layer header information, wherein configuration of the physical layer payload portion of a protocol data unit otherwise complies with configuration specification of a communication protocol standard corresponding to one of a family of IEEE802.11 wireless network protocols/standards.

6. The method of claim 1, wherein the establishing ideal constellation values and ideal symbol values for the pilot bins comprises:
completing determination of coarse frequency error;
compensating for the coarse frequency error;
obtaining ideal pilot tone values in the signal, wherein the ideal pilot tone values comprise the ideal constellation values and ideal symbol values for the pilot bins and corresponding pilot subcarriers;
deciding if user selected “LowSNR” for aFrequencyEstimationMode, if so, re-estimate of frequency error is appropriate;
performing the re-estimate of a fine tune frequency error using pilot tone and/or data bin values in the signal when a result of the deciding is affirmative;
applying the fine tune frequency error to the signal; and
returning the ideal pilot tone values, wherein the ideal pilot tone values comprise the ideal constellation values and the ideal symbol values for the pilot bins and corresponding pilot subcarriers.

7. The method of claim 1, wherein the establishing ideal constellation values and ideal symbol values for the pilot bins and data bins comprises:
determining equalizer values for the pilot subcarriers in the pilot bin based on ideal pilot tone constellation values; and
determining equalizer values for the data subcarriers at data bin locations based on ideal data tone constellation values.

8. The method of claim 7, wherein the equalizer values for the pilot bins and the equalizer values for the data bins are inverses of respective channel response values.

9. The method of claim 7, wherein the determining equalizer values for the data bins comprises interpolation between the equalizer values for the pilot bins.

10. The method of claim 1, wherein establishing ideal constellation values and ideal symbol values for the pilot bins and for the data bins comprises:
selecting one of the pilot bins and assigning a label of current pilot bin to the one of the pilot bins;
extracting an ideal value for the current pilot bin, wherein extracting the ideal value for the current pilot bin is based upon binary phase-shift keying (BPSK) analysis;
extracting a pilot equalizer value based on the ideal value for the current pilot bin and a known capture value for the current pilot bin;
inserting the pilot equalizer in an equalizer list;
selecting one of the data bins that is adjacent to the current pilot bin and assigning the one of the data bins a label of current data bin;
assigning a label of current equalizer value to the pilot equalizer value;
applying the current equalizer value to the current data bin;
extracting an ideal constellation value for the current data bin;
extracting a new equalizer value based on the ideal constellation value and a known capture value for the current data bin;
inserting the new equalizer in the equalizer list;
determining if a next bin in the set of bins is another one of the pilot bins;
re-assigning the label of current pilot bin to the another one of the pilot bins when the determining is positive;
determining if a next bin in the set of bins is another one of the data bins;
ascertaining if the next bin is a bandwidth edge bin when the next bin in the set of bins is another one of the data bins;
applying the new equalizer value to the next bin when the ascertaining is negative;
performing an enhanced equalizer process when the ascertaining is positive;
determining if an iteration of a current bin corresponds to a last bin;
performing an averaging equalization process; and
performing a current data bin label reassignment process.

11. The method of claim 10, wherein the enhanced equalizer process comprises:
establishing a delta equalizer value based on the current equalizer value and the new equalizer value;
adding the new equalizer value to the delta equalizer value and assigning a label of enhanced equalizer value to the result of the adding; and
applying the enhanced equalizer value to the next bin.

12. The method of claim 10, wherein the current data bin label reassignment process comprises:
re-assigning the next data bin the label of the current data bin, wherein the next data bin becomes known as the current bin;
reassigning the new equalizer value the label of the current equalizer value when the ascertaining is negative, wherein the new equalizer value becomes known as the current equalizer value; and
re-assigning the enhanced equalizer value the label of current equalizer value when the ascertaining is positive, wherein the enhanced equalizer value becomes known as the current equalizer value.

13. A signal processing test system comprising:
a load board configured to couple with a plurality of devices under test (DUTs);
a controller configured to direct testing of the plurality of DUTs, wherein the controller comprises a test mode selection module operable to select between a plurality of test modes, wherein one of the plurality of the test modes is associated with a reduced header communication signal test process applied to a signal; and
testing electronics configured to test the plurality of DUTs under control of the controller, wherein the testing electronics is coupled to the load board and wherein the testing electronics comprises:
a demodulation information determination module operable to gather information associated with demodulation operations, wherein the demodulation operations comprise determining signal processing information based upon information in a payload portion of the signal; and
a demodulation module operable to perform demodulation operations based upon information received from the demodulation information determination module.

14. The signal processing test system of claim 13, wherein the test mode selection module is operable to select the mode associated with a reduced header communication signal test process and wherein further the demodulation information determination module determines signal processing information associated with demodulation operations of the signal, and wherein the signal processing information is otherwise not included in a header portion of the signal.

15. The signal processing test system of claim 13, wherein the demodulation information determination module is operable to determine signal processing information associated with a plurality of pilot tone subcarriers and a plurality of non-pilot tone subcarriers within the signal, wherein configuration of the plurality of pilot tone subcarriers and a plurality of non-pilot tone subcarriers otherwise comply with a communication protocol standard corresponding to one of a family of IEEE802.11 wireless network protocols/standards.

16. The signal processing test system of claim 13, wherein the demodulation information determination module is operable to perform a reduced header communication signal processing test method, and wherein the reduced header communication signal comprises a payload portion repeatedly transmitted in a loop and the reduced header communication signal does not have a full set of header training reference symbols specified in a communication protocol.

17. A signal processing test method comprising:
selecting a signal processing mode between a header included mode, a reduced header training mode, and a reduced header mode;
performing a signal processing information determination process in accordance with a result of the selecting a signal process mode; and
performing modulation/demodulation related processes in accordance with results of the signal processing information determination process.

18. The signal processing test method of claim 17, wherein the reduced header training mode comprises:
performing a training process comprising:
demodulating an ideal waveform comprising training sequences; and
performing ideal headerless demodulation using a payload-only portion of the ideal waveform; and
performing full demodulation of another payload waveform utilizing results of the ideal headerless demodulation.

19. The signal processing test method of claim 17, wherein the reduced header mode comprises:
performing an autocorrelation of cyclic prefixes in a signal, wherein the signal is configured in accordance with a communication protocol;
identifying start timing of symbols in the signal based on results of the autocorrelation, wherein the symbols are defined by the communication protocol and comprise orthogonal frequency division modulation (OFDM) symbols;
determining an initial coarse frequency error correction based on results of the autocorrelation;
establishing a set of bins for the signal, wherein the set of bins comprises pilot bins and data bins, wherein the set of bins correspond to a set of subcarriers associated with the signal, the pilot bins correspond to pilot subcarriers in the set of subcarriers, and the data bins correspond to data subcarriers in the set of subcarriers;
extracting identifications of the pilot bins in accordance with definitions of the pilot subcarriers as defined by the communication protocol;
establishing ideal constellation values and ideal symbol values for the pilot bins and for the data bins; and
determining other demodulation parameters values based upon results of the ideal constellation values and ideal symbol values for the pilot bins and the data bins.

20. The signal processing test method of claim 17, wherein the header included mode comprises obtaining demodulation information from a header included in the signal.
